(19) United States
(12) Patent Application Publication
(10) Pub. No.: US 2023/0371769 A1
(43) Pub. Date: Nov. 23, 2023

(54) MOVING ROBOT SYSTEM

(71) Applicant: LG ELECTRONICS INC., Seoul (KR)

(72) Inventor: Donghoon KWAK, Seoul (KR)

(21) Appl. No.: 18/028,349

(22) PCT Filed: Sep. 10, 2021
(86) PCT No.: PCT/KR2021/012374

§ 371 Date: Mar. 24, 2023

(30) Foreign Application Priority Data
Oct. 8, 2020 (KR) 10-2020-0130382

(51) Int. Cl. A47L 9/28; A47L 11/40; G05D 1/02

(52) U.S. Cl. CPC A47L 9/2852; A47L 9/2873; A47L 11/4011; G05D 1/0287; A47L 2201/04; A47L 2201/022; G05D 2201/0203; G05D 2201/0215

(57) ABSTRACT

The present disclosure relates to an embodiment of a moving robot system, including a first robot that sucks contaminants in a zone to be cleaned, a second robot that wipes the floor of the zone to be cleaned, a first charging stand for charging the first robot, a second charging stand for charging the second robot, and a network connecting the first robot and the second robot with each other, wherein the first robot and the second robot enter a collaborative driving mode using the network, perform collaborative driving by recognizing position information to each other, and determine whether to release the collaborative driving mode when an error occurs in at least one of the first robot and the second robot when a kidnap occurs in at least one of the first robot and the second robot or when the network is disconnected while performing the collaborative driving.

### TECHNICAL FIELD

The present disclosure relates to a moving robot system, and more particularly, to a moving robot system in which a plurality of moving robots perform collaborative driving, and a method of performing collaborative driving thereof.

### BACKGROUND ART

A cleaner is a device that performs cleaning by sucking or mopping dust or foreign substances. In general, the cleaner performs a cleaning function for a floor, and the cleaner includes wheels for movement. In general, the wheels are rolled by an external force applied to a cleaner main body to move the cleaner main body with respect to the floor.

However, with the development of such a robot cleaner that performs cleaning while driving by itself without a user's operation, there is a need to develop a plurality of robot cleaners for performing cleaning while collaborating with each other without the user's operation.

The prior art document WO2017-036532 discloses a method in which a master robot cleaner (hereinafter, referred to as a master robot) controls at least one slave robot cleaner (hereinafter, referred to as a slave robot). The prior art document discloses a configuration in which the master robot detects adjacent obstacles using an obstacle detection device, and determines its position with respect to the slave robot using position data derived from the obstacle detection device. Furthermore, KR2017-0174493 discloses a general process in which two robot cleaners perform cleaning while communicating with each other.

However, in the two prior art documents, motions in response to various events that occur during collaborative driving are not disclosed. When two robot cleaners drive collaboratively, controls in response to various events are required than when one unit is driven, and for instance, when an error occurs in only one unit or when errors occur in both units, motion control in response to each error is required, and additionally, when a trap or kidnap occurs, an appropriate response motion for each of the two robot cleaners is required in a leading/following relationship.

In addition, in a mode in which two cleaners are driven collaboratively, there is a limitation in that appropriate collaborative driving is difficult to achieve due to different specifications and states of the two cleaners. For instance, in order for two cleaners to efficiently complete collaborative driving, the battery charge states of both the two cleaners are required to exceed a predetermined reference level, but when the charge state of one cleaner is below the predetermined reference level, it becomes difficult to complete collaborative driving.

In a system in which a plurality of robot cleaners are driven collaboratively as described above, various driving states, driving conditions, and event responses are considered, but in the related art, an appropriate method has not been proposed, so the accuracy/stability/reliability of collaborative driving using the plurality of robot cleaners had to be limited.

### DISCLOSURE OF INVENTION

### Technical Problem

In order to improve the limitations of the related art as described above, the present specification is to provide an embodiment of a moving robot system capable of solving the problems as described above.

In other words, an aspect of the present disclosure is to provide an embodiment of a moving robot system capable of performing collaborative driving while satisfying various conditions of collaborative driving, and a method of performing collaborative driving thereof.

Furthermore, another aspect of the present disclosure is to provide an embodiment of a moving robot system capable of performing collaborative driving in which appropriate responses to various events that occur during collaborative driving can be carried out, and a method of performing collaborative driving thereof.

Specifically, still another aspect of the present disclosure is to provide an embodiment of a moving robot system capable of carrying out an appropriate response to a trap situation that occurs during collaborative driving, and a method of performing collaborative driving.

In addition, yet still another aspect of the present disclosure is to provide an embodiment of a moving robot system capable of carrying out an appropriate response to various error situations that occur during collaborative driving, and a method of performing collaborative driving thereof.

Moreover, still yet another aspect of the present disclosure is to provide an embodiment of a moving robot system capable of carrying out an appropriate response to an obstacle sensed during collaborative driving, and a method of performing collaborative driving thereof.

Besides, yet still another aspect of the present disclosure is to provide an embodiment of a moving robot system capable of carrying out an appropriate response according to changes in battery charge levels of a plurality of moving robots and various states of the battery charge levels while performing collaborative driving.

### Solution to Problem

In order to solve the foregoing problems, a moving robot system and a method of performing collaborative driving thereof may include determining whether driving states of a plurality of moving robots correspond to preset reference conditions to perform a motion for collaborative driving according to the determination result as a solution means.

Specifically, upon receiving a control command for collaborative driving, the driving states of the plurality of moving robots corresponding to a condition of performing collaborative driving may be compared with the preset reference conditions, and when the driving states correspond to the reference conditions, a motion for the collaborative driving may be performed, thereby accurately and stably performing the collaborative driving.

In other words, an embodiment of a moving robot system and a method of performing collaborative driving thereof may determine whether the driving states of the plurality of moving robots correspond to the preset reference condition to perform a motion for collaborative driving according to the determination result, thereby solving the foregoing problems.

An embodiment of a moving robot system having the above technical features as a problem solving means may include a plurality of moving robots that perform cleaning while driving in an area to be cleaned, and a controller that communicates with the plurality of moving robots to transmit a control command for remote control to the plurality of moving robots, wherein upon receiving a control command for a collaborative driving mode for collaboratively cleaning the area to be cleaned from the controller, the plurality of moving robots determine whether driving states of the plurality of moving robots correspond to preset reference conditions to perform a motion for the collaborative driving mode according to the determination result.

Furthermore, an embodiment of a method of performing collaborative driving of a moving robot system having the above technical features as a problem solving means is disclosed as a method of performing collaborative driving of a first robot and a second robot, and the method may include receiving, by the first robot and the second robot, a command for performing collaborative driving, comparing, by the first robot, driving states of the first robot and the second robot with preset reference conditions, and performing, by each of the first robot and the second robot, a motion for collaborative driving according to the comparison result.

On the other hand, in an embodiment of a moving robot system capable of carrying out an appropriate response to a trap situation that occurs during collaborative driving, the first robot and/or the second robot may perform trap escape driving when a trap situation occurs in the first robot and/or the second robot while the first robot and the second robot perform collaborative driving, wherein the trap situation is a situation in which the first robot or the second robot is unable to enter a zone to be cleaned that has not be driven, and the trap escape driving is a driving method in which the first robot or the second robot drives along a boundary of the zone to be cleaned that has been driven.

Furthermore, an embodiment of a method of performing collaborative driving of a moving robot system capable of carrying out an appropriate response to a trap situation that occurs during collaborative driving may include performing, by the first robot and the second robot, collaborative driving with each other, determining whether a trap situation has occurred in the robot and/or the second robot, and performing trap escape driving when the first robot and/or the second robot is in a trap situation, wherein the trap situation is a situation in which the first robot or the second robot is unable to enter a zone to be cleaned that has not be driven, and the trap escape driving is a driving method in which the first robot or the second robot drives along a boundary of the zone to be cleaned that has been driven.

On the other hand, an embodiment of a moving robot system capable of carrying out appropriate responses to various error situations that occur during collaborative driving may include a first robot that sucks contaminants in a zone to be cleaned, a second robot that wipes the floor of the zone to be cleaned, a first charging stand for charging the first robot, a second charging stand for charging the second robot, and a network connecting the first robot and the second robot, wherein the first robot and the second robot enter a collaborative driving mode using the network, perform collaborative driving by recognizing position information to each other, and determine whether to release the collaborative driving mode when an error occurs in at least one of the first robot and the second robot while performing the collaborative driving when a kidnap occurs in at least one of the first robot and the second robot or when the network is disconnected.

Furthermore, an embodiment of a method of performing collaborative driving of a moving robot system capable of carrying out appropriate responses to various error situations that occur during collaborative driving is disclosed as a method of performing collaborative driving of a moving robot system that drives in a zone to be cleaned, wherein the moving robot system includes a first robot that sucks contaminants in a zone to be cleaned, a second robot that wipes the floor of the zone to be cleaned, a first charging stand for charging the first robot, a second charging stand for charging the second robot, and a network connecting the first robot and the second robot, and the method of performing collaborative driving includes entering, by the first robot and the second robot, a collaborative driving mode using the network, recognizing, by the first robot and the second robot, position information to each other to perform collaborative driving, and determining, by the first robot or the second robot, whether to release the collaborative driving mode when an error occurs in at least one of the first robot and the second robot while performing the collaborative driving, when a kidnap occurs in at least one of the first robot and the second robot, or when the network is disconnected.

On the other hand, an embodiment of a moving robot system capable of carrying out an appropriate response to an obstacle sensed during collaborative driving may include a first robot that sucks contaminants in a zone to be cleaned, a second robot that wipes the floor of the zone to be cleaned, a first charging stand for charging the first robot, a second charging stand for charging the second robot, and a network connecting the first robot and the second robot, wherein the first robot and the second robot enter a collaborative driving mode using the network, divide the zone to be cleaned into a plurality of unit zones, perform collaborative driving for each unit zone, and continue the collaborative driving by avoiding the obstacle or climbing the obstacle when the first robot and/or the second robot senses the obstacle formed in a height or depth with a preset range while performing the collaborative driving in any one of the plurality of unit zones.

Furthermore, an embodiment of a method of performing collaborative driving of a moving robot system capable of carrying out an appropriate response to an obstacle sensed during collaborative driving is disclosed as a method of performing collaborative driving of a moving robot system that drives a zone to be cleaned, wherein the moving robot system includes a first robot that sucks contaminants in a zone to be cleaned, a second robot that wipes the floor of the zone to be cleaned, a first charging stand for charging the first robot, a second charging stand for charging the second robot, and a network connecting the first robot and the second robot, and the method of performing collaborative driving includes entering, by the first robot and the second robot, a collaborative driving mode using the network, dividing, by the first robot and the second robot, the zone to be cleaned into a plurality of unit zones to perform collaborative driving for each unit zone, and continuously performing, by the first robot and/or the second robot, the collaborative driving by avoiding the obstacle or climbing the obstacle when sensing the obstacle formed in a height or depth with a preset range while performing the collaborative driving in any one of the plurality of unit zones.

On the other hand, an embodiment of a moving robot system capable of carrying out an appropriate response according to changes in battery charge levels of a plurality of moving robots and various states of the battery charge levels while performing collaborative driving is disclosed as a moving robot system in which the plurality of moving robots drive collaboratively, wherein the moving robot system includes a first robot that operates based on power charged by a first charging stand to drive in a zone to be cleaned, and a second robot that operates based on power charged by a second charging stand to drive along a path that has been driven by the first robot, and the first robot and the second robot respectively sense a capacity charged in the battery while performing a collaborative driving mode to release the collaborative driving mode according to a charge capacity value of the battery, and respectively perform at least one of an independent driving mode and a charging mode of the battery in response to the charge capacity value.

In addition, another embodiment of a moving robot system capable of carrying out an appropriate response according to changes in battery charge levels of a plurality of moving robots and various states of the battery charge levels during collaborative driving is disclosed as a moving robot system in which the plurality of moving robots drive collaboratively, wherein the moving robot system includes a first robot that operates based on power charged by a first charging stand to drive in a zone to be cleaned, and a second robot that operates based on power charged by a second charging stand to drive along a path that has been driven by the first robot, and each of the first robot and the second robot senses a capacity charged in the battery while performing a collaborative driving mode to move each charging stand to charge the battery when a charge capacity value of the battery is less than a preset reference capacity value.

Moreover, an embodiment of a method of performing collaborative driving of a moving robot system capable of carrying out an appropriate response according to changes in battery charge levels of a plurality of moving robots and various states of battery charge levels during collaborative driving is disclosed as a method of performing collaborative driving of a moving robot system including a first robot that operates based on power charged by a first charging stand to drive in a zone to be cleaned, and a second robot that operates based on power charged by a second charging stand to drive along a path that has been driven by the first robot, wherein the method includes starting, by each of the first robot and the second robot, a collaborative driving mode, sensing, by each of the first robot and the second robot, a capacity charged in the battery, comparing, by each of the first robot and the second robot, the charge capacity value with a preset reference capacity value, and performing an independent driving mode or moving to the charging stand to charge the battery, by at least one of the first robot and the second robot, according to the comparison result.

Besides, another embodiment of a method of performing collaborative driving of a moving robot system capable of carrying out an appropriate response according to changes in battery charge levels of a plurality of moving robots and various states of battery charge levels during collaborative driving is disclosed as a method of performing collaborative driving of a moving robot system including a first robot that operates based on power charged by a first charging stand to drive in a zone to be cleaned, and a second robot that operates based on power charged by a second charging stand to drive along a path that has been driven by the first robot, wherein the method includes starting, by each of the first robot and the second robot, a collaborative driving mode, sensing, by each of the first robot and the second robot, a capacity charged in the battery, comparing, by each of the first robot and the second robot, the charge capacity value with a preset reference capacity value, and moving, by at least one of the first robot and the second robot, to the charging stand to charge the battery according to the comparison result.

The embodiments of a moving robot system and a method of performing collaborative driving thereof as described above may be applied and implemented to a robot cleaner, a control system of controlling a robot cleaner, a robot cleaning system, a control method of controlling a robot cleaner, and the like, and effectively applied and implemented particularly to a plurality of moving robots, a moving robot system including a plurality of moving robots, a method of controlling a plurality of moving robots, and the like, and also applied and implemented to all robot cleaners, robot cleaner systems, and methods of controlling robot cleaners to which the technical concept of the above technology can be applied.

### Advantageous Effects of Invention

An embodiment of a moving robot system and a method of performing collaborative driving thereof may determine whether driving states of a plurality of moving robots correspond to preset reference conditions to perform a motion for collaborative driving according to the determination result, thereby having an effect of performing collaborative driving while satisfying various conditions of collaborative driving.

Accordingly, inaccurate and unstable collaborative driving of a plurality of moving robots may be prevented, thereby having an effect of performing collaborative driving in a safe and accurate environment/state.

Furthermore, collaborative driving may be performed in a state where the conditions of collaborative driving are satisfied, thereby having an effect of carrying out appropriate responses to various events that occur during collaborative driving.

For instance, appropriate responses to a trap situation, various error situations, and an obstacle sensing situation, respectively, that occur during collaborative driving, may be carried out, thereby having an effect of safely and reliably performing collaborative driving.

In addition, each of the plurality of moving robots may sense a capacity charged in the battery while performing a collaborative driving mode, and each of the plurality of moving robots may perform a response operation according to the sensing result, thereby having an effect of carrying out an appropriate response to changes in battery charge levels.

Accordingly, it may be possible not only to perform effective cleaning according to various states of battery charge levels while performing collaborative driving, but also to prevent the plurality of moving robots from being neglected when collaborative driving is interrupted due to changes in the battery charge levels while performing collaborative driving, thereby having an effect of appropriately and easily carrying out a follow-up operation subsequent to the interruption of the collaborative driving.

### BRIEF DESCRIPTION OF DRAWINGS

FIGS. 1A and 1B are configuration views (a) and (b) of a moving robot.

FIG. 2 is a detailed configuration view of a moving robot.

FIG. 3 is an exemplary view of a moving robot system.

FIG. 4 is a conceptual view illustrating network communication between a plurality of moving robots in a moving robot system.

FIG. 5 is a conceptual view of driving of a plurality of moving robots in a moving robot system.

FIG. 6 is a detailed exemplary view of driving of the plurality of moving robots according to the conceptual view illustrated in FIG. 5.

FIG. 7 is a flowchart showing a sequence in which a plurality of moving robots perform collaborative driving.

FIGS. 8 (a) and (b) are exemplary views for explaining the concept of recognizing a position through image comparison between a plurality of moving robots.

FIG. 9 is an exemplary view for explaining the concept of position recognition between a plurality of moving robots.

FIG. 10 (a) to (d) are exemplary views in which a plurality of moving robots perform collaborative driving.

FIG. 11 is a configuration view of a moving robot system according to an embodiment.

FIG. 12 is a flowchart showing a process in which a collaborative driving mode is performed in a moving robot system according to an embodiment.

FIG. 13 is a chart showing an example in which a collaborative driving mode is performed in a moving robot system according to an embodiment.

FIG. 14 is a flowchart of a method of performing collaborative driving of a moving robot system according to an embodiment.

FIG. 15 is a flowchart according to a specific embodiment of the method of performing collaborative driving illustrated in FIG. 14.

FIG. 16 is a view illustrating collaborative driving of a moving robot system according to Embodiment 1.

FIG. 17 is a view illustrating a moving robot system that performs a preset scenario when a first robot according to Embodiment 1 is in a trap situation.

FIG. 18 is a view illustrating a moving robot system that performs a preset scenario when a first robot according to Embodiment 1 is in a trap situation.

FIG. 19 is a view illustrating a moving robot system that performs a preset scenario when a second robot according to Embodiment 1 is in a trap situation.

FIG. 20 is a view illustrating a moving robot system that performs a preset scenario when a first robot according to Embodiment 1 is in a trap situation.

FIG. 21 is a view illustrating a moving robot system that performs a preset scenario when a first robot and a second robot according to Embodiment 1 are in a trap situation.

FIG. 22 is a flowchart of a method of performing collaborative driving of a moving robot system when a trap situation according to Embodiment 1 occurs.

FIG. 23 is a view illustrating collaborative driving of a moving robot system according to Embodiment 2.

FIG. 24A is a view (a) illustrating a moving robot system that performs a preset scenario in response to an error that occurs in the first robot according to Embodiment 2.

FIG. 24B is a view (b) illustrating a moving robot system that performs a preset scenario in response to an error that occurs in the first robot according to Embodiment 2.

FIG. 24C is a view (c) illustrating a moving robot system that performs a preset scenario in response to an error that occurs in the first robot according to Embodiment 2.

FIG. 25 is a view illustrating a moving robot system that performs a preset scenario in response to errors occurring in the first robot and the second robot according to Embodiment 2.

FIG. 26A is a view (a) illustrating a moving robot system that performs a preset scenario in response to an error that occurs in the second robot according to Embodiment 2.

FIG. 26B is a view (b) illustrating a moving robot system that performs a preset scenario in response to an error that occurs in the second robot according to Embodiment 2.

FIG. 26C is a view (c) illustrating a moving robot system that performs a preset scenario in response to an error that occurs in the second robot according to Embodiment 2.

FIG. 27A is a view (a) illustrating a moving robot system that performs a preset scenario in response to a kidnap that occurs in the first robot according to Embodiment 2.

FIG. 27B is a view (b) illustrating a moving robot system that performs a preset scenario in response to a kidnap that occurs in the first robot according to Embodiment 2.

FIG. 27C is a view (c) illustrating a moving robot system that performs a preset scenario in response to a kidnap that occurs in the first robot according to Embodiment 2.

FIG. 28A is a view (a) illustrating a moving robot system that performs a preset scenario in response to a kidnap that occurs in the second robot according to Embodiment 2.

FIG. 28B is a view (b) illustrating a moving robot system that performs a preset scenario in response to a kidnap that occurs in the second robot according to Embodiment 2.

FIG. 28C is a view (c) illustrating a moving robot system that performs a preset scenario in response to a kidnap that occurs in the second robot according to Embodiment 2.

FIG. 29 is a flowchart illustrating a method in which the moving robot system according to Embodiment 2 performs a preset scenario in response to an error, a kidnap, or a communication failure that occurs while performing collaborative driving.

FIG. 30 is a view illustrating a method in which a moving robot system according to Embodiment 3 divides a zone to be cleaned into a plurality of unit zones, and collaboratively drives for each unit area.

FIG. 31 is a view illustrating a preset scenario performed when a first robot and a second robot sense a first obstacle, according to Embodiment 3.

FIG. 32 is a view illustrating a preset scenario performed when the first robot does not sense the first obstacle but the second robot senses the first obstacle, according to Embodiment 3.

FIG. 33 is a view illustrating a preset scenario performed when the first robot and the second robot do not sense the first obstacle, according to Embodiment 3.

FIG. 34 is a view illustrating a preset scenario performed when the first robot sense a second obstacle but the second robot does not sense the second obstacle, according to Embodiment 3.

FIG. 35 is a flowchart illustrating a method in which the moving robot system according to Embodiment 3 performs a preset scenario in response to an obstacle sensed during collaborative driving.

FIG. 36A is a chart (a) showing an example of a response according to charge capacity states of batteries while a collaborative driving mode is performed in a moving robot system according to Embodiment 4.

FIG. 36B is a chart (b) showing an example of a response according to charge capacity states of batteries while a collaborative driving mode is performed in a moving robot system according to Embodiment 4.

FIG. 37 is an exemplary view (1) illustrating a response of a plurality of moving robots in the moving robot system according to Embodiment 4.

FIG. 38 is an exemplary view (2) illustrating a response of a plurality of moving robots in the moving robot system according to Embodiment 4.

FIG. 39 is an exemplary view (3) illustrating a response of a plurality of moving robots in the moving robot system according to Embodiment 4.

FIG. 40 is a flowchart of a method of performing collaborative driving of the moving robot system according to Embodiment 4.

### MODE FOR THE INVENTION

Hereinafter, an embodiment of a moving robot system will be described in more detail with reference to the accompanying drawings, and it should be noted that technological terms used below are merely used to describe a specific embodiment, but do not the concept of the present disclosure.

First, a configuration of a moving robot (hereinafter, referred to as a “robot”) in the embodiment of the moving robot system will be described.

The robot may be a cleaning robot that performs cleaning while driving or traveling.

The robot may be a cleaning robot that performs driving and cleaning automatically or by a user's manipulation.

For instance, the robot may be an autonomous driving cleaner and a cleaner that performs autonomous driving (or autonomous traveling).

The robot may be a cleaning robot that recognizes a position while driving in a predetermined area.

The robot may be a cleaning robot that recognizes a position while driving as well as creates a map in a predetermined area.

The robot may perform a function of cleaning the floor while driving on its own in a predetermined area, and the cleaning of the floor referred to herein includes suctioning dust (including foreign substances) on the floor or mopping the floor.

The robot may have a plurality of configurations (constituting components) for driving and cleaning.

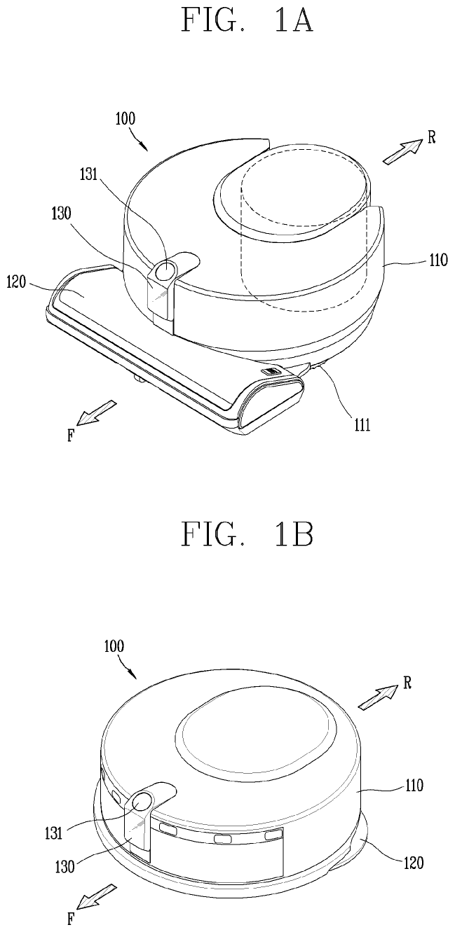

For example, the robot 100 may have a shape as illustrated in FIG. 1A or FIG. 1B.

The robot 100 may have a shape as illustrated in FIG. 1A, or may have a shape as shown in FIG. 1B, or may have a shape modified from that illustrated in FIGS. 1A and 1B, or may have a shape different from that illustrated in FIGS. 1A and 1B.

As illustrated in FIGS. 1A and 1B, the robot 100 may include a main body 110, a cleaning unit 120, and a sensing unit 130.

The main body 110 defines an appearance of the robot 100, and may perform driving (or traveling) and cleaning.

In other words, the main body 110 may perform an overall operation of the robot 100.

The main body 110 may have a shape that facilitates driving and cleaning to define an appearance of the robot 100.

For example, it may be defined in a circular shape, and may also be defined in a rectangular shape with rounded corners.

The main body 110 may have constituting components for allowing the robot 100 to travel and perform cleaning.

Constituting components for enabling the robot 100 to travel and perform cleaning may be provided at an inside or outside of the main body 110.

For example, constituting components in association with a driving (or traveling) operation, a cleaning operation, or sensing may be provided at the outside of the main body 110, and constituting components in association with the control of the robot 100 may be provided at the inside of the main body 110.

Furthermore, the main body 110 may be provided with a wheel unit 111 that allows the robot 100 to travel.

Accordingly, the robot 100 may be moved or rotated back and forth, left and right by the wheel unit 111.

Furthermore, the main body 110 may be mounted with a battery (not shown) that supplies the power of the robot 100.

The battery may be configured to be rechargeable, and configured to be detachable from a bottom portion of the main body 110.

The cleaning unit 120 may be disposed in a protruding form from one side of the main body 110, so as to suck air containing dust or mop an area.

Here, the one side may be a side where the main body 110 drives in a forward direction (F), that is, a front side of the main body 110.

The cleaning unit 120 may be detachably coupled to the main body 110.

When the cleaning unit 120 is separated from the main body 110, a mop unit (not shown) may be detachably coupled to the main body 110 to replace the separated cleaning unit 120.

Accordingly, the user may mount the cleaning unit 120 on the main body 110 when the user wants to remove dust on the floor, and may mount the mop unit on the main body 110 when the user wants to mop the floor.

The sensing unit 130 may be disposed on one side of the main body 110 where the cleaning unit 120 is located, that is, at a front side of the main body 110.

The sensing unit 130 may be disposed to overlap with the cleaning unit 120 in a vertical direction of the main body 110.

The sensing unit 130 is disposed at an upper portion of the main body 110 to sense an obstacle or a feature in front to prevent the robot 100 from colliding with the obstacle.

The sensing unit 130 may be configured to additionally perform another sensing function other than the sensing function.

For an example, the sensing unit 130 may include a camera 131 for acquiring surrounding images.

The camera 131 may include a lens and an image sensor.

The camera 131 may convert a surrounding image of the main body 110 into an electrical signal that can be processed by the control unit, for example, to transmit the electrical signal corresponding to an upward image to the control unit.

Here, the electrical signal corresponding to the upward image may be used by the control unit to detect the position of the main body 110.

In addition, the sensing unit 130 may sense an obstacle such as a wall, a furniture, and a cliff on a driving surface or a driving path of the robot 100.

Furthermore, the sensing unit 130 may sense presence of a docking device that performs battery charging.

In addition, the sensing unit 130 may sense ceiling information so as to map a driving zone or a cleaning zone of the robot 100.

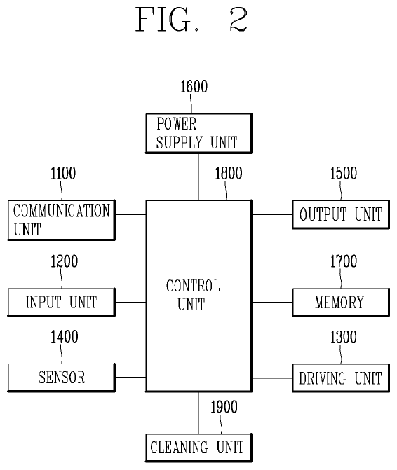

An embodiment related to specific components of the robot 100 will be described below with reference to FIG. 2.

As illustrated in FIG. 2, the robot 100 may include a communication unit 1100, an input unit 1200, a driving unit 1300, a sensing unit 1400, an output unit 1500, a power supply unit 1600, a memory 1700, a control unit 1800, and a cleaning unit 1900, or a combination thereof.

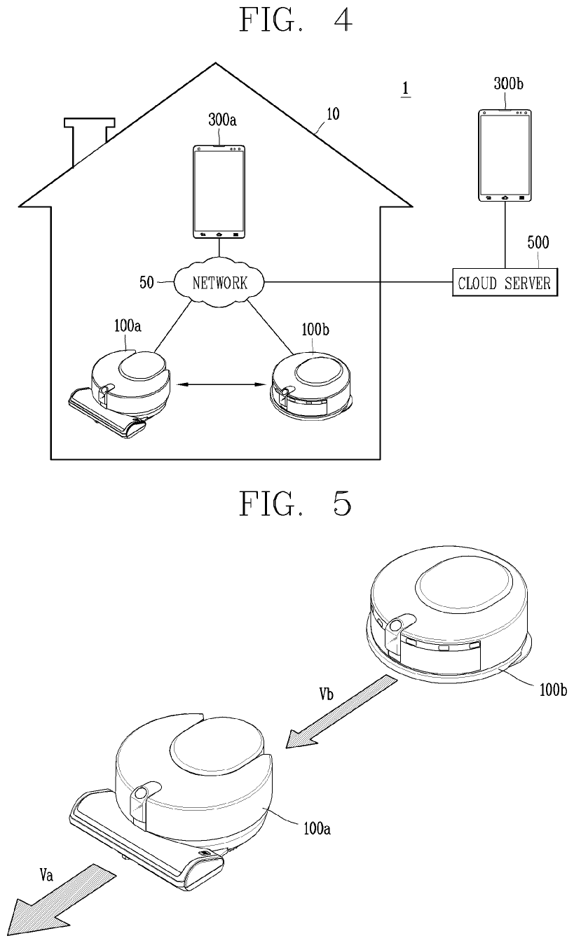

Here, it is needless to say that the components shown in FIG. 2 are not essential, and thus an autonomous cleaner having more or fewer components than shown in FIG. 4 may be implemented. Furthermore, as described above, a plurality of moving robots described therein may include only some of the same components to be described below. In other words, the plurality of moving robots may include different components.

Hereinafter, each component will be described.

First, the power supply unit 1600 includes a battery that can be charged by an external commercial power source to supply power to the robot 100.

The power supply unit 1600 supplies driving power to each of the components included in the robot 100 to supply operating power required for the robot 100 to drive or perform a specific function.

Here, the control unit 1800 may sense the remaining power of the battery, and control the battery to move power to a charging stand connected to the external commercial power source when the remaining power is insufficient, and thus a charge current may be supplied from the charging stand to charge the battery.

The battery may be connected to a battery sensing unit to transmit a remaining power level and a charging state to the control unit 1800. At this time, the output unit 1500 may display the remaining amount of the battery by the control unit 1800.

The control unit 1800 performs a role of processing information based on an artificial intelligence technology and may include at least one circuit module for performing at least one of learning of information, inference of information, perception of information, and processing of a natural language.

The control unit 1800 may use a machine learning technology to perform at least one of learning, inference and processing of a large amount of information (big data), such as information stored in the robot 100, environment information around the mobile terminal, information stored in a communicable external storage, and the like. Furthermore, the control unit 1800 may predict (or infer) at least one executable operation of the robot 100 based on information learned using the machine learning technology, and control the robot 100 to execute the most feasible operation among the at least one predicted operation.

The machine learning technology is a technology that collects and learns a large amount of information based on at least one algorithm, and determines and predicts information based on the learned information. The learning of information is an operation of recognizing the features of information, rules and judgment criteria, quantifying a relation between information and information, and predicting new data using the quantified patterns.

Algorithms used by the machine learning technology may be algorithms based on statistics, for example, a decision tree that uses a tree structure type as a prediction model, an artificial neural network that mimics neural network structures and functions of living creatures, genetic programming based on biological evolutionary algorithms, clustering of distributing observed examples to a subset of clusters, a Monte Carlo method of computing function values as probability using randomly-extracted random numbers, and the like.

As one field of the machine learning technology, deep learning is a technology of performing at least one of learning, determining, and processing information using a deep neural network (DNN) algorithm. The deep neural network (DNN) may have a structure of linking layers and transferring data between the layers. This deep learning technology may be employed to learn a vast amount of information through the deep neural network (DNN) using a graphic processing unit (GPU) optimized for parallel computing.

The control unit 1800 may use training data stored in an external server or the memory 1700, and may include a learning engine for detecting a feature for recognizing a predetermined object. Here, the feature for recognizing an object may include the size, shape, and shade of the object.

Specifically, when the control unit 1800 inputs a part of images acquired through the camera 131 into the learning engine, the learning engine may recognize at least one thing or creature included in the input images.

When the learning engine is applied to driving of the cleaner, the control unit 1800 can recognize whether or not an obstacle such as a chair leg, a fan, and a specific shape of balcony gap, which obstruct the running of the cleaner, exists around the robot 100. This may result in enhancing efficiency and reliability of the driving of the robot 100.

On the other hand, the learning engine may be mounted on the control unit 1800 or on an external server. When the learning engine is mounted on an external server, the control unit 1800 may control the communication unit 1100 to transmit at least one image to be analyzed, to the external server.

The external server may input the image transmitted from the cleaner into the learning engine and thus recognize at least one thing or creature included in the image. In addition, the external server may transmit information related to the recognition result back to the cleaner. In this case, the information related to the recognition result may include information related to the number of objects included in the image to be analyzed and a name of each object.

The driving unit 1300 may be provided with a motor to drive the motor, thereby rotating the left and right main wheels in both directions to rotate or move the main body. At this time, the left and right main wheels may be independently moved. The driving unit 1300 may allow the main body 110 to move forward, backward, left, right, curvedly, or rotate in place.

The input unit 1200 may receive various control commands for the robot 100 from the user.

The input unit 1200 may include one or more buttons.

For example, the input unit 1200 may include a confirmation button, a setting button, and the like. The OK button is a button for receiving a command for confirming sensing information, obstacle information, position information, and map information from the user, and the set button is a button for receiving a command for setting the information from the user.

In addition, the input unit 1200 may include an input reset button for canceling a previous user input and receiving a user input again, a delete button for deleting a preset user input, a button for setting or changing an operation mode, a button for receiving a command to be restored to the charging stand, and the like.

Furthermore, the input unit 1200, such as a hard key, a soft key, a touch pad, or the like, may be provided at an upper portion of the moving robot. In addition, the input unit 1200 may have a form of a touch screen along with the output unit 1500.

The output unit 1500 may be provided at an upper portion of the robot 100. Of course, the installation position and installation type may vary. For example, the output unit 1500 may display a battery state, a driving mode, and the like on the screen.

In addition, the output unit 1500 may output state information inside the moving robot detected by the sensing unit 1400, for example, a current state of each configuration included in the moving robot. Moreover, the output unit 1500 may display external state information, obstacle information, position information, map information, and the like detected by the sensing unit 1400 on the screen. The output unit 1500 may be formed with any one of a light emitting diode (LED), a liquid crystal display (LCD), a plasma display panel, and an organic light emitting diode (OLED).

The output unit 1500 may further include a sound output device for audibly outputting an operation process or an operation result of the robot 100 performed by the control unit 1800. For example, the output unit 1500 may output warning sound to the outside in response to a warning signal generated by the control unit 1800.

In this case, the audio output module (not shown) may be a device, such as a beeper, a speaker or the like for outputting sounds, and the output unit 1500 may output sounds to the outside through the audio output module using audio data or message data having a predetermined pattern stored in the memory 1700.

Accordingly, the robot 100 according to an embodiment of the present disclosure may display environment information on a driving area on the screen or output the information as sound. According to another embodiment, the robot may transmit map information or environment information to a terminal device through the communication unit 1100 to output a screen or sound to be output through the output unit 1500.

The memory 1700 stores a control program for controlling or driving the robot 100 and the resultant data. The memory 1700 may store audio information, image information, obstacle information, position information, map information, and the like. Furthermore, the memory 1700 may store information related to a driving pattern.

The memory 1700 mainly uses a non-volatile memory. Here, the non-volatile memory (NVM, NVRAM) is a storage device capable of continuously storing information even when power is not supplied thereto, and for an example, the non-volatile memory may be a ROM, a flash memory, a magnetic computer storage device (e.g., a hard disk, a diskette drive, a magnetic tape), an optical disk drive, a magnetic RAM, a PRAM, and the like.

Furthermore, a map for a driving zone may be stored in the memory 1700. The map may be received by an external terminal or a server capable of exchanging information with the robot 100 through wired or wireless communication, or may be generated by the robot 100 itself while driving.

The map may indicate the positions of rooms within the driving zone. In addition, a current position of the robot 100 may be displayed on the map, and the current position of the robot 100 on the map may be updated during the driving process.

The memory 1700 may store cleaning history information. Such cleaning history information may be generated whenever cleaning is performed.

The map for the driving zone stored in the memory 1700 is data that stores predetermined information of the driving zone in a predetermined format, such as a navigation map used for driving while cleaning, simultaneous localization and mapping (SLAM) map used for position recognition, a learning map used for learning cleaning by storing the information when the robot collides with an obstacle, a global position map used for global position recognition, an obstacle recognition map in which information on the recognized obstacle is recorded, and the like.

The map may denote a node map including a plurality of nodes. Here, the node denotes data indicating any one position on the map corresponding to a point that is any one position in the driving zone.

Meanwhile, the sensing unit 1400 may include at least one of an external signal detection sensor, a front detection sensor, a cliff detection sensor, a two-dimensional camera sensor, and a three-dimensional camera sensor.

The external signal detection sensor may sense an external signal of the robot 100. The external signal detection sensor may be, for example, an infrared ray sensor, an ultrasonic sensor, a radio frequency (RF) sensor, or the like.

The robot 100 may receive a guide signal generated by the charging stand using the external signal detection sensor to check the position and direction of the charging stand. At this time, the charging stand may transmit a guidance signal indicating a direction and distance so that the moving robot can return thereto. In other words, the robot 100 may determine a current position and set a moving direction by receiving a signal transmitted from the charging stand, thereby returning to the charging stand.

On the other hand, the front detection sensors may be provided at regular intervals on a front side of the robot 100, specifically, along a side outer circumferential surface of the robot 100. The front sensor is located on at least one side surface of the robot 100 to detect an obstacle in front of the moving robot. The front sensor may detect an object, especially an obstacle, existing in a moving direction of the robot 100 and transmit detection information to the control unit 1800. In other words, the front sensor may detect protrusions on the moving path of the robot 100, household appliances, furniture, walls, wall corners, and the like, and transmit the information to the control unit 1800.

For example, the frontal sensor may be an infrared ray (IR) sensor, an ultrasonic sensor, an RF sensor, a geomagnetic sensor, or the like, and the robot 100 may use one type of sensor as the front sensor or two or more types of sensors if necessary.

For an example, the ultrasonic sensors may be mainly used to sense a distant obstacle in general. The ultrasonic sensor may include a transmitter and a receiver, and the control unit 1800 may determine whether or not there exists an obstacle based on whether or not ultrasonic waves radiated through the transmitter is reflected by the obstacle or the like and received at the receiver, and calculate a distance to the obstacle using the ultrasonic emission time and ultrasonic reception time.

Furthermore, the control unit 1800 may compare ultrasonic waves emitted from the transmitter and ultrasonic waves received at the receiver to detect information related to a size of the obstacle. For example, the control unit 1800 may determine that the larger the obstacle is, the more ultrasonic waves are received at the receiver.

In one embodiment, a plurality of (e.g., five) ultrasonic sensors may be provided along a lateral outer circumferential surface at a front side of the robot 100. At this time, the ultrasonic sensors may preferably be provided on a front surface of the robot 100 in a manner that the transmitter and the receiver are alternately arranged.

In other words, the transmitters may be disposed at right and left sides with being spaced apart from a front center of the main body or one transmitter or at least two transmitters may be disposed between the receivers so as to form a reception area of an ultrasonic signal reflected from an obstacle or the like. With this arrangement, the receiving area may be expanded while reducing the number of sensors. A transmission angle of ultrasonic waves may maintain a range of angles that do not affect different signals to prevent a crosstalk phenomenon. Furthermore, the receiving sensitivities of the receivers may be set to be different from each other.

In addition, the ultrasonic sensor may be provided upward by a predetermined angle to output ultrasonic waves transmitted from the ultrasonic sensor in an upward direction, and here, the ultrasonic sensor may further include a predetermined blocking member to prevent ultrasonic waves from being radiated downward.

On the other hand, as described above, the front sensor may be implemented by using two or more types of sensors together, and thus the front sensor may use any one of an IR sensor, an ultrasonic sensor, an RF sensor and the like.

For example, the front detection sensor may include an infrared sensor as a different type of sensor other than the ultrasonic sensor.

The infrared sensor may be provided on an outer circumferential surface of the robot 100 together with the ultrasonic sensor. The infrared sensor may also sense an obstacle existing at the front or the side to transmit obstacle information to the control unit 1800. In other words, the infrared sensor may sense a protrusion, a household appliance, a furniture, a wall surface, a wall corner, and the like, on the moving path of the robot 100 to transmit the information to the control unit 1800. Therefore, the main body 110 may move within a specific area without collision with the obstacle.

On the other hand, a cliff detection sensor (or cliff sensor) may sense an obstacle on the floor supporting the main body 110 mainly using various types of optical sensors.

In other words, the cliff detection sensor may be provided on a rear surface of the robot 100, but may of course be installed in a different position depending on the type of the robot 100. The cliff detection sensor is a sensor located on a back surface of the robot 100 to sense an obstacle on the floor, and the cliff detection sensor may be an infrared sensor, an ultrasonic sensor, an RF sensor, a PSD (Position Sensitive Detector) sensor, or the like, which is provided with a transmitter and a receiver such as the obstacle detection sensor.

For example, one of the cliff sensors may be provided on the front of the robot 100, and two other cliff sensors may be installed relatively behind.

For example, the cliff detection sensor may be a PSD sensor, but may also be configured with a plurality of different kinds of sensors.

The PSD sensor detects a short and long-distance position of incident light with one p-n junction using a semiconductor surface resistance. The PSD sensor includes a one-dimensional PSD sensor that detects light only in one axial direction, and a two-dimensional PSD sensor that detects a light position on a plane. Both of the PSD sensors may have a pin photo diode structure. The PSD sensor is a type of infrared sensor that uses infrared rays to transmit infrared rays and then measure an angle of infrared rays reflected from and returned back to an obstacle so as to measure a distance. In other words, the PSD sensor calculates a distance from the obstacle by using the triangulation method.

The PSD sensor includes a light emitter that emits infrared rays to an obstacle and a light receiver that receives infrared rays that are reflected and returned from the obstacle, and is configured typically as a module type. When an obstacle is sensed using the PSD sensor, a stable measurement value may be obtained irrespective of the reflectance and the color difference of the obstacle.

The control unit 1800 may measure an infrared angle between an emission signal of infrared rays emitted from the cliff detection sensor toward the ground and a reflection signal reflected and received by the obstacle to sense a cliff and analyze the depth thereof.

On the other hand, the control unit 1800 may determine whether or not to pass according to the ground state of the sensed cliff using the cliff detection sensor, and determine whether or not to pass through the cliff according to the determination result. For example, the control unit 1800 determines presence or non-presence of a cliff and a depth of the cliff through the cliff sensor, and then allows the moving robot to pass through the cliff only when a reflection signal is detected through the cliff sensor.

For another example, the control unit 1800 may determine a lifting phenomenon of the robot 100 using the cliff detection sensor.

On the other hand, the two-dimensional camera sensor is provided on one side of the robot 100 to acquire image information related to the surroundings of the main body during movement.

An optical flow sensor converts a downward image input from an image sensor provided in the sensor to generate image data in a predetermined format. The generated image data may be stored in the memory 1700.

Furthermore, one or more light sources may be provided adjacent to the optical flow sensor. The one or more light sources irradiate light to a predetermined area of the bottom surface captured by the image sensor. In other words, when the robot 100 moves in a specific area along the bottom surface, a predetermined distance is maintained between the image sensor and the bottom surface when the bottom surface is flat. On the contrary, when the moving robot moves on a bottom surface having an uneven surface, the image sensor and the bottom surface are spaced apart from each other by more than a predetermined distance due to an unevenness and an obstacle on the floor surface. At this time, the one or more light sources may be controlled by the control unit 1800 to adjust an amount of light to be irradiated. The light source may be a light emitting device capable of controlling the amount of light, for example, a light emitting diode (LED) or the like.

Using the optical flow sensor, the control unit 1800 may detect the position of the robot 100 irrespective of the slippage of the robot 100. The control unit 1800 may compare and analyze the image data captured by the optical flow sensor over time to calculate the moving distance and the moving direction, and calculate the position of the robot 100 on the basis of the moving distance and the moving direction. Using image information on a bottom side of the robot 100 using the optical flow sensor, the control unit 1800 may perform slip-resistant correction on the position of the robot 100 calculated by another device.

The three-dimensional camera sensor may be attached to one side or a part of the main body 110 to generate three-dimensional coordinate information related to the surroundings of the main body 110.

In other words, the three-dimensional camera sensor may be a three-dimensional (3D) depth camera that calculates a near and far distance of the robot 100 and an object to be captured.

Specifically, the three-dimensional camera sensor may capture a two-dimensional image related to the surroundings of the main body 110, and generate a plurality of three-dimensional coordinate information corresponding to the captured two-dimensional image.

In an embodiment, the three-dimensional camera sensor may include two or more cameras that acquire a conventional two-dimensional image, and may be formed in a stereo vision manner to combine two or more images obtained from the two or more cameras so as to generate three-dimensional coordinate information.

Specifically, the three-dimensional camera sensor according to the embodiment may include a first pattern irradiation unit for irradiating light with a first pattern in a downward direction toward the front of the main body, and a second pattern irradiation unit for irradiating the light with a second pattern in an upward direction toward the front of the main body 110, and an image acquisition unit for acquiring an image in front of the main body. As a result, the image acquisition unit may acquire an image of an area where light of the first pattern and light of the second pattern are incident.

In another embodiment, the three-dimensional camera sensor may include an infrared ray pattern emission unit for irradiating an infrared ray pattern together with a single camera, and capture the shape of the infrared ray pattern irradiated from the infrared ray pattern emission unit onto the object to be captured, thereby measuring a distance between the sensor and the object to be captured. Such a three-dimensional camera sensor may be an infrared (IR) type three-dimensional camera sensor.

In still another embodiment, the three-dimensional camera sensor may include a light emitting unit that emits light together with a single camera, receive a part of laser emitted from the light emitting unit reflected from the object to be captured, and analyze the received laser, thereby measuring a distance between the three-dimensional camera sensor and the object to be captured. The three-dimensional camera sensor may be a time-of-flight (TOF) type three-dimensional camera sensor.

Specifically, the laser of the above-described three-dimensional camera sensor is configured to irradiate a laser beam in the form of extending in at least one direction. In one example, the three-dimensional camera sensor may include first and second lasers, wherein the first laser irradiates a linear shaped laser intersecting each other, and the second laser irradiates a single linear shaped laser. According to this, the lowermost laser is used to sense obstacles in the bottom portion, the uppermost laser is used to sense obstacles in the upper portion, and the intermediate laser between the lowermost laser and the uppermost laser is used to sense obstacles in the middle portion.

While the robot 100 is driving, the sensing unit 1400 acquires images around the robot 100. Hereinafter, an image acquired by the sensing unit 1400 is defined as an “acquired image”.

The acquired image includes various features such as lights located on the ceiling, edges, corners, blobs, and ridges.

The control unit 1800 detects a feature from each of the acquired images, and calculates a descriptor based on each feature point. The descriptor denotes data in a predetermined format for representing a feature point, and denotes mathematical data in a format capable of calculating a distance or a degree of similarity between descriptors. For example, the descriptor may be an n-dimensional vector (n is a natural number) or data in a matrix format.

The control unit 1800 classifies at least one descriptor for each acquired image into a plurality of groups according to a predetermined sub-classification rule based on descriptor information obtained through the acquired image at each position, and converts descriptors included in the same group according to a predetermined sub-representative rule into sub-representative descriptors, respectively.

For another example, all descriptors collected from acquired images within a predetermined zone such as a room are classified into a plurality of groups according to a predetermined sub-classification rule, and descriptors included in the same group according to the predetermined sub-representative rule are respectively classified as sub-representative descriptors.

The control unit 1800 may obtain the feature distribution of each position through this process. Each position feature distribution may be expressed as a histogram or an n-dimensional vector. For another example, the control unit 1800 may estimate an unknown current position based on descriptors calculated from each feature point without going through a predetermined sub-classification rule and a predetermined sub-representative rule.

Furthermore, when the current position of the robot 100 becomes unknown due to a position jump or the like, the current position may be estimated based on data such as a pre-stored descriptor or a sub-representative descriptor.

The robot 100 acquires an acquired image through the sensing unit 1400 at an unknown current position. Various features such as lights located on the ceiling, edges, corners, blobs, and ridges are identified through the image.

The control unit 1800 detects features from the acquired image and calculates a descriptor.

The control unit 1800 converts the acquired image into information (sub-recognition feature distribution) that is comparable with position information to be compared (e.g., feature distribution of each position) according to a predetermined sub-conversion rule based on at least one descriptor information obtained through the acquired image of the unknown current position.

According to a predetermined sub-comparison rule, each positional feature distribution may be compared with each recognition feature distribution to calculate each degree of similarity. A degree of similarity (probability) may be calculated for the position corresponding to each position, and a position from which the greatest probability is calculated may be determined as a current position.

In this way, the control unit 1800 may divide a driving zone and generate a map consisting of a plurality of areas, or recognize the current position of the robot 100 based on a pre-stored map.

On the other hand, the communication unit 1100 is connected to a terminal device and/or another device (also referred to as “home appliance” herein) through one of wired, wireless and satellite communication methods, so as to transmit and receive signals and data.

The communication unit 1100 may transmit and receive data with another located in a specific area. Here, the another device may be any device capable of connecting to a network to transmit and receive data, and for example, the device may be an air conditioner, a heating device, an air purification device, a lamp, a TV, an automobile, or the like. The another device may also be a device for controlling a door, a window, a water supply valve, a gas valve, or the like. The another device may be a sensor for sensing temperature, humidity, air pressure, gas, or the like.

Further, the communication unit 1100 may communicate with another cleaner located in a specific area or within a predetermined range.

When a map is generated, the control unit 1800 may transmit the generated map to an external terminal or a server through the communication unit 1100, and may store the map in its own memory 1700. Furthermore, as described above, when a map is received from an external terminal, a server, or the like, the control unit 1800 may store the map in the memory 1700.

Hereinafter, a moving robot system (hereinafter, referred to as a system) in which a plurality of the robots 100 are configured to perform collaboration will be described.

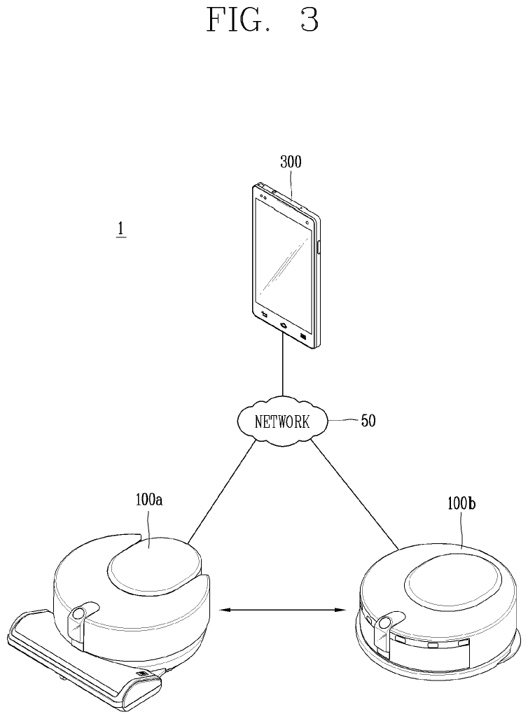

As illustrated in FIGS. 3 and 4, in the system 1, a first robot 100a and a second robot 100b may exchange data with each other through a network 50. In addition, the first robot 100a and/or the second robot 100b may perform a cleaning related operation or a corresponding operation by a control command received from a terminal 300 through the network or other communication.

In other words, although not shown, the plurality of autonomous moving robots 100a, 100b may perform communication with the terminal 300 through a first network communication and perform communication with each other through a second network communication.

Here, the network 50 may refer to network communication, and may refer to short-range communication using at least one of wireless communication technologies, such as a wireless LAN (WLAN), a wireless personal area network (WPAN), a wireless fidelity (Wi-Fi) Wi-Fi direct, Digital Living Network Alliance (DLNA), Wireless Broadband (WiBro), World Interoperability for Microwave Access (WiMAX), Zigbee, Z-wave, Blue-Tooth, Radio Frequency Identification (RFID), Infrared Data Association (IrDA), Ultrawide-Band (UWB), Wireless Universal Serial Bus (USB), and the like.

The network 50 may vary depending on a communication mode of the robots desired to communicate with each other.

In FIG. 3, the first robot 100a and/or the second robot 100b may provide information sensed through each sensing unit 130 to the terminal 300 through the network 50. Furthermore, the terminal 300 may also transmit a control command generated based on the received information to the first robot 100a and/or the second robot 100b through the network 50.

In FIG. 3, the communication unit 1100 of the first robot 100a and the communication unit 1100 of the second robot 100b may also directly communicate with each other or indirectly communicate with each other via another router (not shown), to recognize information related to a driving state and positions of counterparts.

In one example, the second robot 100b may perform a driving operation and a cleaning operation according to a control command received from the first robot 100a. In this case, it may be said that the first robot 100a operates as a master cleaner, and the second robot 100b operates as a slave cleaner. Alternatively, it may be said that the second cleaner 100b follows the first cleaner 100a. In some cases, it may also be said that the first robot 100a and the second robot 100b collaborate with each other.

As an example of collaboration between the first robot 100a and the second robot 100b, the first robot 100a is mounted with the cleaning unit 120, and the second robot 100b is mounted with the mop unit, and the first robot 100a leads the second robot 100b to suck dust on the floor, and the second robot 100b follows the first robot 100a to wipe the floor.

FIG. 4 illustrates an example of a system 1 in which collaboration is carried out by including a plurality of robots 100a, 100b and a plurality of terminals 300a, 300b.

Referring to FIG. 4, the system 1 may include the plurality of robots 100a, 100b, the network 50, a server 500, and the plurality of terminals 300a, 300b.

Among them, the plurality of robots 100a, 100b, the network 50 and at least one terminal 300a may be disposed in a building 10 while another terminal 300b and the server 500 may be located outside the building 10.

Each of the plurality of robots 100a, 100b may perform autonomous driving and autonomous cleaning. Each of the plurality of robots 100a, 100b may include a communication unit 1100, in addition to the driving function and the cleaning function.

The plurality of robots 100a, 100b, the server 500 and the plurality of terminals 300a, 300b may be connected together through the network 50 to exchange data. To this end, although not shown, a wireless router such as an access point (AP) device and the like may further be provided. In this case, the terminal 300a located inside the building 10 may access at least one of the plurality of robots 100a, 100b through the AP device so as to perform monitoring, remote control and the like with respect to the plurality of robots 100a, 100b. Furthermore, the terminal 300b located outside the building 10 may access at least one of the plurality of robots 100a, 100b through the AP device so as to perform monitoring, remote control and the like with respect to the plurality of robots 100a, 100b.

The server 500 may be directly connected in a wireless manner through the mobile terminal 300b. Alternatively, the server 500 may be connected to at least one of the plurality of robots 100a, 100b without passing through the mobile terminal 300b.

The server 500 may include a programmable processor and may include various algorithms. For an example, the server 500 may have an algorithm related to the execution of machine learning and/or data mining. For another example, the server 500 may include a voice recognition algorithm. In this case, upon receiving voice data, the received voice data may be converted into text format data and then output.

The server 500 may store firmware information, operation information (course information and the like) related to the plurality of robots 100a, 100b, and may register product information regarding the plurality of robots 100a, 100b. For example, the server 500 may be a server operated by a robot manufacturer or a server operated by an open application store operator.

In another example, the server 500 may be a home server that is provided in an internal network of the building 10 and stores status information regarding the home appliances or stores contents shared by the home appliances. When the server 500 is a home server, information related to foreign substances, for example, foreign substance images and the like may be stored.

Meanwhile, the plurality of robots 100a, 100b may be directly connected to each other in a wireless manner via Zigbee, Z-wave, Blue-Tooth, Ultra-wide band, and the like. In this case, the plurality of robots 100a, 100b may exchange position information and driving information with each other.

At this time, any one of the plurality of robots 100a, 100b may be a master robot 100a and another may be a slave robot 100b.

In this case, the first robot 100a may control the driving and cleaning of the second robot 100b. In addition, the second robot 100b may perform driving and cleaning while following the first robot 100a. Here, following the first robot 100a by the second robot 100b denotes that the second robot 100b and the first robot 100a perform driving and cleaning by following the first robot 100a while maintaining an appropriate distance to the first robot 100a.

Referring to FIG. 5, the first robot 100a controls the second robot 100b such that the second robot 100b follows the first robot 100a.

For this purpose, the first robot 100a and the second robot 100b should exist in a specific area where they can communicate with each other, and the second robot 100b should recognize at least a relative position of the first robot 100a.

For an example, the communication unit 1100 of the first robot 100a and the communication unit 1100 of the second robot 100b exchange IR signals, ultrasonic signals, carrier frequencies, impulse signals, and the like with each other, and analyze them through triangulation, so as to calculate movement displacements of the first robot 100a and the second robot 100b, thereby recognizing relative positions of the first robot 100a and the second robot 100b. However, the present disclosure is not limited to this method, and one of the various wireless communication technologies described above may be used to recognize the relative positions of the first robot 100a and the second robot 100b through triangulation or the like.

When the relative position between the first robot 100a and the second robot 100b is recognized, the second robot 100b may be controlled based on map information stored in the first robot 300 or map information stored in the server 500, the terminal 300 or the like. In addition, the second robot 100b may share obstacle information sensed by the first robot 100a. The second robot 100b may perform an operation based on a control command (e.g., a control command related to a driving direction, a driving speed, a stop, etc.) received from the first robot 100a.

Specifically, the second robot 100b performs cleaning while driving along a driving path of the first robot 100a. However, traveling directions of the first robot 100a and the second robot 100b do not always coincide with each other. For example, when the first robot 100a moves or rotates up/down/right/left, the second robot 100b may move or rotate up/down/right/left after a predetermined time period, and thus current traveling directions thereof may differ from each other.

Furthermore, a driving speed Va of the first robot 100a and a driving speed Vb of the second robot 100b may be different from each other.

The first robot 100a is controlled to vary the driving speed Vb of the second robot 100b in consideration of a communicable distance between the first robot 100a and the second robot 100b. For example, when the first robot 100a and the second robot 100b move away from each other by a predetermined distance or more, the first robot 100a may control the driving speed Vb of the second robot 100b to be faster than before. On the other hand, when the first robot 100a and the second robot 100b move close to each other by a predetermined distance or less, the first robot 100a may control the driving speed Vb of the second robot 100b to be slower than before or control the second robot 100b to stop for a predetermined time period. Accordingly, the second robot 100b may perform cleaning while continuously following the first robot 100a.

In the system 1, the first robot 100a and the second robot 100b may perform driving and cleaning while following each other or collaborating with each other without user intervention.

To this end, it is necessary that the first robot 100a recognizes the position of the second robot 100b or the second robot 100b recognizes the position of the first robot 100a. This may mean that the relative positions of the first robot 100a and the second robot 100b must be recognized.

For instance, the relative positions of the first robot 100a and the second robot 100b may be recognized through triangulation using one of the various wireless communication technologies described above (e.g., Zigbee, Z-wave, Blue-Tooth and Ultra-wide Band).

Since the triangulation method for obtaining the relative positions of two devices is a general technology, a detailed description thereof will be omitted herein, and as an example of recognizing the relative positions of the first robot 100a and the second robot 100b in the system 1, an example in which the first robot 100a and the second robot 100b determine (recognize) relative positions using a UWB module will be described.

As described above, the UWB module (or UWB sensor) may be included in the communication unit 1100 of each of the first robot 100a and the second robot 100b. In view of the fact that the UWB modules are used to sense the relative positions of the first cleaner 100a and the second cleaner 100b, the UWB modules may be included in the sensing unit 1400 of each of the first robot 100a and the second robot 100b.

The first robot 100a and the second robot 100b may measure time periods of signals transmitted and received between the UWB modules, respectively, included in each robot to obtain a distance (separation distance) between the first robot 100a and the second robot 100b.

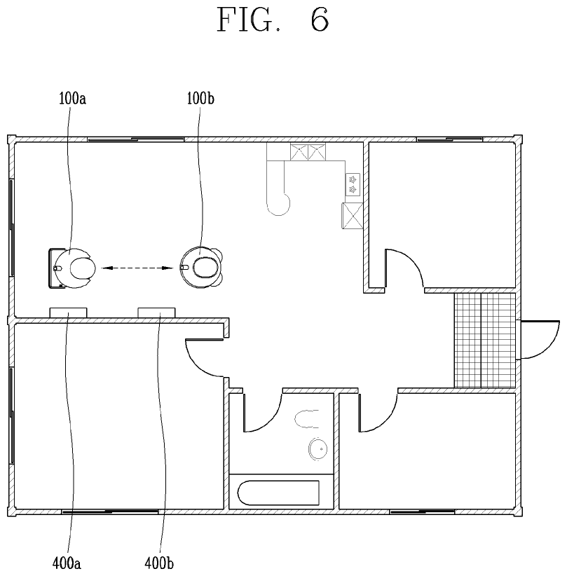

Hereinafter, a principle in which the first robot 100a and the second robot 100b perform collaborative driving while recognizing positions through sharing of map information will be described with reference to FIGS. 6 to 8.

As illustrated in FIG. 6, the first robot 100a and the second robot 100b may be disposed in one cleaning space. A house, which is an entire space in which cleaning is typically performed, may be divided into several spaces such as a living room, a room, and a kitchen.

The first robot 100a has map information on the entire space in a state in which the space has been cleaned at least once. In this case, the map information may be input by the user or based on a record obtained while the first robot 100a performs cleaning. Although the first robot 100a in FIG. 6 is located in the living room or kitchen, it is possible to have map information on the entire space of the house.

Here, each of the first robot 100a and the second robot 100b may be assigned a charging stand. In other words, the two robots 100a, 100b do not share a charging stand, and the batteries may be charged at a charging stand corresponding to each robot. For instance, the first robot 100a may be docked to a first charging stand to charge the battery, and the second robot 100b may be docked to a second charging stand to charge the battery. In addition, each of the first robot 100a and the second robot 100b may store information on the position of the charging stand between each other. For instance, the position information of the second charging stand may be stored in the first robot 100a to recognize the position during the docking of the second robot 100b, and the position information of the first charging stand may be stored in the second robot 100b to recognize the position during the docking of the first robot 100a.

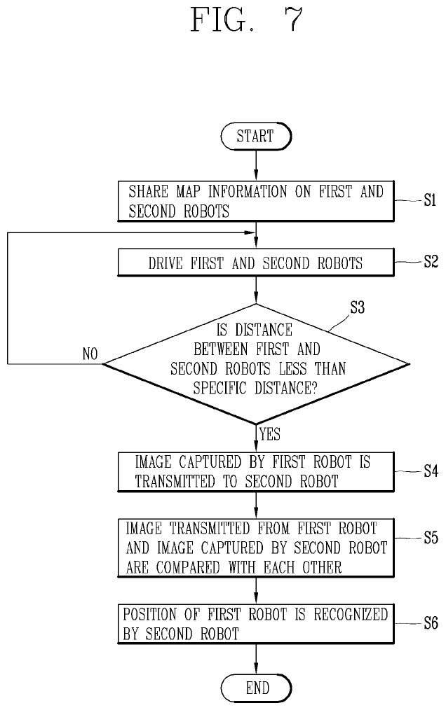

A process in which the first robot 100a and the second robot 100b perform collaboration in such a space may be as illustrated in FIG. 7.

The map information of the first robot 100a may be transmitted to the second robot 100b (S1). At this time, map information may be transmitted while the communication units 1100 of the first robot 100a and the second robot 100b directly communicates with each other. Furthermore, the first robot 100a and the second robot 100b are able to transmit information through another network such as Wi-Fi or through a server as a medium. In this case, the shared map information may be map information including the position where the first robot 100a is disposed. In addition, it is possible to share map information including the position where the second robot 100b is disposed. Substantially, since the first robot 100a and the second robot 100b may exist together in the entire space called a house, and furthermore, they may exist together in a more specific space such as a living room, it is preferable to share map information on the space where the two robots 100a, 100b are located.

The first robot 100a and the second robot 100b may be able to move to start cleaning from each charging stand, but also move to a space where each robot needs cleaning by the user.

When the first robot 100a and the second robot 100b are respectively powered on to be driven (S2), the first robot 100a and the second robot 100b are able to move. In particular, the second robot 100b is able to move in a direction in which a distance from the first robot 100a decreases.

At this time, it is determined whether the distance between the first robot 100a and the second robot 100b is less than a specific distance (S3). In this case, the specific distance may be less than 50 cm. The specific distance may denote a distance for an initial arrangement set for cleaning while the first robot 100a and the second robot 100b are driven together. In other words, when the two robots 100a, 100b are disposed at a specific distance, the two robots may perform cleaning together according to a predetermined algorithm afterward.

Since the first robot 100a and the second robot 100b are able to directly communicate with each other, it may be seen that the distance from the first robot 100a decreases while the second robot 100b moves. For reference, for communication made between the first robot 100a and the second robot 100b, accuracy with respect to the position and facing direction of the first robot 100a from the second robot 100b is not so high, a technology for increasing the accuracy may be added later.

In order to reduce the distance from the first robot 100a, the second robot 100b may move while drawing a circular or spiral trajectory. In other words, since it is not easy for the second robot 100b to accurately measure the position of the first robot 100a and move to the relevant position, it is possible to find a position where the distance decreases while moving in various directions, such as in a circular or spiral trajectory.

When the distance between the first robot 100a and the second robot 100b does not decrease within a specific distance, the second robot 100b continuously moves until the distance between the first robot 100a and the second robot 100b is within the specific distance. For instance, the second robot 100b may move while drawing a circular trajectory, and continuously move in a specific direction to check whether the distance decreases when the distance decreases while moving in the relevant direction.

When the distance between the first robot 100a and the second robot 100b decreases within a specific distance, an image captured by the first robot 100a is transmitted to the second robot 100b (S4). In this case, as with map information, the first robot 100a and the second robot 100b may communicate directly or communicate through another network or server.

Since the first robot 100a and the second robot 100b are located within a specific distance, images captured by the first robot 100a and the second robot 100b may be similar to each other. In particular, when the cameras provided in the first robot 100a and the second robot 100b are respectively disposed toward the upper front side, the images taken by the two robots 100a, 100b are the same when their positions and directions are the same. Therefore, the initial positions and directions for the two robots 100a, 100b to start cleaning may be aligned by comparing the images captured by the two robots 100a, 100b, and adjusting the positions and directions of the two robots 100a, 100b.

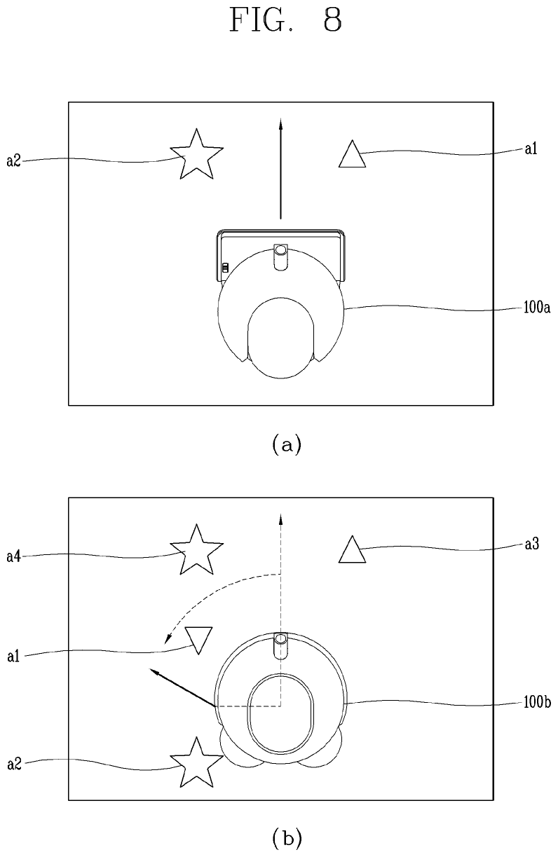

Then, the image transmitted from the first robot 100a and the image captured by the second robot 100b are compared with each other (S5). Referring to FIG. 8, a comparison process will be described.

(a) of FIG. 8 is a view for explaining a state in which the first robot 100a captures an image, and (b) of FIG. 8 is a view for explaining a state in which the second robot 100b captures an image.

Cameras are provided in the first robot 100a and the second robot 100b to capture an upper side of the front, and the capturing is carried out in a direction indicated by an arrow in each drawing.

As shown in (a) of FIG. 8, in an image captured by the first robot 100a, feature point a2 and feature point a1 are arranged on the left and on the right, respectively, with respect to an arrow direction. In other words, it may be possible to select feature points from the image captured by the first robot 100a, but to select different feature points on the left and right with respect to the front captured by the camera. Accordingly, the left and right of the image captured by the camera may be identified.

As shown in (b) of FIG. 8, in the second robot 100b, capturing is initially carried out based on a dotted arrow. In other words, the camera provided in the second robot 100b is disposed to face upward in the front, and feature point a1 and feature point a4 are arranged on the left, and feature point a3 is arranged on the right with respect to the dotted arrow. Therefore, when the feature points are compared by the control unit provided in the second robot 100b, it can be seen that there is a difference in the feature points of the images captured by the two robots 100a, 100b.

In this case, when the second robot 100b rotates counterclockwise as shown in (b) of FIG. 8, images viewed by the two robots 100a, 100b may be similarly implemented. In other words, since the second robot 100b is rotated counterclockwise, the direction in which the camera of the second robot 100b looks may be changed as shown by a solid arrow. At this time, when viewing the image captured by the camera of the second robot 100b, feature point a2 is arranged on the left, and feature point a1 is arranged on the right. Accordingly, feature points in the image provided by the first robot 100a as shown in (a) of FIG. 8 and the image captured by the second robot 100b as shown in (b) of FIG. 8 may be similarly arranged. Through this process, heading angles of the two robots 100a, 100b may be similarly aligned. Furthermore, when the feature points are similarly arranged in the images provided by the two robots 100a, 100b, it may be seen that the positions at which the two robots 100a, 100b look at the feature points in the current state are arranged adjacent to each other within a specific distance, thereby accurately specifying the positions to each other.

As described above, it may be possible to select the same feature points from the image captured by the second robot 100b and the image captured and transmitted by the first robot 100a, that is, the two images, and determine according to the selected feature points. At this time, the feature point may be a large object that can be easily identified by the feature or a portion of a large object that can be easily identified by the feature. For example, the feature point may be an object such as an air purifier, a door, a TV, or the like, or a portion of an object such as a corner of a closet, a bed, or the like.

In the control unit 1800 of the second robot 100b, when the feature points are arranged at similar positions in the two images, it may be determined that the second robot 100b is disposed at an initial position prior to the start of driving with the first robot 100a. When there is a difference between the image provided by the first robot 100a and the image currently captured by the second robot 100b, it may be possible to change the image captured by the camera of the second robot 100b through moving or rotating the second robot 100b. In case where the image captured by the camera of the first robot 100a and the image provided by the second robot 100b are compared with each other, when position changes of the feature points in the two images are made in a similar direction, it may also be determined that the second robot 100b is disposed at an initial position prior to the start of driving with the first robot 100a.

On the other hand, in order to make it easier to compare the two images, it is preferable that a plurality of the feature points are selected, and respective feature points are divided and arranged on the left and right of the front center of the first robot 100a or the second robot 100b. The cameras of the second robot 100b and the first robot 100a are respectively disposed to face forward because the control unit 1800 of the second robot 100b is able to easily sense the position and direction of the other cleaner when different feature points are arranged on the left and right with respect to the cameras. The second robot 100b moves or rotates such that the left and right arrangements of the feature points are the same as those transmitted from the first robot 100a, thereby allowing the second robot 100b to be disposed in a line behind the first robot 100a. In particular, the fronts of the second robot 100b and the first robot 100a may be arranged to coincide with each other, thereby easily selecting an initial movement direction when cleaning together afterward.

Through the foregoing process, the position of the first robot 100a may be determined from the map information shared by the second robot 100b (S6).

Furthermore, the first robot 100a and the second robot 100b may exchange position information with each other while moving based on a navigation map and/or a SLAM map shared with each other.

The second robot 100b may acquire an image through the sensing unit 1400 while moving or after moving a predetermined distance, and may extract area feature information from the acquired image.

The control unit 1800 may extract area feature information based on the acquired image. Here, the extracted area feature information may include a set of probability values for an area and a thing recognized based on the acquired image.

Meanwhile, the control unit 1800 may determine a current position based on SLAM-based current position node information and the extracted area feature information.

Here, the SLAM-based current position node information may correspond to a node most similar to the feature information extracted from the acquired image among pre-stored node feature information. In other words, the control unit 1800 may perform position recognition using feature information extracted from each node to select the current position node information.

In addition, in order to further improve the accuracy of position estimation, the control unit 1800 may perform position recognition using both feature information and area feature information to increase the accuracy of position recognition. For example, the control unit 1800 may select a plurality of candidate SLAM nodes by comparing the extracted area feature information with pre-stored area feature information, and determine current position based on candidate SLAM node information most similar to the SLAM-based current position node information among the plurality of the selected candidate SLAM nodes.

Alternatively, the control unit 1800 may determine SLAM-based current position node information, and correct the determined current position node information according to the extracted area feature information to determine a final current position.

In this case, the control unit 1800 may determine a node most similar to the extracted area feature information among pre-stored area feature information of nodes existing within a predetermined range based on the SLAM-based current position node information as the final current position.

For a position estimation method using an image, a global feature describing an overall shape of an object rather than a local feature may be used, as well as a position estimation method using a local feature point such as a corner, thereby extracting a feature that is robust to an environmental change such as lighting/illuminance. For example, the control unit 1800 may extract and store area feature information (e.g., living room: sofa, table, TV; kitchen: dining table, sink; room: bed, desk) when generating a map, and then estimate the positions of the first robot 100a and the second robot 100b using various area feature information in an indoor environment.

In other words, according to the present disclosure, it may be possible to store a feature in the unit of thing, object and area instead of using only a specific point in the image when storing the environment, thereby allowing position estimation that is robust to a change in lighting/illuminance.

In addition, when at least part of the first robot 100a and the second robot 100b enters under a thing such as a bed or a sofa, the sensing unit 1400 may be unable to acquire an image sufficiently including a feature point such as a corner since the field of view is obscured by a thing. Alternatively, in an environment with a high ceiling, the accuracy of extracting a feature point using the ceiling image may be lowered at a specific position.

However, according to the present disclosure, in case where an object such as a bed or a sofa covers the sensing unit 1400, even when feature point identification is weak due to a high ceiling, the control unit 1800 may determine the current location using area feature information such as a sofa and a living room in addition to a feature point such as a corner.

Then, the first robot 100a and the second robot 100b may perform cleaning while driving together. In other words, the second robot 100b may perform cleaning while driving along the first robot 100a.

On the other hand, in case where the sharing of map information between the first robot 100a and the second robot 100b fails during collaborative driving, the positions may be determined through mutual communication. For instance, as described above, time periods of signals transmitted and received between the UWB modules included in each of the first robot 100a and the second robot 100b may be measured to obtain a distance (separation distance) between the two robots 100a, 100b. In this case, the distance (separation distance) between the two robots 100a, 100b may be obtained through a transformation equation using the coordinates of positions at which signals are transmitted and received between the UWB modules.

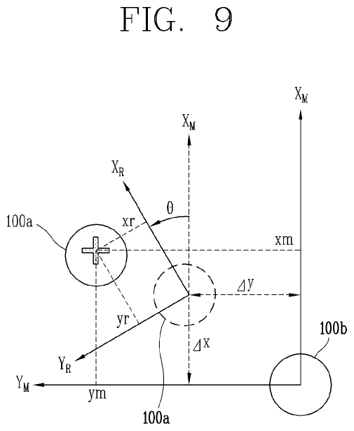

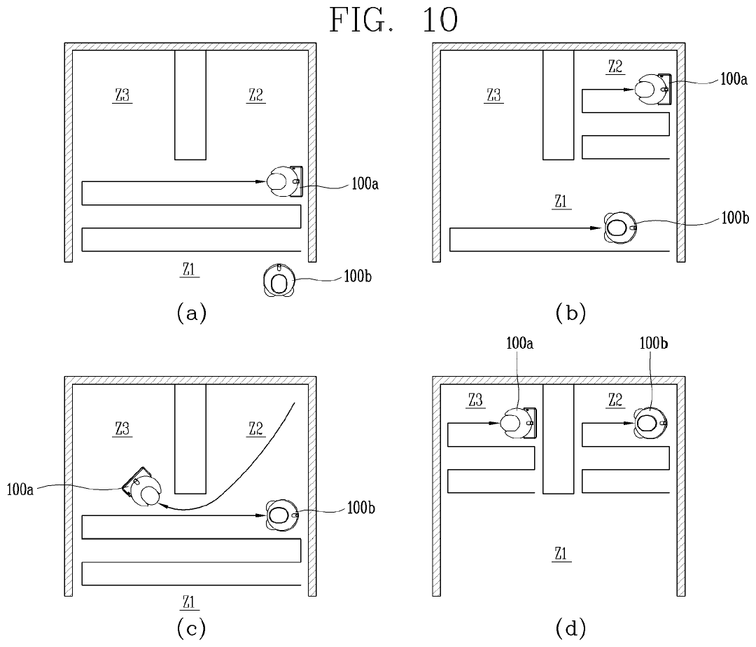

Hereinafter, with reference to FIG. 9, a process of calculating the positions of the first robot 100a and the second robot 100b through a transformation equation will be described in detail. Here, the transformation equation denotes an equation for converting first coordinates representing a current position of the first robot 100a based on a previous position of the first robot 100a to second coordinates representing the current position of the first robot 100a based on a position of the main body of the second robot 100b.

In FIG. 9, the previous position of the first robot 100a is represented by a dotted line, and the current position is represented by a solid line. In addition, the position of the second robot 100b is represented by a solid line.

The transformation equation is described as follows, and is represented as a 3×3 matrix in Equation 1 below.

<Transformation Formula>

M (current position [second coordinates] of first robot represented based on second robot)=H (transformation formula)×R (current position [first coordinates] of first robot represented based on previous position of first robot)

For a more detailed equation, it may be expressed as in the following Equation 1.

$$M = H \times R , ( \begin{matrix}{x}_{m} \\ {y}_{m} \\ 1\end{matrix} ) = ( \begin{matrix}cos Θ & - sin Θ & Δ x \\ sin Θ & cos Θ & Δ y \\ 0 & 0 & 1\end{matrix} ) ( \begin{matrix}{x}_{r} \\ {y}_{r} \\ 1\end{matrix} ) \qquad < Equation 1 >$$

Here, Xr and Yr are first coordinates, and Xm and Ym are second coordinates.

The first coordinates can be calculated based on information provided by the driving unit 1300 that moves the first robot 100a. The information provided by the driving unit 1300 of the first robot 100a is information in which information derived from an encoder that measures rotation information of a motor that rotates a wheel is calibrated by a gyro sensor that senses the rotation of the first robot 100a.

The driving unit 1300 provides a driving force for moving or rotating the first robot 100a, and the first coordinates may be calculated even in a situation that the second robot 100b is unable to receive a signal provided from the first robot 100a. Therefore, it may be possible to determine a relatively accurate position compared to position information calculated by transmitting and receiving signals between the two robots 100a, 100b. In addition, since the driving unit 1300 includes information on the actual movement of the first robot 100a, it may be possible to accurately describe a change in the position of the first robot 100a.

For example, even when the encoder senses that the motor is rotated in the first robot 100a, a change in position of the first robot 100a may be accurately calculated by determining the position of the first robot 100a is rotated rather than moved by using the gyro sensor. Even when the motor that rotates the wheel is rotated, since the first robot 100a is able to only rotate without movement, the rotation of the motor does not unconditionally move the position of the other cleaner. Accordingly, in case of using the gyro sensor, a case in which only rotation is made without any change in position of the first robot 100a, a case where both a change in position and rotation are made, or a case where only a change in position is made without rotation may be identified. Accordingly, using the encoder and the gyro sensor, the first robot 100a may accurately calculate the first coordinates transformed from the previous position to the current position. Furthermore, this information may be transmitted to a network through the communication unit 1100 of the first robot 100a, and may be transmitted to the second robot 100b through the network.

The second coordinates are measured by signals transmitted and received between the first robot 100a and the second robot 100b (e.g., signals may be transmitted and received using a UWB module). The second coordinates may be calculated when a signal is transmitted because the first robot 100a is present in a sensing area of the second robot 100b.

Referring to FIG. 9, it can be seen that two coordinate values can be represented by an equal sign by H.

Meanwhile, in order to obtain H, data when the first robot 100a is disposed in the sensing area of the second robot 100b may be continuously accumulated. Such data is represented as in the following Equation 2. A lot of data is accumulated when the first robot 100a is located in the sensing area. At this time, data is a plurality of first coordinates and a plurality of second coordinates corresponding to each.

$$M = H \times R , [ \begin{matrix}{x}_{{m}_{1}} & {x}_{{m}_{2}} & {x}_{{m}_{3}} & ∘ & ∘ & ∘ \\ {y}_{{m}_{1}} & {y}_{{m}_{2}} & {y}_{{m}_{3}} & ∘ & ∘ & ∘ \\ 1 & 1 & 1 & ∘ & ∘ & ∘\end{matrix} ] = H [ \begin{matrix}{x}_{{r}_{1}} & {x}_{{r}_{2}} & {x}_{{r}_{3}} & ∘ & ∘ & ∘ \\ {y}_{{r}_{1}} & {y}_{{r}_{2}} & {y}_{{r}_{3}} & ∘ & ∘ & ∘ \\ 1 & 1 & 1 & ∘ & ∘ & ∘\end{matrix} ] \qquad < Equation 2 >$$

Here, to obtain H, a least squares method may be used as shown in Equation 3 below.

H=M·R^{T}(R R^{T})⁻¹ <Equation 3>

On the other hand, after calculating H, when the first coordinates and the second coordinates are continuously acquired, it may be possible to newly calculate H to update H. As the amount of data that calculates H increases, H has a more reliable value.

Using the transformation equation (H) calculated in this way, even when it is difficult for the second robot 100b and the first robot 100a to directly transmit and receive signals, the second robot 100b may follow the first robot 100a. When the second robot 100b is unable to directly receive a signal regarding the position of the first robot 100a through the sensing unit since the first robot 100a temporarily gets out from the sensing area of the second robot 100b, the second robot 100b may calculate the position of the first robot 100a compared to the position of the second robot 100b by a transformation expression using the driving information of the first robot 100a transmitted through the network.

When the second robot 100b determines the position of the first robot 100a by the transformation equation, the first coordinates corresponding to R must be transmitted through the communication unit 1100 of the second robot 100b. In other words, M can be calculated since R and H are known. M is the position of the first robot 100a with respect to the second robot 100b. Accordingly, the second robot 100b may know a relative position with respect to the first robot 100a, and the second robot 100b may move behind the first robot 100a.

On the other hand, based on the above-described technology, when either one of the second robot 100b and the first robot 100a comes first into contact with the charging stand and then starts charging, the other one moves to its own charging stand after saving the position of the charging stand of the either one (second coordinates or first coordinates for the robot that has started charging). Since the position has been saved, from the next cleaning, the two robots may gather for follow-up cleaning even when outside the sensing area.

As described above, the position of the other robot may be obtained using a result of mutual communication without using map information, thereby obtaining positions to each other using a map-less position recognition method even while the first robot 100a and the second robot 100b are driving.

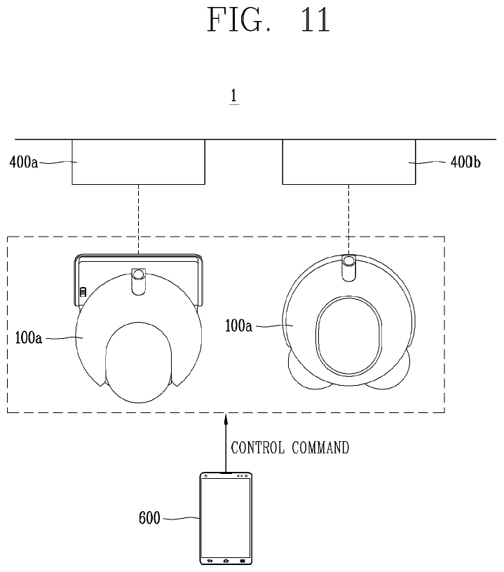

The first robot 100a and the second robot 100b that drive through recognizing their respective positions as described above, may perform collaborative driving as illustrated in FIG. 10. At this time, an area to be cleaned in which the first robot 100a and the second robot 100b drive may be divided into one or more zones Z1 to Z3 to carry out cleaning in the unit of divided zone as illustrated in FIG. 10.

When the execution of collaborative driving is started, the first robot 100a may start cleaning for a first zone Z1, and the second robot 100b stands by near the starting position of the first robot 100a. When the first robot 100a completes the cleaning of the first zone Z1 above a predetermined reference level, the first robot 100a may transmit information on a cleanable zone to the second robot 100b. For instance, the first robot 100a may transmit information on the first zone Z1, or information on a path that has been driven by the first robot 100a in the first zone Z1 to the second robot 100b, thereby allowing the second robot 100b to drive along the driving path of the first robot 100a.

The first robot 100a may transmit information on the cleanable zone to the second robot 100b, and then clean the remaining portion of the first zone Z1, or move to the second zone Z2 to clean the second zone Z2, and the second robot 100b may clean the first zone Z1 based on the information received from the first robot 100a. In this case, the second robot 100a may perform cleaning while driving along a path that has been driven by the first robot 100a based on the information received from the first robot 100a.

The first robot 100a cleans the second zone Z2 while the second robot 100b cleans the first zone Z1, and then moves to the third zone Z3, which is a next uncleaned zone when the cleaning of the second zone Z2 is completed. At this time, as transmitting information on the cleanable zone in the first zone Z1 to the second robot 100b, the first robot 100a may also transmit information on a cleanable zone in the second zone Z2 to the second robot 100b. Accordingly, after completing the cleaning of the first zone Z1, the second robot 100b may move to the second zone Z2 to perform the cleaning of the second zone Z2.

Then, the first robot 100a may clean the third zone Z3, and the second robot 100b may clean the second zone Z2 while the first robot 100a cleans the third zone Z3. When the first robot 100a completes the cleaning of the third zone Z3, similarly, the second robot 100b may move to the third zone Z3 to clean the third zone Z3 while driving along a path that has been driven by the first robot 100a.

As described above, the system 1 in which the collaboration of first robot 100a and the second robot 100b is carried out, may perform collaborative driving according to the driving states of the first robot 100a and the second robot 100b.

For instance, when at least one of the first robot 100a and the second robot 100b is in a driving state in which the collaborative driving is not allowed or when there is a concern that at least one of the first robot 100a and the second robot 100b may cause an error during the collaborative driving, the collaborative driving may not be performed.

For a specific example, the collaborative driving may not be performed in case where the collaborative driving cannot be completed since the battery charge capacity of at least one of the first robot 100a and the second robot 100b does not meet a predetermined reference capacity or in case where it is difficult to start the collaborative driving since at least one of the first robot 100a and the second robots 100b is located in a zone in which mutual position recognition is not allowed, and the position recognition of the other robot is not made.

In other words, the collaborative driving in the system 1 may be performed when the driving states of the first robot 100a and the second robot 100b satisfy predetermined reference states.

Hereinafter, an embodiment of the system 1 in which collaborative driving is performed according to an initial driving state will be described.

The embodiment of the system 1 may include a plurality of moving robots 100a, 100b that perform cleaning while driving in an area to be cleaned, and a controller 600 that communicates with the plurality of moving robots 100a, 100b and transmits a control command for remote control to the plurality of moving robots 100a, 100b.

The plurality of moving robots 100a, 100b may include two robots, preferably the first robot 100a and the second robot 100b.

Here, the first robot 100a may be a robot that sucks dust while driving ahead in a zone subject to the collaborative driving, and the second robot 100b may be a robot that wipes dust while driving behind in a zone in which the first robot 100a has driven.

In other words, for the collaborative driving, the first robot 100a may suck dust while driving ahead, and the second robot 100b may perform cleaning to wipe dust on a path in which the first robot 100a has sucked dust while driving ahead.

Hereinafter, the plurality of moving robots 100a, 100b are used to mean that the plurality of moving robots 100a, 100b include both the first robot 100a and the second robot 100b.

The controller 600 may be at least one of the terminal 300, a control device of the server 500, and a remote controller of the first robot 100a and the second robot 100b.

Accordingly, the first robot 100a and the second robot 100b may be driven by receiving the control command from at least one of the terminal 300, the control device of the server 500, and the remote controller of the first robot 100a and the second robot 100b.

The controller 600 may preferably be a mobile terminal.

Accordingly, the first robot 100a and the second robot 100b may perform the collaborative driving mode by the terminal 300.

The collaborative driving in the system 1 may be performed by transmitting a control command for the collaborative driving from the controller 600 to the first robot 100a and the second robot 100b.

Upon receiving a control command for a collaborative driving mode for collaboratively cleaning the area to be cleaned from the controller 600, the plurality of moving robots 100a, 100b determine whether the driving states of the plurality of moving robots 100a, 100b correspond to preset reference conditions, and perform a motion for the collaborative driving mode according to the determination result.

In other words, when the control command is received, the plurality of moving robots 100a, 100b may compare each driving state with the reference condition to perform a motion for the collaborative driving mode according to the comparison result.

The collaborative driving mode may denote an operation mode in which the plurality of moving robots 100a, 100b perform the collaborative driving.

The collaborative driving mode may be a mode in which the plurality of moving robots 100a, 100b perform cleaning while being sequentially driven.

For instance, the collaborative driving mode may be a mode in which the first robot 100a and the second robot 100b perform cleaning in a predetermined zone while being sequentially driven.

The collaborative driving mode may be a mode in which either one of the plurality of moving robots 100a, 100b performs cleaning while driving behind in a zone that has been cleaned while the other robot drives ahead.

For instance, cleaning may be performed while the first robot 100a drives ahead and the second robot 100b drives behind.

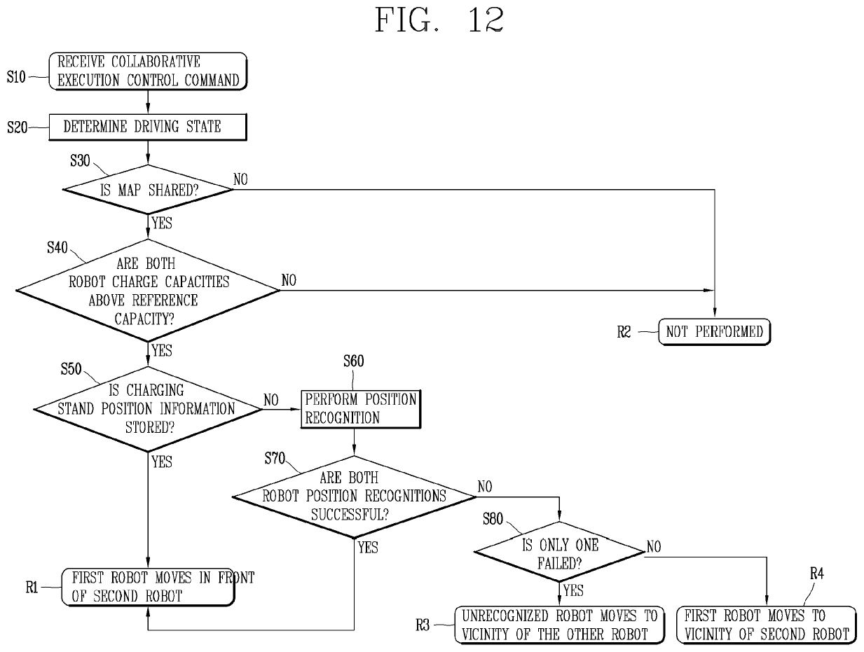

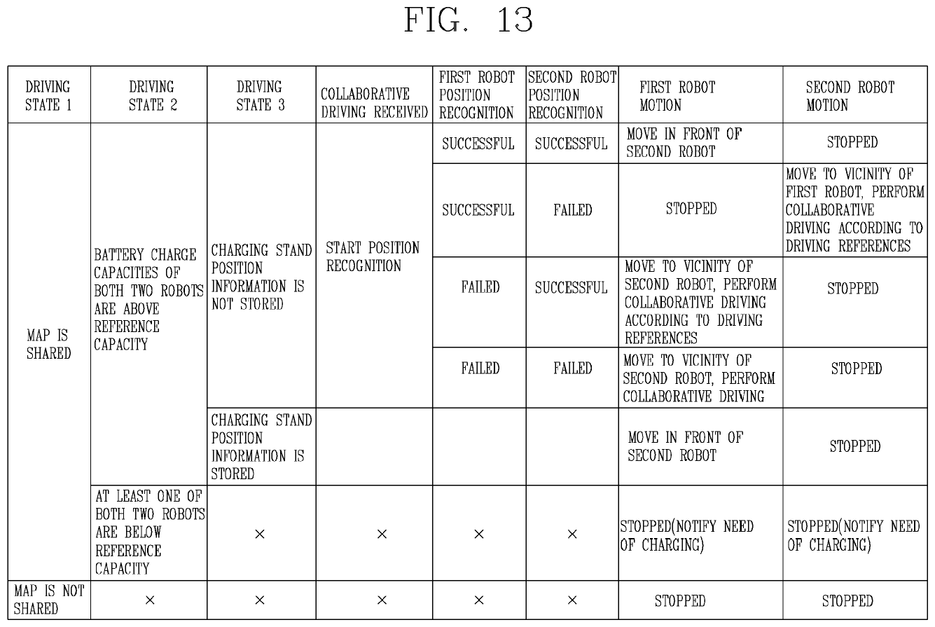

A process in which the collaborative driving mode is performed in the system 1 may be as illustrated in FIG. 12. Furthermore, conditions under which the collaborative driving mode is performed in the system 1 according to the process illustrated in FIG. 12 may be as illustrated in FIG. 13.

First, when a control command for performing the collaborative driving mode is received at the plurality of moving robots 100a, 100b (S10), the plurality of moving robots 100a, 100b may stop an operation being performed at a current position to determine the driving state (S20). Here, when the control command is received, the plurality of moving robots 100a, 100b may already be performing another operation mode, or may be docked to the charging stands 400a, 400b, respectively. The plurality of moving robots 100a, 100b may receive the control command regardless of whether another operation mode is being already performed or whether the charging stands 400a, 400b are docked to determine the driving state at the current position (S20).

The driving state may denote a state for performing collaborative driving of each of the plurality of moving robots 100a, 100b. Furthermore, the driving state may have a meaning including at least one state information of the plurality of moving robots 100a, 100b compared with the reference condition.

As illustrated in FIG. 13, the driving state may include at least one of a map sharing state (driving state 1), a battery charging state (driving state 2), and a charging stand position information state (driving state 3) of the other robot for each of the plurality of moving robots 100a, 100b. In other words, when determining the driving state (S20), at least one of the map sharing state (driving state 1), the battery charging state (driving state 2), and the charging stand position information state (driving state 3) of the other robot may be determined for each of the plurality of moving robots 100a, 100b.

The map sharing state may denote a state of whether map information of each of the plurality of moving robots 100a, 100b is shared with each other. In other words, the map sharing state may be a state on whether the map information of the second robot 100b is shared with the first robot 100a and the map information of the first robot 100a is shared with the second robot 100b.

The battery charge state may denote a battery charge capacity state of each of the plurality of moving robots 100a, 100b. In other words, the battery charge state may be a state on each of the battery charge capacity of the first robot 100a and the battery charge capacity of the second robot 100b.

The charging stand position information state of the other robot may denote a state on whether the charging stand position information of the other robot is stored in each of the plurality of moving robots 100a, 100b. In other words, the charging stand position information state may be a state on whether the position information of the charging stand 400b of the second robot 100b is stored in the first robot 100a, which is a counterpart robot, and the position information of the charging stand 400a of the first robot 100a is stored in the second robot 100b, which is a counterpart robot.

The driving state may include all of the map sharing state, and the battery charging state, and the charging stand position information state of the other robot for each of the plurality of moving robots 100a, 100b.

After each of the plurality of moving robots 100a, 100b determines the driving state (S20), the plurality of moving robots 100a, 100b may communicate with each other to share the determination result. Accordingly, each of the plurality of moving robots 100a, 100b may recognize the driving states of all of the plurality of moving robots 100a, 100b. Then, at least one of the plurality of moving robots 100a, 100b may compare the driving state with the reference condition to determine whether the driving state corresponds to the reference condition (S30 to S50).

The reference condition may be a condition of the driving state in which the collaborative driving mode can be performed. In other words, the reference condition may denote an initial state condition in which the collaborative driving mode can be performed. Accordingly, conditions corresponding to the driving state may be preset for the reference condition.

The reference condition may include at least one of a first condition in which each of the plurality of moving robots 100a, 100b shares a map, a second condition in which a battery charge capacity of each of the plurality of moving robots 100a, 100b is above a preset reference capacity, and a third condition in which the charging stand position information of the other robot is stored in each of the plurality of moving robots 100a, 100b.

The reference condition may preferably include all of the first to third conditions. Accordingly, the plurality of moving robots 100a, 100b may compare the driving state with the reference condition (S30 to S50) to determine whether the map sharing state of each of the plurality of moving robots 100a, 100b corresponds to the first condition (S30), and determine whether the battery charge state of each of the plurality of moving robots 100a, 100b corresponds to the second condition (S40), and determine whether the charging stand position information state of the other robot of each of the plurality of moving robots 100a, 100b corresponds to the third condition (S50).

As a result of determining whether the driving state corresponds to the reference condition (S30 to S50), when each of the plurality of moving robots 100a, 100b shares a map, and the battery charge capacity of each of the plurality of moving robots 100a, 100b is above a preset reference capacity, the plurality of moving robots 100a, 100b may perform a motion for the collaborative driving mode according to a result of determining whether the charging stand position information of the other robot is stored in each of the plurality of moving robots 100a, 100b (S50).

As a result of determining whether the map sharing state of each of the plurality of moving robots 100a, 100b corresponds to the first condition (S30), when the map sharing state of each of the plurality of moving robots 100a, 100b corresponds to the first condition, the plurality of moving robots 100a, 100b may determine whether the battery charge capacity state of each of the plurality of moving robots 100a, 100b corresponds to the second condition (S40). Then, as a result of determining whether the map sharing state of each of the plurality of moving robots 100a, 100b corresponds to the first condition (S30), when the map sharing state of each of the plurality of moving robots 100a, 100b does not correspond to the first condition, the plurality of moving robots 100a, 100b may not perform the collaborative driving mode (R2). In other words, when each of the plurality of moving robots 100a, 100b shares a map, it may be determined that the plurality of moving robots 100a, 100b are able to perform the collaborative driving mode through the shared map, and when each of the moving robots 100a, 100b does not share a map, it may be determined that the plurality of moving robots 100a, 100b are unable to perform the collaborative driving mode due to a collaborative cleaning limitation in the same zone due to the non-sharing of map information so as not to perform the collaborative driving mode (R2).

As a result of determining whether the battery charge capacity state of each of the plurality of moving robots 100a, 100b corresponds to the second condition (S40), when the battery charge capacity of each of the plurality of moving robots 100a, 100b corresponds to the second condition, the plurality of moving robots 100a, 100b may determine whether the charging stand position information state of each of the plurality of moving robots 100a, 100b corresponds to the third condition (S50). Furthermore, as a result of determining whether the battery charge capacity state of each of the plurality of moving robots 100a, 100b corresponds to the second condition (S40), when the battery charge capacity of each of the plurality of moving robots 100a, 100b does not correspond to the second condition, the plurality of moving robots 100a, 100b may not perform the collaborative driving mode (R2). In other words, when the battery charge capacity state of each of the plurality of moving robots 100a, 100b is above the reference capacity, it may be determined that the plurality of moving robots 100a, 100b is able to perform the collaborative driving mode with the charged capacity, and when the battery charge capacity state of each of the plurality of moving robots 100a, 100b is below the reference capacity, it may be determined that the plurality of moving robots 100a, 100b is unable to perform the collaborative driving mode due to lack of charge capacity so as not to perform the collaborative driving mode (R2). In this case, at least one of the first robot 100a and the second robot 100b may output a notification regarding the shortage of the charge capacity of the battery. For instance, a notification on the need for charging may be output from the robot whose charge capacity is less than the reference capacity.

For the plurality of moving robots 100a, 100b, as a result of determining whether the position information of the charging stand 400a, 400b of the other robot is stored in each of the plurality of moving robots 100a, 100b (S50), when the position information of the charging stand 400a, 400b of the other robot is stored in each of the moving robots 100a, 100b, a robot subject to driving ahead may move to a position within a predetermined distance from the other robot to perform the collaborative driving mode (R1). As a result of determining whether the position information of the charging stand 400a, 400b of the other robot is stored in each of the plurality of moving robots 100a, 100b (S50), when position information of the charging stand 400a, 400b of the other robot is not stored in each of the plurality of moving robots 100a, 100b, the plurality of moving robots 100a, 100b may recognize positions to each other (S60) to perform a motion for the collaborative driving mode according to the recognition result.

As a result of determining whether the position information state of the charging stand 400a, 400b of each of the plurality of moving robots 100a and 100b corresponds to the third condition (S50), when the position information state of the charging stand 400a, 400b of each of the plurality of moving robots 100a and 100b corresponds to the third condition, the first robot 100a may move to a position within a predetermined distance from the front of the second robot 100b to perform the collaborative driving mode (R1). For instance, the first robot 100a may move a point at 1 m in front of the second robot 100b to perform the collaborative driving mode (R1) by leading the second robot 100b. Then, as a result of determining whether the position information state of the charging stand 400a, 400b of the other robot of each of the plurality of moving robots 100a, 100b corresponds to the third condition (S50), when the position information state of the charging stand 400a, 400b of the other robot of each of the plurality of moving robots 100a, 100b does not correspond to the third condition, each of the plurality of moving robots 100a, 100b may perform an operation of recognizing positions to each other (S60). In other words, when the position information of the charging stand 400a, 400b of the other robot is stored in each of the plurality of moving robots 100a, 100b, it may be determined that the plurality of moving robots 100a, 100b are able to perform the collaborative driving mode with the stored position information such that the first robot 100a moves to a position within a predetermined distance from the front of the second robot 100b to perform the collaborative driving mode (R1), and when the position information of the charging stand 400a, 400b of the other robot is not stored in each of the plurality of moving robots 100a, 100b, it may be determined that the initial position and the end position of the opposite robot cannot be recognized due to the inability to recognize the position of the charging stand 400a, 400b of the other robot to perform an operation for recognizing positions to each other (S60).

For the plurality of moving robots 100a, 100b, as a result of recognizing positions to each other (S60), when the positions to each other are recognized (S70), a robot subject to driving ahead may move to a position within a predetermined distance from the other robot to perform the collaborative driving mode (R1). For the plurality of moving robots 100a, 100b, as a result of recognizing positions to each other (S60), when either one robot does not recognize a position to the other robot (S80), a notification informing that the unrecognized robot moves to the vicinity of the other robot may be output from at least one of the plurality of moving robots 100a, 100b, and then a motion for the collaborative driving mode may be performed according to the movement result. When the unrecognized robot is moved to the vicinity of the other robot, the unrecognized robot may perform a position recognition operation for recognizing the position of the other robot using a communication result with the other robot, and then the collaborative driving mode may be performed according to preset driving references (R3). For the plurality of moving robots 100a, 100b, as a result of recognizing positions to each other (S60), when all of the plurality of moving robots 100a, 100b do not recognize the positions (S80), the first robot 100a may move to a position within a predetermined distance in the vicinity of the second robot 100b to perform a motion for performing the collaborative driving mode (R4).

For the plurality of moving robots 100a, 100b, as a result of recognizing positions to each other (S60), when the positions to each other are recognized (S70), the first robot 100a may move to a position within a predetermined distance in front of the second robot 100b to perform the collaborative driving mode (R1). For instance, the first robot 100a may move a point at 1 m in front of the second robot 100b to perform the collaborative driving mode by leading the second robot 100b. Furthermore, when either one of the plurality of moving robots 100a, 100b does not recognize the position of the other robot (S80), a notification informing that the unrecognized robot moves to the vicinity of the other robot may be output from at least one of the plurality of moving robots 100a, 100b, and then, when the unrecognized robot is moved to the vicinity of the other robot by the user, the unrecognized robot may perform a position recognition operation for recognizing the position of the other robot using a communication result with the other robot according to a map-less position recognition method as illustrated in FIG. 9, and then perform the collaborative driving mode according to the driving references (R3). For instance, when the first robot 100a does not recognize the position of the second robot 100b, the first robot 100a may move to a position within a radius of 50 cm of the second robot 100b, and then recognize the position of the second robot 100b according to the map-less position recognition method illustrated in FIG. 9. On the contrary, when the second robot 100b does not recognize the position of the first robot 100b, the second robot 100b may move a position within a radius of 50 cm of the first robot 100a, and then recognize the position of the first robot 100a according to the map-less position recognition method illustrated in FIG. 9. Here, the vicinity of the other robot may denote about a distance at which the angle of view overlaps with the camera 131 of the other robot, and may be a radius of 50 cm or roughly 50 cm of the other robot. Then, the plurality of moving robots 100a, 100b may perform the collaborative driving mode (R3) according to the driving references. Here, the driving references may be references for changing or limiting the setting of the collaborative driving mode. For instance, a zone set in the collaborative driving mode may be divided into two or more small areas to be driven. Accordingly, the plurality of moving robots 100a, 100b may try to recognize positions to each other even during the execution of the collaborative driving mode, and a result of position recognition may be corrected according to the trial result. If all of the plurality of moving robots 100a, 100b do not recognize the positions (S80), the first robot 100a may move to a position within a predetermined distance in the vicinity of the second robot 100b, and then each of the first robot 100a and the second robot 100b may recognize the position of the other robot according to the map-less position recognition method illustrated in FIG. 9, and then perform a motion for performing the collaborative driving mode (R4).

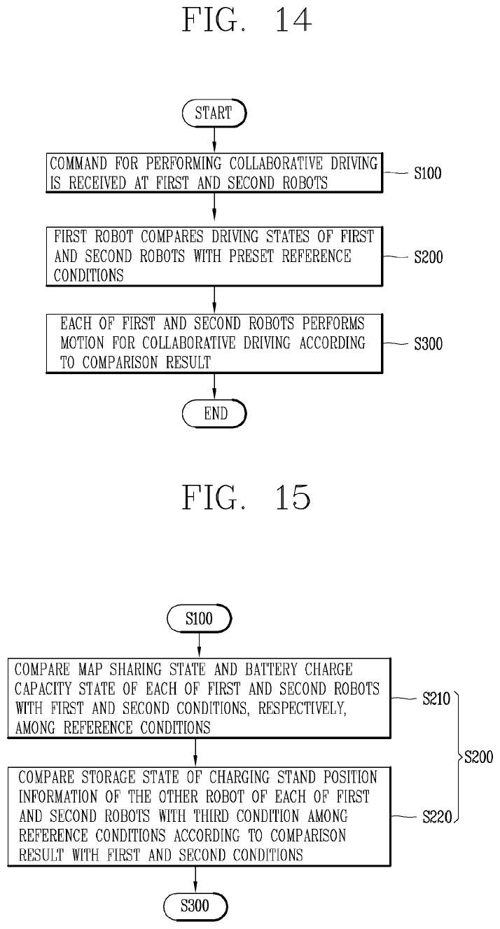

The system 1 in which the collaborative driving mode is performed according to whether the driving state corresponds to the reference condition may perform the collaborative driving using a method of performing collaborative driving as illustrated in FIG. 14.

The method of performing collaborative driving (hereinafter, referred to as an implementation method), which is a method of performing, by the first robot 100a and the second robot 100b, collaborative driving, may include receiving, by the first robot 100a and the second robot 100b, a command for performing collaborative driving (S100), comparing, by the first robot, the driving states of the first robot 100a and the second robot 100b with preset reference conditions (S200), and performing, by each of the first robot 100a and the second robot 100b, a motion for collaborative driving according to the comparison result (S300), as illustrated in FIG. 14.

Here, the first robot 100a may suck dust while driving ahead in an area subject to the collaborative driving, and the second robot 100b may wipe dust while driving behind in a zone in which the first robot 100a has driven. In other words, when the collaborative driving is performed according to the execution method, the first robot 100a may suck dust while leading the second robot 100b, and the second robot 100b may wipe dust while following the first robot 100a.

The receiving a command for performing collaborative driving (S100) may receive a command for performing collaborative driving by each of the first robot 100a and the second robot 100b.

The receiving a command for performing collaborative driving (S100) may stop an operation being performed at a current position by the first robot 100a and the second robot 100b.

The comparing the driving states with preset reference conditions (S200) may compare the driving state with a preset reference condition by the first robot 100a.

The comparing the driving states with preset reference condition (S200) may include comparing a map sharing state and a battery charge capacity state of each of the first robot 100a and the second robot 100b with a first condition and a second condition, respectively, among the reference conditions (S210), and comparing a storage state of the charging stand position information of the other robot of each of the first robot 100a and the second robot 100b with a third condition among the reference conditions according to the comparison result with the first condition and the second condition (S220).

The performing a motion for collaborative driving (S300) may perform, by at least one of the first robot 100a and the second robot 100b, a motion for the collaborative driving according to a comparison result of comparing the driving states with preset reference conditions (S200).

The performing a motion for collaborative driving (S300) may move, by the first robot 100a, to a position within a predetermined distance from the second robot 100b when the driving states correspond to all of the first to third conditions.

In this case, the first robot 100a may move to a position within x m in front of the second robot 100b to start the collaborative driving.

The performing a motion for collaborative driving (S300) may recognize, by each of the first robot 100a and the second robot 100b, positions to each other when the driving state corresponds to the first condition and the second condition, thereby performing, by at least one of the first robot 100a and the second robot 100b, a motion for the collaborative driving according to the recognition result.

The performing a motion for collaborative driving (S300) may output, by at least one of the first robot 100a and the second robot 100b, a notification informing that the unrecognized robot moves to the vicinity of the other robot when either one robot does not recognize the position of the other robot as a result of recognizing the positions to each other, then perform a motion for the collaborative driving according to the movement result.

In this case, the unrecognized robot may be moved within a radius y cm of the other robot to perform a motion for the collaborative driving.

The performing a motion for collaborative driving (S300) may perform, by the unrecognized robot, a position recognition operation for recognizing the position of the other robot using a communication result with the other robot when the unrecognized robot is moved to the vicinity of the other robot, and then perform the collaborative driving according to preset driving references.

The execution method including the receiving a command for performing collaborative driving (S100), the comparing the driving states with preset reference conditions (S200), and the performing a motion for collaborative driving (S300) may be implemented as computer-readable codes on a program-recorded medium. The computer readable medium includes all types of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). In addition, the computer may include the control unit 1800.

Hereinafter, Embodiment 1 of a moving robot system 1 that performs a preset scenario in response to a trap situation that occurs while performing collaborative driving will be described with reference to FIGS. 16 to 21.

Referring to FIG. 16, when the first robot 100a and the second robot 100b enter a collaborative driving mode and recognize position information to each other, the first robot 100a may suck contaminants in an area to be cleaned in front of the second robot 100b. In addition, as illustrated in the drawing, a zone to be cleaned may be divided into one or more zones Z4 to Z6 to carry out cleaning in the unit of divided zone.

A fourth zone Z4 refers to a cleaning zone in which the second robot 100b is expected to drive after the first robot 100a completes driving. A fifth zone Z5 refers to a cleaning zone in which the first robot 100a is expected to drive. A sixth zone Z6 refers to a cleaning zone in which the first robot 100a is expected to drive after the completion of cleaning of the fifth zone Z5.

At this time, in the drawing, the fourth zone Z4 to the sixth zone Z6 are divided by outer walls and entrances D1, D2 as boundaries. However, the embodiment is not limited thereto, and the fourth zone Z4 to the sixth zone Z6 may be divided based on a predetermined size or divided based on an outer wall, a corner, furniture, and the like, and may also be divided by a method of efficiently performing the collaborative driving of the moving robot system 1 as described above.

During collaborative driving of the moving robot system 1, the first robot 100a may drive along a first driving path L1, and the second robot 100b may drive along a second driving path L2. In this case, the first path L1 refers to all paths for the first robot 100a to clean an area to be cleaned, such as bypassing an obstacle. In addition, the second driving path L2 refers to all paths for the second robot 100b to clean the area to be cleaned, and may be set to be the same as the driving path that the first robot 100a has already driven. However, when an obstacle that did not exist during the driving of the first robot 100a occurs, the second robot 100b may drive on a modified path such as a detour.

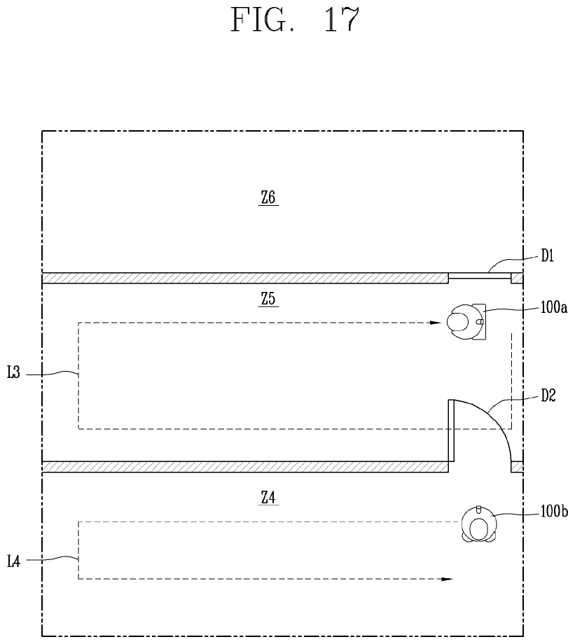

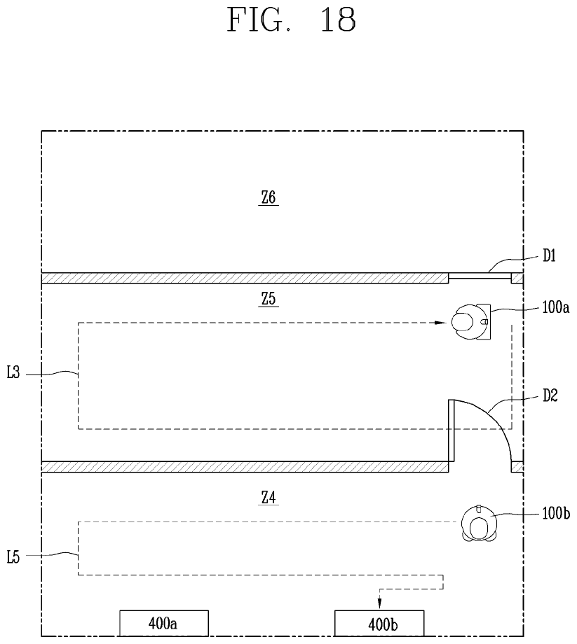

Hereinafter, a scenario according to a trap situation and a case where the first robot 100a is in the trap situation will be described with reference to FIGS. 17 and 18.

Referring to FIG. 17, there is shown a state in which the first robot 100a completes the cleaning of the fifth zone Z5, and the second robot 100b completes the cleaning of the fourth zone Z4. Furthermore, there is shown a state in which an entrance D1 that allows the robot to move from the fifth zone Z5 to the sixth zone Z6 is closed. Accordingly, it refers to a case where the first robot 100a is in a trap situation.

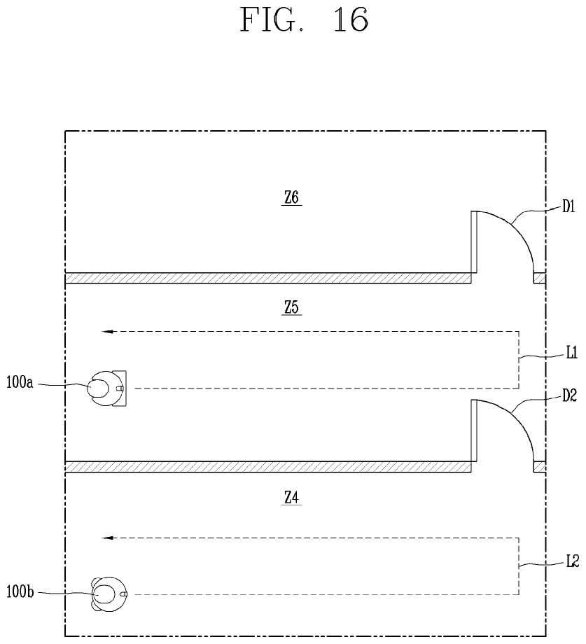

The trap situation refers to a situation in which the first robot 100a or the second robot 100b is unable to enter a zone to be cleaned that has not been driven. In other words, it refers to a situation in which the first robot 100a and/or the second robot 100b is unable to enter an uncleaned area. Therefore, the trap situation of the first robot 100a in FIG. 15 refers to a state in which the first robot 100a completes the cleaning of the fifth zone Z5, but is unable to enter the sixth zone Z6, which is a cleaning expected zone.

In addition, in order to indicate the division of a cleaning area and whether being able to move to the cleaning area, it is shown whether movement between cleaning zones is allowed by opening and closing a first entrance D1 and a second entrance D2, but the embodiment is not limited thereto, and the trap situation includes a situation in which the first robot 100a and the second robot 100b are unable to enter a zone to be cleaned that has not been driven by various obstacles such as a chair, a desk, furniture, and the like, in addition to a door.

When a trap situation occurs in the first robot 100a while performing the collaborative driving mode of the moving robot system 1, the first robot 100a performs trap escape driving. The trap escape driving refers to a driving method in which the first robot 100a drives along an outer perimeter or boundary of the cleaning zone. In other words, the trap escape driving refers to a driving method in which the first robot 100a or the second robot 100b drives while pushing the outer perimeter or boundary of the cleaning zone that has already been driven. A third path L3 refers to all paths in which the first robot 100a or the second robot 100b drives while pushing the outer perimeter or boundary of the cleaning zone as the trap escape driving is performed.

A case of escaping from a trap situation denotes that the first robot 100a and/or the second robot 100b enters an uncleaned zone that has not been able to enter. Accordingly, in case where the first robot 100a is in a trap situation and the second robot 100b is not in a trap situation, when the first robot 100a performs trap escape driving to escape from the trap situation, that is, when neither the first robot 100a nor the second robot 100b is in a trap situation, the first robot 100a and the second robot 100b perform collaborative driving again.

Furthermore, when the first robot 100a is in a trap situation and the second robot 100b is not in a trap situation, the second robot 100b may stand by in place for a preset first time period. In addition, the second robot 100b may end the driving of the fourth zone Z4 being cleaned, and then stand by for a preset first time period at the end point. When the first robot 100a escapes from the trap situation while the second robot 100b is standing by, the second robot 100b releases the standby state to perform collaborative driving with the first robot 100a.

Furthermore, when the first robot 100a is in a trap situation and the second robot 100b is not in a trap situation, the second robot 100b may stand by for a preset first time period and then perform re-cleaning again along a fourth path L4 in the fourth zone Z4 that has already been cleaned. In this case, the re-cleaning time period may be set to a preset second time period. The fourth path L4 refers to all paths for performing re-cleaning of an area to be cleaned, such as returning to a second path L2 that has already been driven, or driving by avoiding an obstacle to perform re-cleaning. When the first robot 100a escapes from the trap situation while the second robot 100b performs re-cleaning in the fourth zone Z4 that has already been cleaned, the second robot 100b and the first robot 100a perform collaborative driving again.

The first time period may be set to 1 minute and the second time period may be set to 9 minutes, but the embodiment is not limited thereto. Since water may accumulate on the floor when the standby time period of the second robot 100b becomes long, the first time period may be set as an appropriate time period to prevent water accumulation. In addition, the second time period may be set as an appropriate time period for the second robot 100b to perform re-cleaning and to stand by for the first robot 100a to escape from the trap situation.

When the first robot 100a escapes from the trap situation while the second robot 100b performs re-cleaning for the second time period, the second robot 100b stops re-cleaning to perform collaborative driving again with the first robot 100a.

FIG. 18 is a view showing a case where a first time period for the second robot 100b to stand by and a second time period for the second robot 100b to perform re-cleaning have passed from a case where the first robot 100a is in a trap situation and the second robot 100b is not in a trap situation.

When the first robot 100a fails to escape from the trap situation for the first time period and the second time period, the second robot 100b releases the collaborative driving mode to return to the second charging stand 400b. At this time, a fifth path L5 in which the second robot 100b returns to the second charging stand 400b refers to all paths returning to the second charging stand 400b after the first time period in which the second robot 100b stand by and the second time period in which the re-cleaning is performed have passed.

Furthermore, when the first robot 100a is in a trap situation and the second robot 100b is not in a trap situation, the second robot 100b may immediately release the collaborative driving mode to return to the second charging stand 400b without standing by for the first time period or performing re-cleaning for the second time period when the first robot 100a is in the trap situation.

In addition, when only the first robot 100a is in a trap situation, the second robot 100b returns to the second charging stand 400b without releasing the collaborative driving mode, and then perform cleaning according to the collaborative driving mode when the first robot 100a escapes from the trap situation. When the first robot 100a fails to escape from the trap situation for a preset time period after the second robot 100b returns to the second charging stand 400b, the second robot 100b may release the collaborative driving mode to end cleaning.

In addition, when the first robot 100a is in a trap situation and the second robot 100b is not in a trap situation, the second robot 100b may perform the cleaning of the fifth zone Z5 in which the cleaning of the first robot 100a has been completed but has not been driven while the first robot 100a performs a trap escape driving.

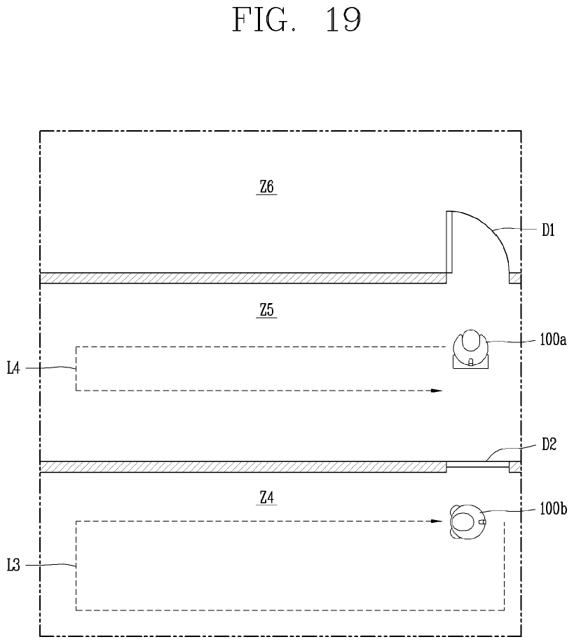

Hereinafter, a scenario according to a case where the second robot 100b is in a trap situation will be described with reference to FIG. 19.

Referring to FIG. 19, the first robot 100a is in a state in which the cleaning of the fifth zone Z5 is completed, and the second robot 100b is in a state in which the cleaning of the fourth zone Z4 is completed. In addition, there is shown a state in which the entrance D2 that allows the robot to move from the fourth zone Z4 to the fifth zone Z5 is closed. Accordingly, it refers to a case where the second robot 100b is in a trap situation.

When the first robot 100a is not in a trap situation and the second robot 100b is in a trap situation, the second robot 100b performs trap escape driving along the third path L3. As described above, the trap escape driving along the third path L3 refers to a driving method in which the second robot 100b drives while pushing an outer perimeter or boundary of the cleaning zone that has been driven.

While the second robot 100a performs the trap escape driving, the first robot 100a may stand by in place for a first time period. Furthermore, the first robot 100a may end the driving of the fifth zone Z5 being cleaned, and then stand by for the first time period at the end point. When the first robot 100b escapes from the trap situation while the first robot 100a is standing by, the first robot 100a releases the standby state to perform collaborative driving with the second robot 100b.

Furthermore, when the first robot 100a is not in a trap situation and the second robot 100b is in a trap situation, the first robot 100a may stand by for a preset first time period and then perform re-cleaning again along a fourth path L4 in the fourth zone Z5 that has already been cleaned. At this time, the re-cleaning time period may be set to a preset second time period, and the fourth path L4 refers to all paths for performing re-cleaning of a cleaning zone, such as returning to a first path L1 that has already been driven, or driving by avoiding an obstacle to perform re-cleaning. When the second robot 100b escapes from the trap situation while the first robot 100a performs re-cleaning in the fifth zone Z5 that has already been cleaned, the first robot 100a and the second robot 100b perform collaborative driving again.

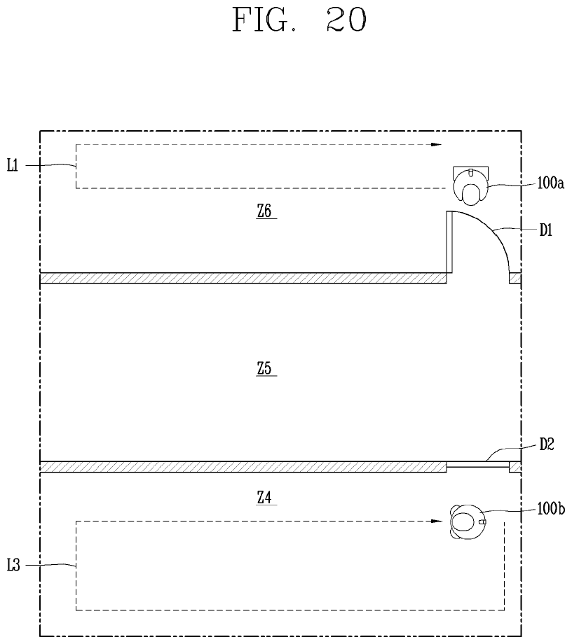

Hereinafter, a scenario according to a case where the second robot 100b is in a trap situation will be described with reference to FIG. 20.

FIG. 20 is a view showing a case where a first time period for the first robot 100a to stand by and a second time period for the first robot 100a to perform re-cleaning have passed from a case where the second robot 100b is in a trap situation and the first robot 100a is not in a trap situation.

When the first robot 100a is in a trap situation as described above, in case where the first robot 100a fails to escape from the trap situation during the first time period for the second robot 100b to stand by and the second time period for the second robot 100b to perform re-cleaning, the first robot 100a releases the collaborative driving mode to perform independent driving instead of allowing the second robot 100b to release the collaborative driving to return to the second charging stand 400b when the first time period and the second time period have passed in case where the second robot 100b is in a trap situation.

In other words, in case where the first time period for the first robot 100a to stand by and the second time period for the first robot 100a to perform re-cleaning have passed while the first robot 100a is not in a trap situation, but the second robot 100b is in a trap situation, the first robot 100a releases the collaborative driving mode and enter the independent driving mode to perform independent driving. Accordingly, the first robot 100a drives in the sixth zone Z6, which is a cleaning expected zone. In this case, the first path L1 in which the first robot 100a drives in the sixth zone Z6 refers to all paths for cleaning a cleaning zone.

In addition, in case where the first robot 100a is not in a trap situation and the second robot 100b is in a trap situation, the first robot 100a may release the collaborative driving mode as soon as the trap situation occurs in the second robot 100b, and enter an independent driving mode to drive in the sixth zone Z6, which is a cleaning expected zone.

Furthermore, when the first robot 100a is not in a trap situation and the second robot 100b is in a trap situation, the first robot 100a may immediately release the collaborative driving mode to return to the first charging stand 400a without standing by for the first time period or performing re-cleaning for the second time period. In other words, when the first robot 100a is not in a trap situation, the first robot 100a may release the collaborative driving mode as soon as the second robot 100b is in a trap situation to return to the first charging stand 400a.

In addition, when only the second robot 100b is in a trap situation, the first robot 100a may return to the first charging stand 400a without releasing the collaborative driving mode, and then perform the collaborative driving mode again to perform collaborative driving when the second robot 100b escapes from the trap situation. When the second robot 100b fails to escape from the trap situation for a preset time period after the first robot 100a returns to the first charging stand 400a, the first robot 100a may release the collaborative driving mode to end cleaning.

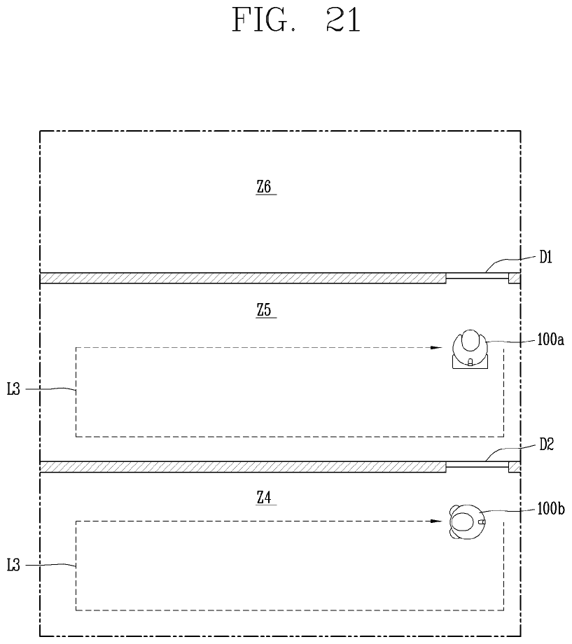

Hereinafter, a scenario according to a case in which the first robot 100a and the second robot 100b are in a trap situation will be described with reference to FIG. 21.

Referring to FIG. 21, there is shown a state in which both the first entrance D1 and the second entrance D2 are closed, and both the first robot 100a and the second robot 100b are in a trap situation. However, it is divided for convenience of explanation, and the embodiment is not limited thereto, and refers to all cases where the first robot 100a and the second robot 100b are in a trap situation, including a case where a trap situation occurs while the first robot 100a and the second robot 100b drive in the same cleaning zone.

When both the first robot 100a and the second robot 100b are in a trap situation, the first robot 100a and the second robot 100b respectively perform trap escape driving. Furthermore, when only the first robot 100a escapes from a trap situation according to the trap escape driving, it operates according to a scenario in which the foregoing first robot 100a is not in the trap situation and the second robot 100b is in a trap situation. In addition, when only the second robot 100b escapes from a trap situation according to the trap escape driving, it operates according to a scenario in which the foregoing first robot 100a is in a trap situation and the second robot 100b is not in the trap situation.

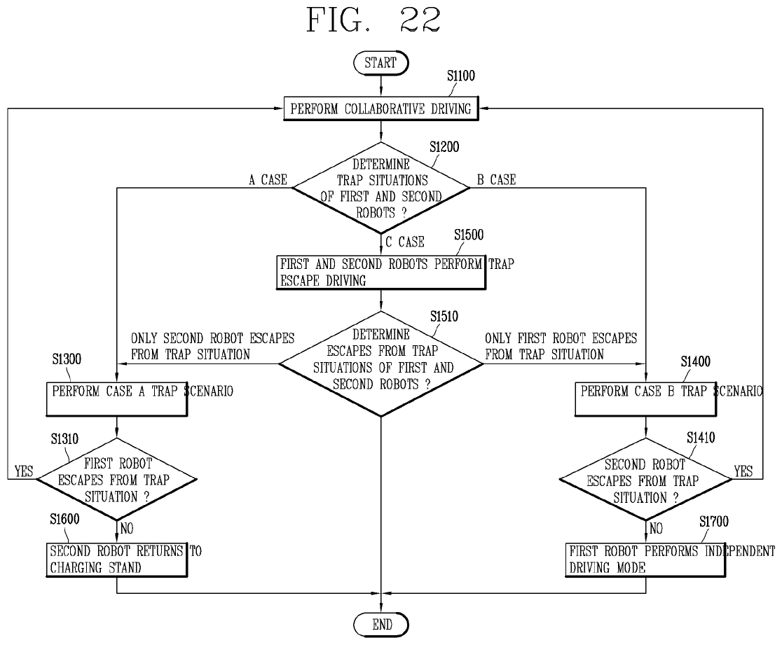

Hereinafter, a method of performing collaborative driving of the moving robot system 1 when a trap situation occurs will be described with reference to FIG. 22.

FIG. 22 is a flowchart of a method of performing collaborative driving of the moving robot system 1 when a trap situation occurs.

Referring to FIG. 22, step S1100 refers to a process in which the first robot 100a and the second robot 100b enter the collaborative driving mode and perform collaborative driving by recognizing position information to each other. At this time, a zone to be cleaned may be divided into one or more zones Z4 to Z6 to perform cleaning in the unit of divided zone.

In step S1200, it is determined whether the first robot 100a and the second robot 100b are in a trap situation. At this time, it is divided into three cases to perform a scenario according to the trap situation. First, case A represents a case in which the first robot 100a is a trap situation and the second robot 100b is not a trap situation. Case B represents a case in which the first robot 100a is not in a trap situation and the second robot 100b is in a trap situation. Case C represents a case in which both the first robot 100a and the second robot 100b are in a trap situation.

In step S1300, a trap scenario according to case A is performed. As disclosed in the foregoing description of FIGS. 17 and 18, the trap scenario according to case A refers to driving of the first robot 100a and the second robot 100b when the first robot 100a is a trap situation, and the second robot 100b is not a trap situation.

Therefore, according to the trap scenario of case A, when only the first robot 100a is in a trap situation, the first robot 100a performs trap escape driving. While the first robot 100a performs the trap escape driving, the second robot 100b may stand by in place for a preset first time period. Furthermore, the second robot 100b may end the driving of a cleaning zone that is being cleaned, and then stand by for the first time period at a point where cleaning ends. When the first robot 100a escapes from the trap situation while the second robot 100b is standing by, the second robot 100b releases the standby state to perform collaborative driving again with the first robot 100a.

In addition, while the first robot 100a performs trap escape driving, the second robot 100b may stand by for the first time period and then perform re-cleaning in a cleaning zone that has already been cleaned. In this case, the re-cleaning time period may be set to a preset second time period. When the first robot 100a escapes from the trap situation while the second robot 100b performs re-cleaning for the second time period, the second robot 100b stops re-cleaning to perform collaborative driving again with the first robot 100a.

Furthermore, when the first robot 100a fails to escape from the trap situation during the first time period for the second robot 100b to stand by and the second time period for the second robot 100b to perform re-cleaning, the second robot 100b releases the collaborative driving mode to return to the second charging stand 400b.

In addition, when only the first robot 100a is in a trap situation, the second robot 100b may immediately release the collaborative driving mode to return to the second charging stand 400b without standing by for the first time period or performing re-cleaning for the second time period when the first robot 100a is in the trap situation.

Furthermore, although only representative scenarios are shown in the flowchart of FIG. 22, when only the first robot 100a is in a trap situation, the second robot 100b may return to the second charging stand 400b without releasing the collaborative driving mode, and then perform the collaborative driving mode again to perform cleaning when the first robot 100a escapes from the trap situation. When the first robot 100a fails to escape from the trap situation for a preset time period after the second robot 100b returns to the second charging stand 400b, the second robot 100b may release the collaborative driving mode to end cleaning.

In addition, when only the first robot 100a is in a trap situation, the second robot 100b may perform cleaning of a cleaning area in which the cleaning of the first robot 100a has been completed but the second robot 100b has not driven.

In step S1310, as a result of performing the trap escape driving by the first robot 100a, it is determined whether the first robot 100a has escaped from the trap situation. When the first robot 100a escapes from the trap situation, neither the first robot 100a nor the second robot 100b is in the trap situation. Therefore, collaborative driving is performed (S1100). However, when the first robot 100a fails to escape from the trap situation, the second robot 100b returns to the second charging stand 400b (S1600).

In step S1400, a trap scenario according to case B is performed. As disclosed in the foregoing description of FIGS. 19 and 20, the trap scenario according to case B refers to driving of the first robot 100a and the second robot 100b when the second robot 100b is a trap situation, and the first robot 100a is not a trap situation.

Therefore, according to the trap scenario of case B, when only the second robot 100b is in a trap situation, the second robot 100b performs trap escape driving. While the second robot 100b performs the trap escape driving, the first robot 100a may stand by in place for a preset first time period. Furthermore, the first robot 100a may end the driving of a cleaning zone that is being cleaned, and then stand by for the first time period at a point where cleaning ends. When the second robot 100b escapes from the trap situation while the first robot 100a is standing by, the first robot 100a releases the standby state to perform collaborative driving again with the second robot 100b.

In addition, while the second robot 100b performs the trap escape driving, the first robot 100a may stand by for the first time period and then perform re-cleaning in a cleaning zone that has already been cleaned. In this case, the re-cleaning time period may be set to a preset second time period. When the second robot 100b escapes the trap situation while the first robot 100a performs re-cleaning for the second time period, the first robot 100a stops re-cleaning to perform collaborative driving again with the second robot 100b.

Furthermore, when the second robot 100b fails to escape the trap situation during the first time period for the second robot 100b to stand by and the second time period for the second robot 100b to perform re-cleaning, the first robot 100a may release the collaborative driving and enter an independent driving mode to perform independent driving. In other words, while the second robot 100b performs trap escape driving, the first robot 100a may stand by for a first time period, and perform re-cleaning for a second time period, and then perform independent driving according to an independent driving mode.

In addition, although only representative scenarios are shown in the flowchart of FIG. 22, when only the second robot 100b is in a trap situation, the first robot 100a may immediately release the collaborative driving mode to return to the first charging stand 400a without standing by for the first time period or performing re-cleaning for the second time period when the second robot 100b is in the trap situation.

In addition, when only the second robot 100b is in a trap situation, the first robot 100a may return to the first charging stand 400a without releasing the collaborative driving mode, and then perform collaborative driving again when the second robot 100b escapes from the trap situation. When the second robot 100b fails to escape from the trap situation for a preset time period after the first robot 100a returns to the first charging stand 400a, the first robot 100a may release the collaborative driving mode to end cleaning.

In step S1410, as a result of performing the trap escape driving by the second robot 100b, it is determined whether the second robot 100b has escaped from the trap situation. When the second robot 100b escapes from the trap situation, neither the first robot 100a nor the second robot 100b is in the trap situation. Therefore, collaborative driving is performed (S1100). However, when the second robot 100b fails to escape from the trap situation, the first robot 100a performs independent driving according to the independent driving mode (S1700).

In step S1500, in response to case C in which both the first robot 100a and the second robot 100b are in a trap situation, the first robot 100a and the second robot 100b respectively perform trap escape driving. Then, in step S1510, it is determined whether the first robot 100a and the second robot 100b, respectively, escape from the trap situation. When only the second robot 100b escapes from the trap situation, since it corresponds to case A, a case A trap scenario is performed (S1300). When only the first robot 100a escapes the trap situation, since it corresponds to case B, a case B trap scenario is performed (S1400). In addition, when both the first robot 100a and the second robot 100b escape from the trap situation, collaborative driving may be performed (S1100).

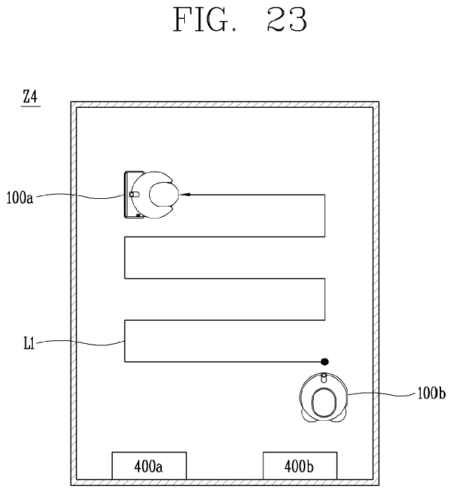

Hereinafter, Embodiment 2 of the moving robot system 1 that performs a preset scenario in response to an error that occurs while performing collaborative driving will be described with reference to FIGS. 23 to 29.

The first robot 100a and the second robot 100b may enter a collaborative driving mode using the network 50. Referring to FIG. 23, when the first robot 100a and the second robot 100b enter a collaborative driving mode and recognize position information to each other, the first robot 100a may drive prior to the driving of the second robot 100b to suck contaminants in the zone Z4 to be cleaned. Here, the contaminants may include all suckable substances such as dust, foreign substances, and debris existing in the zone Z4 to be cleaned. In addition, the second robot 100b may drive along the path L1 that has been driven by the first robot 100a to wipe the floor in the zone Z4 to be cleaned. Here, wiping the floor by the second robot 100b may denote wiping a substance such as a liquid that cannot be sucked by the first robot 100a by mopping. However, while performing the collaborative driving, there may be a case in which an error occurs in at least one of the first robot 100a and the second robot 100b to stop the collaborative driving. In this case, the first robot 100a and the second robot 100b may perform a preset scenario in response to an error that occurs while performing collaborative driving.

Table 1 is a table showing first to seventh embodiments for preset scenarios performed by first robot 100a and the second robot 100b in response to an error that occurs while performing collaborative driving. In Table 1, the “error” denotes a state in which the first robot 100a or the second robot 100b is unable to continuously perform collaborative driving, such as being stuck in an obstacle, falling off of the wheel, or failure of the motor that rotates the wheel. Furthermore, “OK” denotes a state in which the first robot 100a or the second robot 100b is able to continuously perform collaborative driving without generating an error.

In Table 1, different reference numerals are assigned to errors, respectively, in the first to seventh embodiments, for the sake of convenience of explanation. In addition, it should be understood that each embodiment to be described below is independent. Meanwhile, the first robot 100a and the second robot 100b may include a button for receiving a resume command from the user. The first robot 100a and the second robot 100b may perform collaborative driving again when receiving a resume command, and recognizing position information to each other after the error is resolved. The resume command relates to a second embodiment, a third embodiment, a sixth embodiment, and a seventh embodiment, which will be described later. Hereinafter, the first to seventh embodiments will be described in detail with reference to Table 1.

TABLE 1

| Embodiment | State of first robot 100a | State of second robot 100b |
|---|---|---|
| 1 | Error (a) | OK |
| 2 | Error (b) | OK |
| 3 | Error (c) | OK |
| 4 | Error (d) | Error (e) |
| 5 | OK | Error (f) |
| 6 | OK | Error (g) |
| 7 | OK | Error (h) |

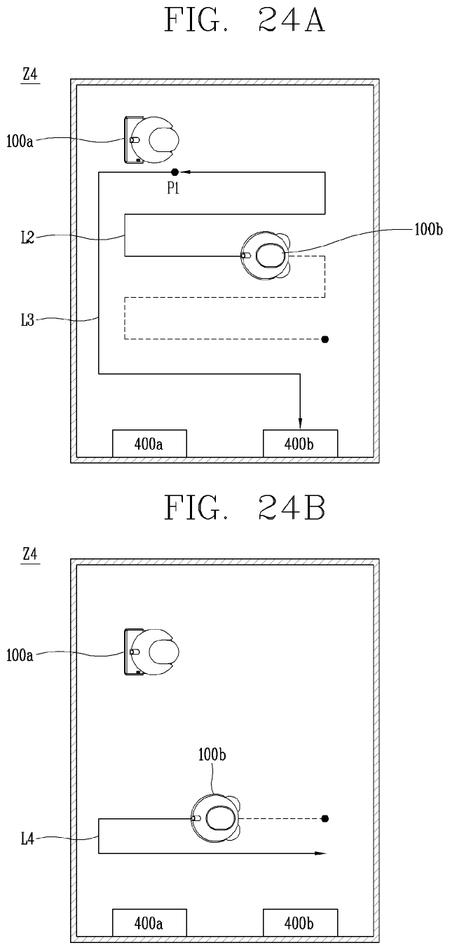

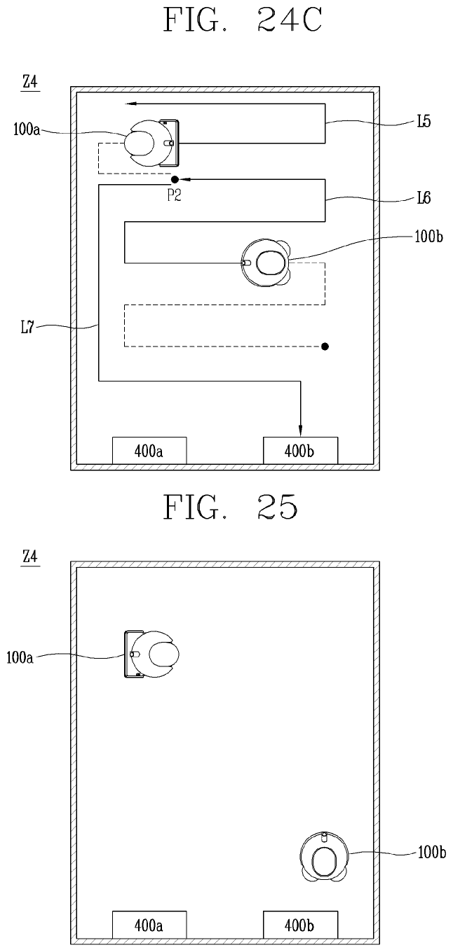

The first embodiment represents a scenario in case where while performing collaborative driving, an error (a) occurs in the first robot 100a, and a preset standby time period has passed. In this case, the first robot 100a may turn off the power after the preset standby time period. Here, the preset standby time period may be 10 minutes. On the other hand, referring to FIG. 24A, in the first embodiment, the second robot 100b may release a collaborative driving mode and drive to point P1 at which the first robot 100a has driven (L2), and then return to the charging stand 400b (L3). Here, the point P1 at which the first robot 100a has driven is a position of the first robot 100a at the time when the error (a) occurs. In other words, the second robot 100b may drive up to the point P1 at which the first robot 100a has sucked contaminants (L2), wipe the floor, and then return to the second charging stand 400b (L3). On the other hand, as another embodiment of the first embodiment, it may be considered that the second robot 100b releases the collaborative driving mode, and then performs independent driving without returning to the second charging stand 400b. The second embodiment represents a scenario in case where while performing collaborative driving, an error (b) occurs in the first robot 100a, but the error (b) is resolved and a resume command is received at the first robot 100a, and the first robot 100a and the second robot 100b recognize position information to each other for a preset standby time period. In this case, the first robot 100a and the second robot 100b may perform collaborative driving again. Here, the preset standby time period may be 10 minutes. On the other hand, referring to FIG. 24B, in the second embodiment, the second robot 100b may drive again (L4) in a zone to be cleaned that has been driven by the second robot 100b itself from the time when the error (b) occurs to the time when the collaborative driving is performed again. In other words, when the second robot 100b is left in place during the standby time period, since the floor may be wet with water at the standby point, the second robot 100b may wipe the floor in zone area to be cleaned again, which has already wiped the floor. On the other hand, as another embodiment of the second embodiment, it may be considered that the first robot 100a and the second robot 100b releases a collaborative driving mode without performing the collaborative driving, and then perform independent driving, respectively. The third embodiment represents a scenario in case where while performing collaborative driving, an error (c) occurs in the first robot 100a, and the error (c) is resolved and a resume command is received at the first robot 100a, but the first robot 100a and the second robot 100b do not recognize position information to each other for a preset standby time period. Here, the preset standby time period may be 10 minutes. Referring to FIG. 24C, the first robot 100a may release a collaborative driving mode, and then perform independent driving (L5). Furthermore, the second robot 100b may release the collaborative driving mode and drive to point P2 at which the first robot 100a has driven (L6), and then return to the second charging stand 400b (L7). Here, the point P2 at which the first robot 100a has driven is a position of the first robot 100a at the time when the error (c) occurs. In other words, the second robot 100b may drive up to the point P2 at which the first robot 100a has sucked contaminants (L6), wipe the floor, and then return to the second charging stand 400b (L7). On the other hand, as another embodiment of the third embodiment, it may be considered that the second robot 100b releases the collaborative driving mode, and then performs independent driving without returning to the second charging stand 400b. Furthermore, as another embodiment of the third embodiment, it may be considered that the first robot 100a and the second robot 100b release a collaborative driving mode and then return to the charging stands 400a, 400b, respectively. In addition, as another embodiment of the third embodiment, after the first robot 100a and the second robot 100b release the collaborative driving mode, it may be considered that the first robot 100a returns to the first charging stand 400a, and the second robot 100b performs independent driving. The fourth embodiment represents a scenario in case where errors occur in both the first robot 100a and the second robot 100b, and a preset standby time period has passed while performing collaborative driving. In other words, in the fourth embodiment, an error (d) occurs in the first robot 100a, and an error (e) occurs in the second robot. Referring to FIG. 25, the first robot 100a and the second robot 100b may respectively turn off their power after a preset standby time period. Here, the preset standby time period may be 10 minutes.

The fifth embodiment represents a scenario in case where an error (f) occurs in the second robot 100b, and a preset standby time period has passed while performing collaborative driving. In this case, the second robot 100b may turn off the power after the preset standby time period. Here, the preset standby time period may be 10 minutes. Meanwhile, referring to FIG. 24A, in the fifth embodiment, the first robot 100a may release a collaborative driving mode, and then perform independent driving (L8). On the other hand, as another embodiment of the fifth embodiment, it may be considered that the first robot 100a releases the collaborative driving mode and then returns to the charging stand 400a without performing independent driving.

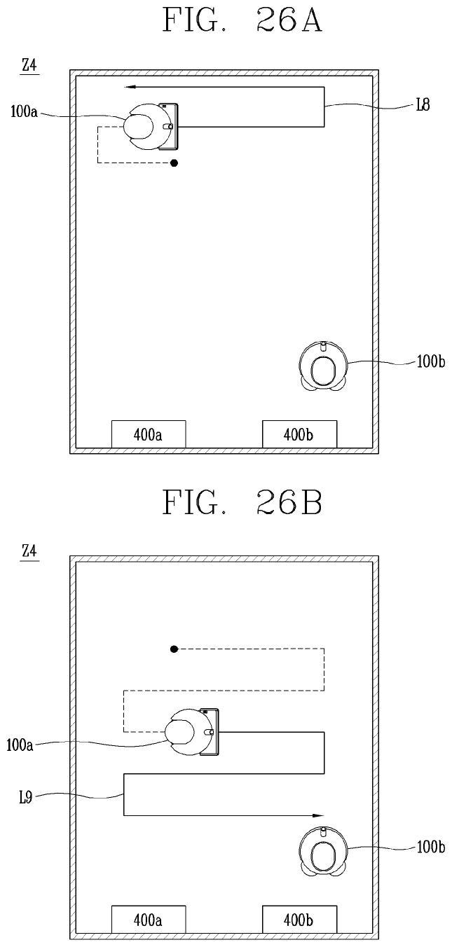

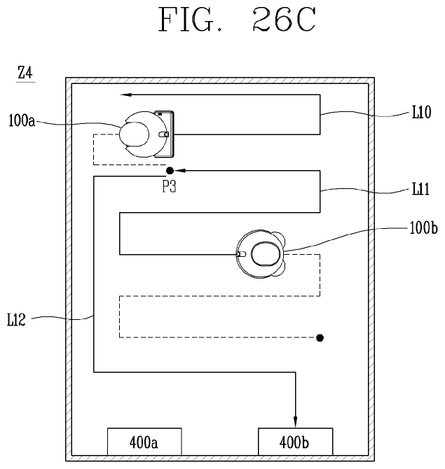

The sixth embodiment represents a scenario in case where while performing collaborative driving, an error (g) occurs in the second robot 100b, but the error (g) is resolved and a resume command is received at the second robot 100b, and the first robot 100a and the second robot 100b recognize position information to each other for a preset standby time period. In this case, the first robot 100a and the second robot 100b may perform collaborative driving again. Here, the preset standby time period may be 10 minutes. On the other hand, referring to FIG. 26B, in the sixth embodiment, the first robot 100a may drive again (L9) in a zone to be cleaned that has been driven by the first robot 100a itself from the time when the error (g) occurs to the time when the collaborative driving is performed again. On the other hand, as another embodiment of the sixth embodiment, it may be considered that the first robot 100a and the second robot 100b releases a collaborative driving mode without performing the collaborative driving, and then perform independent driving, respectively.

The seventh embodiment represents a scenario in case where while performing collaborative driving, an error (h) occurs in the second robot, and the error (h) is resolved and a resume command is received at the second robot 100b, but the first robot 100a and the second robot 100b do not recognize position information to each other for a preset standby time period. Here, the preset standby time period may be 10 minutes. Referring to FIG. 26C, the first robot 100a may release the collaborative driving mode and then perform independent driving (L10). Furthermore, the second robot 100b may release the collaborative driving mode and drive to point P3 at which the first robot 100a has driven, and then return to the second charging stand 400b. Here, the point P3 at which the first robot 100a has driven is a position of the first robot 100a at the time when the error (h) occurs. In other words, the second robot 100b may drive up to the point P3 at which the first robot 100a has sucked contaminants (L11), wipe the floor, and then return to the second charging stand 400b (L12). On the other hand, as another embodiment of the seventh embodiment, it may be considered that the first robot 100a releases the collaborative driving mode and then returns to the first charging stand 400a without performing independent driving. In addition, as another embodiment of the seventh embodiment, it may be considered that the second robot 100b releases the collaborative driving mode, and then performs independent driving without returning to the second charging stand 400b, and the first robot 100a releases the collaborative driving mode, and then performs independent driving or returns to the charging stand 400a.

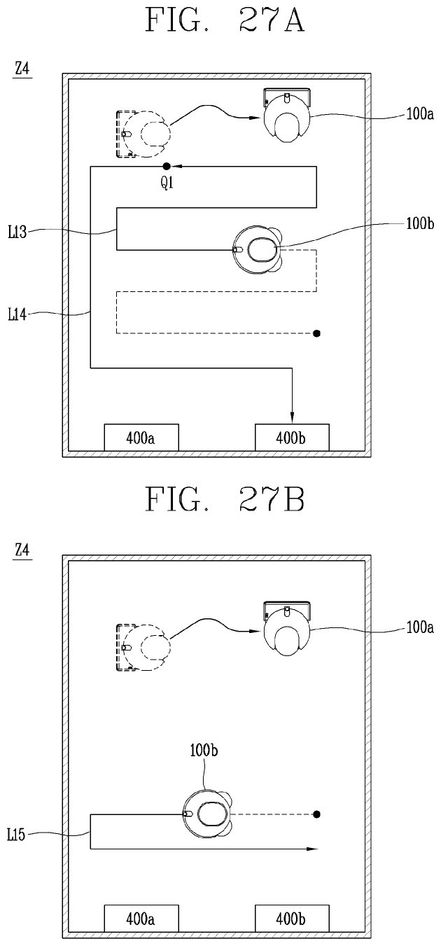

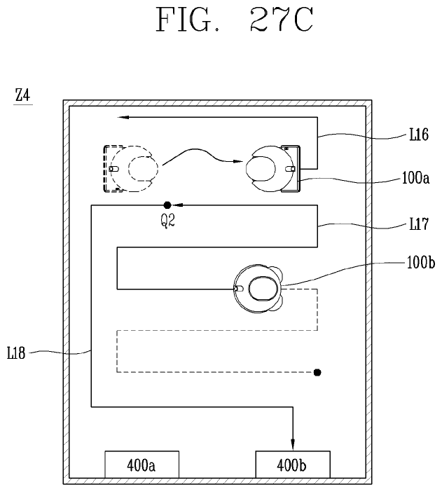

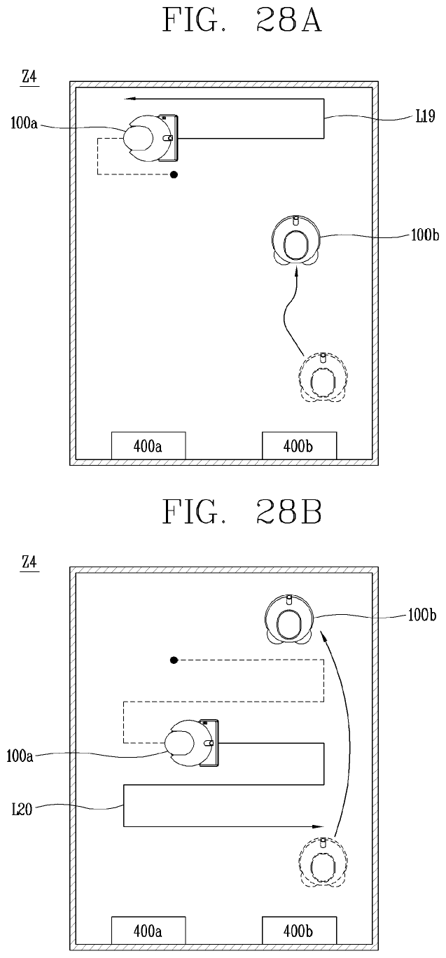

Hereinafter, the moving robot system 1 that performs a preset scenario in response to a kidnap that occurs while performing collaborative driving will be described with reference to FIGS. 27A to 28C.

The first robot 100a and the second robot 100b may enter a collaborative driving mode using the network 50. Referring back to FIG. 23, when the first robot 100a and the second robot 100b enter a collaborative driving mode and recognize position information to each other, the first robot 100a may drive prior to the driving of the second robot 100b to suck contaminants in the zone Z4 to be cleaned. Here, the contaminants may include all suckable substances such as dust, foreign substances, and debris existing in the zone Z4 to be cleaned. In addition, the second robot 100b may drive along the path L1 that has been driven by the first robot 100a to wipe the floor in the zone Z4 to be cleaned. Here, wiping the floor by the second robot 100b may denote wiping a substance such as a liquid that cannot be sucked by the first robot 100a by mopping. However, while performing the collaborative driving, there may be a case in which a kidnap occurs in at least one of the first robot 100a and the second robot 100b to stop the collaborative driving. In this case, the first robot 100a and the second robot 100b may perform a preset scenario in response to a kidnap that occurs while performing collaborative driving.

Table 2 is a table showing first to seventh embodiments for preset scenarios performed by the first robot 100a and the second robot 100b in response to a kidnap that occurs while performing collaborative driving. In Table 2, “kidnap” denotes that the user picks up the first robot 100a or the second robot 100b being driven and places it at a different position. Furthermore, “OK” denotes a state in which the first robot 100a or the second robot 100b is able to continuously perform collaborative driving without generating a kidnap.

In Table 2, different reference numerals are assigned to kidnaps, respectively, in the first to seventh embodiments, for the sake of convenience of explanation. In addition, it should be understood that each embodiment to be described below is independent. Meanwhile, the first robot 100a and the second robot 100b may include a button for receiving a resume command from the user. The first robot 100a and the second robot 100b may perform collaborative driving again when receiving a resume command, and recognizing position information to each other. The resume command relates to a second embodiment, a third embodiment, a fourth embodiment, a sixth embodiment, and a seventh embodiment, which will be described later. Hereinafter, the first to seventh embodiments will be described in detail with reference to Table 2.

TABLE 2

| Embodiment | State of first robot 100a | State of second robot 100b |
|---|---|---|
| 1 | Kidnap (i) | OK |
| 2 | Kidnap (j) | OK |
| 3 | Kidnap (k) | OK |
| 4 | Kidnap (l) | Kidnap (m) |
| 5 | OK | Kidnap (n) |
| 6 | OK | Kidnap (o) |
| 7 | OK | Kidnap (p) |

The first embodiment represents a scenario in case where while performing collaborative driving, a kidnap (i) occurs in the first robot 100a, and a preset standby time period has passed. In this case, the first robot 100a may turn off the power after the preset standby time period. Here, the preset standby time period may be 10 minutes. On the other hand, referring to FIG. 27A, in the first embodiment, the second robot 100b may release a collaborative driving mode and drive to point Q1 at which the first robot 100a has driven (L13), and then return to the charging stand 400b (L14). Here, the point Q1 at which the first robot 100a has driven is a position of the first robot 100a at the time when the kidnap (i) occurs. In other words, the second robot 100b may drive up to the point Q1 at which the first robot 100a has sucked contaminants (L13), wipe the floor, and then return to the second charging stand 400b (L14). On the other hand, as another embodiment of the first embodiment, it may also be considered that the second robot 100b releases the collaborative driving mode, and then performs independent driving without returning to the second charging stand 400b. The second embodiment represents a scenario in case where while performing collaborative driving, a kidnap (j) occurs in the first robot 100a, and a resume command is received at the first robot 100a, and the first robot 100a and the second robot 100b recognize position information to each other for a preset standby time period. In this case, the first robot 100a and the second robot 100b may perform collaborative driving again. Here, the preset standby time period may be 10 minutes. On the other hand, referring to FIG. 27B, in the second embodiment, the second robot 100b may drive again (L15) in a zone to be cleaned that has been driven by the second robot 100b itself from the time when the kidnap (j) occurs to the time when the collaborative driving is performed again. In other words, when the second robot 100b is left in place during the standby time period, since the floor may be wet with water at the standby point, the second robot 100b may wipe the floor in zone area to be cleaned again, which has already wiped the floor. On the other hand, as another embodiment of the second embodiment, it may be considered that the first robot 100a and the second robot 100b releases a collaborative driving mode without performing the collaborative driving, and then perform independent driving, respectively. The third embodiment represents a scenario in case where while performing collaborative driving, a kidnap (k) occurs in the first robot 100a, and a resume command is received at the first robot 100a, but the first robot 100a and the second robot 100b do not recognize position information to each other for a preset standby time period. Here, the preset standby time period may be 10 minutes. Referring to FIG. 27C, the first robot 100a may release a collaborative driving mode, and then perform independent driving (L16). Furthermore, the second robot 100b may release the collaborative driving mode and drive to point Q2 at which the first robot 100a has driven (L17), and then return to the second charging stand 400b (L18). Here, the point Q2 at which the first robot 100a has driven is a position of the first robot 100a at the time when the kidnap (k) occurs. In other words, the second robot 100b may drive up to the point Q2 at which the first robot 100a has sucked contaminants (L17), wipe the floor, and then return to the second charging stand 400b (L18). On the other hand, as another embodiment of the third embodiment, it may be considered that the second robot 100b releases the collaborative driving mode, and then performs independent driving without returning to the second charging stand 400b. Furthermore, as another embodiment of the third embodiment, it may be considered that the first robot 100a and the second robot 100b release a collaborative driving mode and then return to the charging stands 400a, 400b, respectively. In addition, as another embodiment of the third embodiment, after the first robot 100a and the second robot 100b release the collaborative driving mode, it may be considered that the first robot 100a returns to the first charging stand 400a, and the second robot 100b performs independent driving.

The fourth embodiment represents a scenario in case where kidnaps occur in both the first robot 100a and the second robot 100b, and a preset standby time period has passed while performing collaborative driving. In other words, in the fourth embodiment, a kidnap (I) occurs in the first robot 100a, and a kidnap (m) occurs in the second robot 100b. In this case, when a resume command is received at the first robot 100a and the second robot 100b, and the first robot 100a and the second robot 100b recognize positions to each other for a preset standby time period, the first robot 100a and the second robot 100b may perform collaborative driving again. Here, the preset standby time period may be 10 minutes. On the other hand, as another embodiment of the fourth embodiment, when a resume command is received at only one of the first robot 100a and the second robot 100b, the first robot 100a and the second robot 100b may follow any one scenario of the first to third embodiments as described above and the fifth to seventh embodiments to be described later, depending on the situation.

The fifth embodiment represents a scenario in case where a kidnap (n) occurs in the second robot 100b, and a preset standby time period has passed while performing collaborative driving. In this case, the second robot 100b may turn off the power after the preset standby time period. Here, the preset standby time period may be 10 minutes. Meanwhile, referring to FIG. 28A, in the fifth embodiment, the first robot 100a may release a collaborative driving mode, and then perform independent driving (L19). On the other hand, as another embodiment of the fifth embodiment, it may be considered that the first robot 100a releases the collaborative driving mode and then returns to the charging stand 400a without performing independent driving.

The sixth embodiment represents a scenario in case where while performing collaborative driving, a kidnap (o) occurs in the second robot 100b, but a resume command is received at the second robot 100b, and the first robot 100a and the second robot 100b recognize position information to each other for a preset standby time period. In this case, the first robot 100a and the second robot 100b may perform collaborative driving again. Here, the preset standby time period may be 10 minutes. On the other hand, referring to FIG. 28B, in the sixth embodiment, the first robot 100a may drive again (L20) in a zone to be cleaned that has been driven by the first robot 100a itself from the time when the kidnap (o) occurs to the time when the collaborative driving is performed again. On the other hand, as another embodiment of the sixth embodiment, it may be considered that the first robot 100a and the second robot 100b releases a collaborative driving mode without performing the collaborative driving, and then perform independent driving, respectively.

The seventh embodiment represents a scenario in case where while performing collaborative driving, a kidnap (p) occurs in the second robot, and a resume command is received at the first robot 100b, but the first robot 100a and the second robot 100b do not recognize position information to each other for a preset standby time period. Here, the preset standby time period may be 10 minutes. Referring to FIG. 28C, the first robot 100a may release the collaborative driving mode and then perform independent driving (L21). Furthermore, the second robot 100b may release the collaborative driving mode and drive to point Q3 at which the first robot 100a has driven, and then return to the second charging stand 400b. Here, the point Q3 at which the first robot 100a has driven is a position of the first robot 100a at the time when the kidnap (p) occurs. In other words, the second robot 100b may drive up to the point Q3 where the first robot 100a has sucked contaminants (L22), wipe the floor, and then return to the second charging stand 400b (L23). On the other hand, as another embodiment of the seventh embodiment, it may be considered that the first robot 100a releases the collaborative driving mode and then returns to the first charging stand 400a without performing independent driving. In addition, as another embodiment of the seventh embodiment, it may be considered that the second robot 100b releases the collaborative driving mode, and then performs independent driving without returning to the second charging stand 400b, and the first robot 100a releases the collaborative driving mode, and then performs independent driving or returns to the charging stand 400a.

Hereinafter, the moving robot system 1 that performs a preset scenario in response to a communication failure that occurs while performing collaborative driving will be described.

The first robot 100a and the second robot 100b may enter a collaborative driving mode using the network 50. Referring back to FIG. 23, when the first robot 100a and the second robot 100b enter a collaborative driving mode and recognize position information to each other, the first robot 100a may drive prior to the driving of the second robot 100b to suck contaminants in the zone Z4 to be cleaned. Here, the contaminants may include all suckable substances such as dust, foreign substances, and debris existing in the zone Z4 to be cleaned. In addition, the second robot 100b may drive along the path L1 that has been driven by the first robot 100a to wipe the floor in the zone Z4 to be cleaned. Here, wiping the floor by the second robot 100b may denote wiping a substance such as a liquid that cannot be sucked by the first robot 100a by mopping. However, while performing the collaborative driving, a communication failure may occur in at least one of the first robot 100a and the second robot 100b. Here, the communication failure refers to any type of failure in which the first robot 100a or the second robot 100b is unable to transmit or receive data with the other moving robot using a network. In this case, the first robot 100a and the second robot 100b may perform a preset scenario in response to a communication failure that occurs while performing collaborative driving.

The network 50 connecting the first robot 100a and the second robot 100b to each other may include a first network and a second network. The first network may be a network for the first robot 100a and the second robot 100b to share map information of the zone Z4 to be cleaned. Here, the first network may be Wi-Fi. In addition, the second network may be a network for the first robot 100a and the second robot 100b to determine to separation distance between the first robot 100a and the second robot 100b. Here, the second network may be UWB. A method of sharing map information using Wi-Fi between the first robot 100a and the second robot 100b, and a method of determining a separation distance between the first robot 100a and the second robot 100b using UWB have been described above, and a description thereof will be omitted. Hereinafter, a first embodiment and a second embodiment for a preset scenario performed by the first robot 100a and the second robot 100b in response to a communication failure that occurs while performing collaborative driving will be described in detail.

The first embodiment represents a scenario in case where a first network or a second network is disconnected between the first robot 100a and the second robot 100b while performing collaborative driving. In this case, the first robot 100a and the second robot 100b may continuously perform collaborative driving. In other words, the first network or the second network being disconnected between the first robot 100a and the second robot 100b denotes that either one of the first network and the second network is connected between the first robot 100a and the second robot 100b.

The second embodiment represents a scenario in case where both the first network and the second network are disconnected between the first robot 100a and the second robot 100b while performing collaborative driving. In this case, the first robot 100a may release the collaborative driving mode and then perform independent driving. In addition, the second robot 100b may release the collaborative driving mode and then return to the second charging stand 100b.

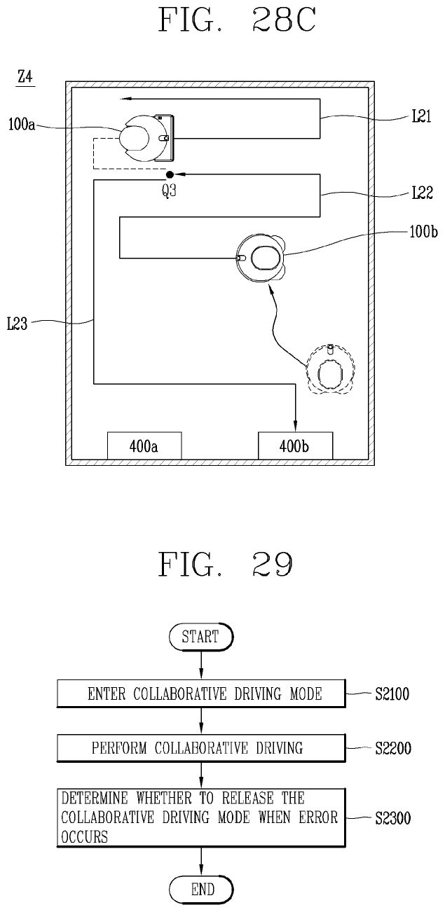

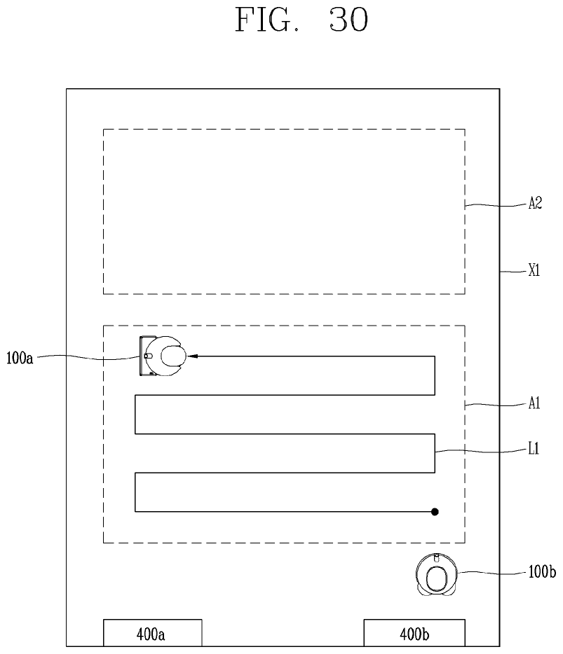

Hereinafter, a method in which the moving robot system 1 performs a preset scenario in response to an error, a kidnap, or a communication failure that occurs while performing collaborative driving will be described with reference to FIG. 29.

Referring to FIG. 29, in step S2100, the first robot 100a and the second robot 100b may enter a collaborative driving mode using the network 50. The process in which the first robot 100a and the second robot 100b enter the collaborative driving mode has been described above, and thus a specific description thereof will be omitted.

In step S2200, the first robot 100a and the second robot 100b may perform collaborative driving by recognizing positions to each other. Referring back to FIG. 23, the first robot 100a may drive prior to the driving of the second robot 100b to suck contaminants in the zone Z4 to be cleaned. Here, the contaminants may include all suckable substances such as dust, foreign substances, and debris existing in the zone Z4 to be cleaned. In addition, the second robot 100b may drive along the path L1 that has been driven by the first robot 100a to wipe the floor in the zone Z4 to be cleaned. Here, wiping the floor by the second robot 100b may denote wiping a substance such as a liquid that cannot be sucked by the first robot 100a by mopping.

In step S2300, the first robot 100a and the second robot 100b may determine whether to release a collaborative driving mode in response to an error, a kidnap, or a communication failure that occurs while performing the collaborative driving. In other words, an error, a kidnap, or a communication failure may occur in at least one of the first robot 100a and the second robot 100b while performing collaborative driving. In this case, the first robot 100a and the second robot 100b may perform a preset scenario in response to an error, a kidnap, or a communication failure that occurs while performing collaborative driving. Preset scenarios in response to errors, kidnaps, or communication failures that occur while performing collaborative driving have been described above, and thus a detailed description thereof will be omitted.

Meanwhile, the moving robot system 1 may include a first robot 100a and a second robot 100b. The first robot 100a and the second robot 100b may each include the main body 110, and the communication unit 1100 provided inside the main body 110 to exchange data with the other moving robot using the network 50. Furthermore, the first robot 100a may include the cleaning unit 120 mounted on one side of the main body 110 to suck contaminants in an area to be cleaned. In addition, the second robot 100b may include a mop unit (not shown) mounted on one side of the main body 110 to wipe the floor in the area to be cleaned. On the other hand, the network 50 connecting the first robot 100a and the second robot 100b to each other may include a first network and a second network. The first network may be a network for the first robot 100a and the second robot 100b to share map information of the area to be cleaned. Here, the first network may be Wi-Fi. In addition, the second network may be a network for the first robot 100a and the second robot 100b to determine to separation distance between the first robot 100a and the second robot 100b. Here, the second network may be UWB. The first robot 100a and the second robot 100b may perform independent driving or collaborative driving, from such a configuration. Furthermore, the first robot 100a and the second robot 100b may perform a preset scenario in response to an error, a kidnap, or a communication failure that occurs while performing collaborative driving, from the configuration. A preset scenario corresponding to an error, a kidnap, or a communication failure that occurs during collaborative driving performed by the first robot 100a and the second robot 100b has been described above, and thus a detailed description thereof will be omitted.

Hereinafter, Embodiment 3 of the moving robot system 1 that performs a preset scenario in response to an obstacle sensed during collaborative driving will be described with reference to FIGS. 30 to 34.

The first robot 100a and the second robot 100b may enter a collaborative driving mode using the network 50. Referring to FIG. 30, when the first robot 100a and the second robot 100b enter a collaborative driving mode, the first robot 100a and the second robot 100b may divide a zone X1 to be cleaned into a plurality of unit zones (e.g., the zone X1 to be cleaned is divided into a first unit zone A1 and a second unit zone A2) to perform collaborative driving for each unit zone. When the first robot 100a and the second robot 100b perform collaborative driving, the first robot 100a may drive prior to the driving of the second robot 100b to suck contaminants in any one (e.g., a first unit zone A1) of the plurality of unit zones. Here, the contaminants may include all suckable substances such as dust, foreign substances, and debris existing in each unit zone. In addition, the second robot 100b may drive along the path L1 that has been driven by the first robot 100a to wipe the floor in any one (the first unit zone A1, which is a unit zone in which contaminants are sucked by the first robot 100a) of the plurality of unit zones. Here, wiping the floor by the second robot 100b may denote wiping a substance such as a liquid that cannot be sucked by the first robot 100a by mopping. A method in which the first robot 100a and the second robot 100b perform collaborative driving for each divided unit zone has been described above, and thus a detailed description thereof will be omitted.

At least one of the first robot 100a and the second robot 100b may sense an obstacle during collaborative driving in any one of the plurality of unit zones. Specifically, at least one of the first robot 100a and the second robot 100b may sense an obstacle existing between the divided zones (e.g., between the first unit zone A1 and the second unit zone A2), or inside the divided zones (e.g., inside the first unit zone A1). Here, an obstacle existing between the divided zones is defined as a first obstacle OB1, and an obstacle existing inside the divided zones is defined as a second obstacle OB2. The first obstacle OB1 or the second obstacle OB2 may be a doorsill, a carpet, or a cliff. Specifically, the first obstacle OB1 or the second obstacle OB2, as an obstacle that can be climbed by the first robot 100a and the second robot 100b, may be is an obstacle disposed at a height or depth within a preset range. For example, the first robot 100a may recognize an obstacle disposed at a height of 5 mm or more as a climbable obstacle. Furthermore, the second robot 100b may recognize an obstacle disposed at a height of 4 mm or more as a climbable obstacle. In addition, the first robot 100a may recognize an obstacle disposed at a depth of 30 mm or more as a climbable obstacle, in case of independent driving. Furthermore, the first robot 100a may recognize an obstacle disposed at a height of 10 mm or more as a climbable obstacle, in case of collaborative driving. In addition, the second robot 100b may recognize an obstacle at a depth of 10 mm or more as a climbable obstacle. Here, climbing an obstacle by the first robot 100a and the second robot 100b refers to crossing a doorsill, crossing a carpet, passing a gap in a cliff, or going down and then going up a slope of a cliff.

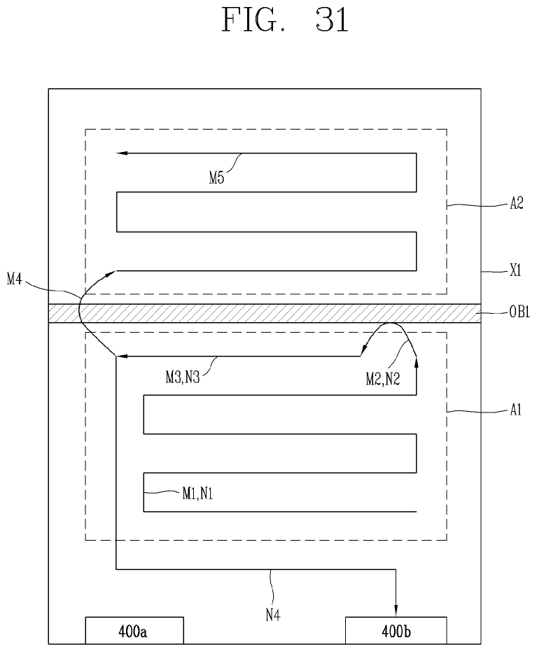

Hereinafter, first to fourth embodiments for preset scenarios performed by at least one of the first robot 100a and the second robot 100b upon sensing the first obstacle OB1 or the second obstacle OB2 will be described in detail. Referring to FIGS. 31 to 34, reference numerals M1 to M17 denote driving paths of the first robot 100a, and reference numerals N1 to N13 denote driving paths of the second robot 100b.

Referring to FIG. 31, the first embodiment represents a scenario in case where first robot 100a and the second robot 100b sense the first obstacle OB1 during collaborative driving in the first unit zone A1 (M1, N1). In this case, the first robot 100a may complete collaborative driving in the first unit zone A1 (M3) by avoiding the first obstacle OB1 (M2), and then enter the second unit zone A2 (M4) to perform independent driving (M5). In the first embodiment, the second robot 100b may complete collaborative driving in the first unit zone A1 (M3) by avoiding the first obstacle OB1 (M2), and then return to the second charging stand 100b (N4). Meanwhile, as another embodiment of the first embodiment, it may be considered that the first robot 100a enters the second unit zone A2 without avoiding the first obstacle OB1, and the second robot 100b completes the wiping of the floor in the first unit zone A1, and stands by until the first robot 100a completes the suction of contaminants in the second unit zone A2.

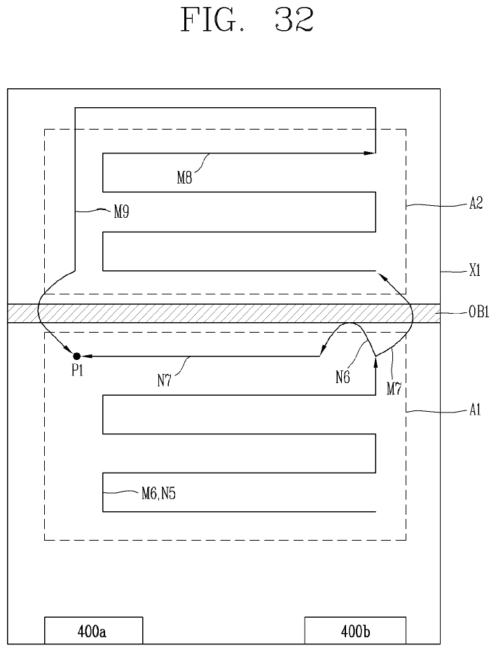

Referring to FIG. 32, the second embodiment represents a scenario in case where while the first robot 100a and the second robot 100b perform collaborative driving in the first unit zone A1 (M6, N5), the first robot 100a enters the second unit zone A2 (M7) without sensing the first obstacle OB1, and the second robot 100b avoids the first obstacle OB1 (N6) by sensing the first obstacle OB1. In this case, the second robot 100b may transmit a notification to the first robot 100a that the second robot 100b is unable to enter the second unit zone A2 after completing the wiping of the floor in the first unit zone A1 (N7). Furthermore, the first robot 100a may complete the suction of contaminants in the second unit zone A2 (M8), and then move to the position P1 (M9) at which the second robot 100b has transmitted the notification. In the second embodiment, even when the first robot 100a enters the second unit zone A2 without completing the suction of contaminants in the first unit zone A1, the second robot 100b may complete the wiping of the floor in the first unit zone A1. In addition, in the second embodiment, the second robot 100b may not wipe the floor in the second unit zone A2 in which the first robot 100a has completed the suction of contaminants. The driving of the first robot 100a and the second robot 100b in the above-described second embodiment should be understood as driving in a collaborative driving mode other than independent driving. Meanwhile, in the second embodiment, the second robot 100b may sense the first obstacle OB1 to transmit information on the first obstacle OB1 to the first robot 100a. In addition, the first robot 100a may receive information on the first obstacle OB1 from the second robot 100b to merge the first obstacle OB1 into a map stored in the memory 1700. In other words, the second robot 100b may share information on the first obstacle OB1 with the first robot 100a.

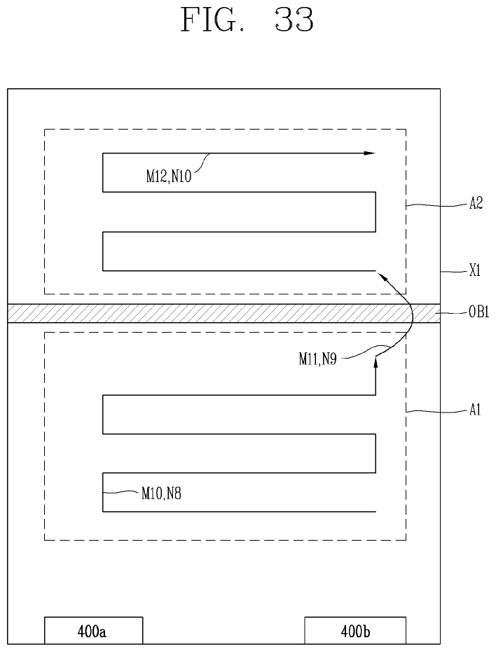

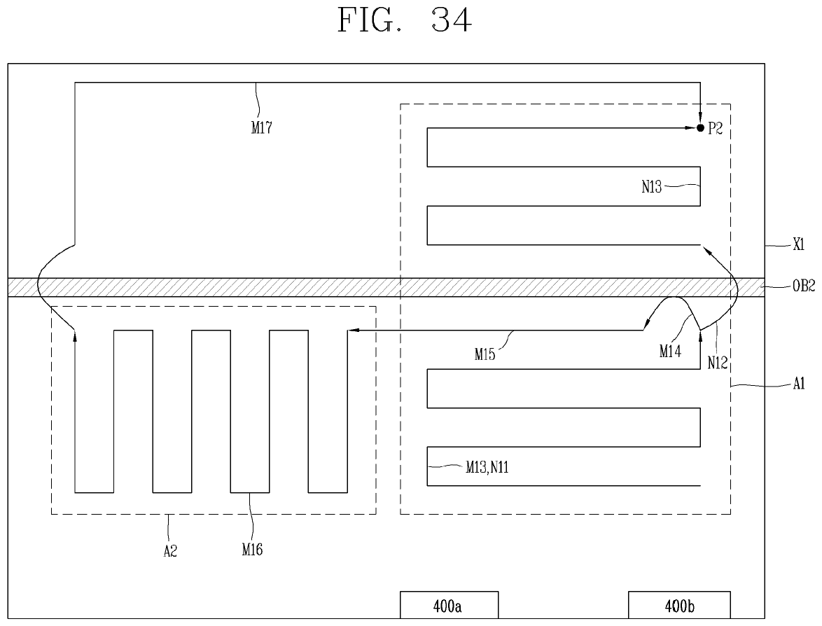

Referring to FIG. 33, the third embodiment represents a scenario in case where the first robot 100a and the second robot 100b enter the second unit zone A2 without sensing the first obstacle OB1 while performing collaborative driving in the first unit zone A1 (M10, N8). In this case, the first robot 100a and the second robot 100b may perform collaborative driving in the second unit zone A2 (M12, N10).

Referring to FIG. 34, the fourth embodiment represents a scenario in case where while the first robot 100a and the second robot 100b perform collaborative driving in the first unit zone A1 (M13, N11), the first robot 100a avoids the second obstacle (M14) by sensing the second obstacle OB2 and then moves to the second unit zone A2 (M15), and the second robot 100b is unable to avoid the second obstacle OB2 (N12) without sensing the second obstacle OB2. In this case, the second robot 100b may transmit a notification to the first robot 100a that the second robot 100b is unable to enter the second unit zone A2 after completing the wiping of the floor in the first unit zone A1 (N13). Furthermore, the first robot 100a may complete the suction of contaminants in the second unit zone A2 (M16), and then move to the position (M17) at which the second robot 100b has transmitted the notification. In the fourth embodiment, even when the first robot 100a moves to the second unit zone A2 without completing the suction of contaminants in the first unit zone A1, the second robot 100b may complete the wiping of the floor in the first unit zone A1. In addition, the second robot 100b may not wipe the floor in the second unit zone A2 in which the first robot 100a has completed the suction of contaminants. The driving of the first robot 100a and the second robot 100b in the above-described fourth embodiment should be understood as driving in a collaborative driving mode other than independent driving. Meanwhile, in the fourth embodiment, the first robot 100a may sense the second obstacle OB2 to transmit information on the second obstacle OB2 to the second robot 100b. In addition, the second robot 100b may receive information on the second obstacle OB2 from the first robot 100a to merge the second obstacle OB2 into a map stored in the memory 1700. In other words, the first robot 100a may share information on the second obstacle OB2 with the second robot 100b.

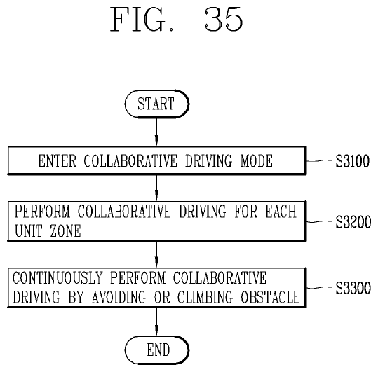

Hereinafter, a method in which the moving robot system 1 performs a preset scenario in response to an obstacle sensed during collaborative driving will be described with reference to FIG. 35.

Referring to FIG. 35, in step S3100, the first robot 100a and the second robot 100b may enter a collaborative driving mode using the network 50. The process in which the first robot 100a and the second robot 100b enter the collaborative driving mode has been described above, and thus a specific description thereof will be omitted.

In step S3200, referring back to FIG. 30, the first robot 100a and the second robot 100b may divide a zone X1 to be cleaned into a plurality of unit zones (e.g., the zone X1 to be cleaned is divided into a first unit zone A1 and a second unit zone A2) to perform collaborative driving for each unit zone. When the first robot 100a and the second robot 100b perform collaborative driving, the first robot 100a may drive prior to the driving of the second robot 100b to suck contaminants in any one (e.g., a first unit zone A1) of the plurality of unit zones. Here, the contaminants may include all suckable substances such as dust, foreign substances, and debris existing in each unit zone. In addition, the second robot 100b may drive along the path L1 that has been driven by the first robot 100a to wipe the floor in any one (the first unit zone A1, which is a unit zone in which contaminants are sucked by the first robot 100a) of the plurality of unit zones. Here, wiping the floor by the second robot 100b may denote wiping a substance such as a liquid that cannot be sucked by the first robot 100a by mopping. A method in which the first robot 100a and the second robot 100b perform collaborative driving for each divided unit zone has been described above, and thus a detailed description thereof will be omitted.

In step S3300, at least one of the first robot 100a and the second robot 100b may sense an obstacle during collaborative driving in any one of the plurality of unit zones. Specifically, at least one of the first robot 100a and the second robot 100b may sense an obstacle existing between the divided zones (e.g., between the first unit zone A1 and the second unit zone A2), or inside the divided zones (e.g., inside the first unit zone A1). Here, an obstacle existing between the divided zones is defined as a first obstacle OB1, and an obstacle existing inside the divided zones is defined as a second obstacle OB2. The first obstacle OB1 or the second obstacle OB2 may be a doorsill, a carpet, or a cliff. Specifically, the first obstacle OB1 or the second obstacle OB2, as an obstacle that the first robot 100a and the second robot 100b is able to climb, may be is an obstacle disposed at a height or depth within a preset range. For example, the first robot 100a may recognize an obstacle disposed at a height of 5 mm or more as a climbable obstacle. Furthermore, the second robot 100b may recognize an obstacle disposed at a height of 4 mm or more as a climbable obstacle. In addition, the first robot 100a may recognize an obstacle disposed at a depth of 30 mm or more as a climbable obstacle, in case of independent driving. Furthermore, the first robot 100a may recognize an obstacle disposed at a height of 10 mm or more as a climbable obstacle, in case of collaborative driving. In addition, the second robot 100b may recognize an obstacle at a depth of 10 mm or more as a climbable obstacle. Here, climbing an obstacle by the first robot 100a and the second robot 100b refers to crossing a doorsill, crossing a carpet, passing a gap in a cliff, or going down and then going up a slope of a cliff. Hereinafter, for the first robot 100a and the second robot 100b, in step S3300, first to fourth embodiments for preset scenarios performed by at least one of the first robot 100a and the second robot 100b upon sensing the first obstacle OB1 or the second obstacle OB2 will be described in detail.

Referring to FIG. 31, the first embodiment represents a scenario in case where first robot 100a and the second robot 100b sense the first obstacle OB1 during collaborative driving in the first unit zone A1 (M1, N1). In this case, the first robot 100a may complete collaborative driving in the first unit zone A1 (M3) by avoiding the first obstacle OB1 (M2), and then enter the second unit zone A2 (M4) to perform independent driving (M5). In the first embodiment, the second robot 100b may complete collaborative driving in the first unit zone A1 (M3) by avoiding the first obstacle OB1 (M2), and then return to the second charging stand 100b (N4). Meanwhile, as another embodiment of the first embodiment, it may be considered that the first robot 100a enters the second unit zone A2 without avoiding the first obstacle OB1, and the second robot 100b completes the wiping of the floor in the first unit zone A1, and stands by until the first robot 100a completes the suction of contaminants in the second unit zone A2.

Referring to FIG. 32, the second embodiment represents a scenario in case where while the first robot 100a and the second robot 100b perform collaborative driving in the first unit zone A1 (M6, N5), the first robot 100a enters the second unit zone A2 (M7) without sensing the first obstacle OB1, and the second robot 100b avoids the first obstacle OB1 (N6) by sensing the first obstacle OB1. In this case, the second robot 100b may transmit a notification to the first robot 100a that the second robot 100b is unable to enter the second unit zone A2 after completing the wiping of the floor in the first unit zone A1 (N7). Furthermore, the first robot 100a may complete the suction of contaminants in the second unit zone A2 (M8), and then move to the position P1 (M9) at which the second robot 100b has transmitted the notification. In the second embodiment, even when the first robot 100a enters the second unit zone A2 without completing the suction of contaminants in the first unit zone A1, the second robot 100b may complete the wiping of the floor in the first unit zone A1. In addition, in the second embodiment, the second robot 100b may not wipe the floor in the second unit zone A2 in which the first robot 100a has completed the suction of contaminants. The driving of the first robot 100a and the second robot 100b in the above-described second embodiment should be understood as driving in a collaborative driving mode other than independent driving. Meanwhile, in the second embodiment, the second robot 100b may sense the first obstacle OB1 to transmit information on the first obstacle OB1 to the first robot 100a. In addition, the first robot 100a may receive information on the first obstacle OB1 from the second robot 100b to merge the first obstacle OB1 into a map stored in the memory 1700. In other words, the second robot 100b may share information on the first obstacle OB1 with the first robot 100a.

Referring to FIG. 33, the third embodiment represents a scenario in case where the first robot 100a and the second robot 100b enter the second unit zone A2 without sensing the first obstacle OB1 while performing collaborative driving in the first unit zone A1 (M10, N8). In this case, the first robot 100a and the second robot 100b may perform collaborative driving in the second unit zone A2 (M12, N10).

Referring to FIG. 34, the fourth embodiment represents a scenario in case where while the first robot 100a and the second robot 100b perform collaborative driving in the first unit zone A1 (M13, N11), the first robot 100a avoids the second obstacle (M14) by sensing the second obstacle OB2 and then moves to the second unit zone A2 (M15), and the second robot 100b is unable to avoid the second obstacle OB2 (N12) without sensing the second obstacle OB2. In this case, the second robot 100b may transmit a notification to the first robot 100a that the second robot 100b is unable to enter the second unit zone A2 after completing the wiping of the floor in the first unit zone A1 (N13). Furthermore, the first robot 100a may complete the suction of contaminants in the second unit zone A2 (M16), and then move to the position (M17) at which the second robot 100b has transmitted the notification. In the fourth embodiment, even when the first robot 100a moves to the second unit zone A2 without completing the suction of contaminants in the first unit zone A1, the second robot 100b may complete the wiping of the floor in the first unit zone A1. In addition, the second robot 100b may not wipe the floor in the second unit zone A2 in which the first robot 100a has completed the suction of contaminants. The driving of the first robot 100a and the second robot 100b in the above-described fourth embodiment should be understood as driving in a collaborative driving mode other than independent driving. Meanwhile, in the fourth embodiment, the first robot 100a may sense the second obstacle OB2 to transmit information on the second obstacle OB2 to the second robot 100b. In addition, the second robot 100b may receive information on the second obstacle OB2 from the first robot 100a to merge the second obstacle OB2 into a map stored in the memory 1700. In other words, the first robot 100a may share information on the second obstacle OB2 with the second robot 100b.

Meanwhile, the moving robot system 1 may include a first robot 100a and a second robot 100b. The first robot 100a and the second robot 100b may each include the main body 110 and the communication unit 1100 provided inside the main body 110 to exchange data with the other moving robot using the network 50. Furthermore, the first robot 100a may include the cleaning unit 120 mounted on one side of the main body 110 to suck contaminants in an area to be cleaned. In addition, the second robot 100b may include a mop unit (not shown) mounted on one side of the main body 110 to wipe the floor in the area to be cleaned. The first robot 100a and the second robot 100b may perform independent driving in an independent driving mode, or may enter a collaborative driving mode using the network 50 to perform collaborative driving. When the first robot 100a and the second robot 100b enter the collaborative driving mode, the first robot 100a and the second robot 100b may divide a zone to be cleaned into a plurality of unit zones to perform collaborative driving for each unit zone. On the other hand, at least one of the first robot 100a and the second robot 100b may sense an obstacle during collaborative driving in any one of the plurality of unit zones. Specifically, at least one of the first robot 100a and the second robot 100b may sense an obstacle existing between the divided zones (e.g., between the first unit zone A1 and the second unit zone A2), or inside the divided zones (e.g., inside the first unit zone A1). Here, an obstacle existing between the divided zones is defined as a first obstacle OB1, and an obstacle existing inside the divided zones is defined as a second obstacle OB2. The first obstacle OB1 or the second obstacle OB2 may be a doorsill, a carpet, or a cliff. Specifically, the first obstacle OB1 or the second obstacle OB2, as an obstacle that the first robot 100a and the second robot 100b is able to climb, may be is an obstacle disposed at a height or depth within a preset range. Here, climbing an obstacle by the first robot 100a and the second robot 100b refers to crossing a doorsill, crossing a carpet, passing a gap in a cliff, or going down and then going up a slope of a cliff. The first robot 100a and the second robot 100b may perform a preset scenario in response to the first obstacle OB1 or the second obstacle OB2 sensed during collaborative driving. A preset scenario corresponding to the first obstacle OB1 or the second obstacle OB2 sensed during collaborative driving performed by the first robot 100a and the second robot 100b has been described above, and thus a detailed description thereof will be omitted.

On the other hand, when a capacity charged in each of the batteries of the first robot 100a and the second robot 100b falls below a predetermined value while the collaborative driving is performed in the system 1 as described above, the first robot 100a and the second robot 100b may not be able to perform the collaborative driving due to lack of charge capacity. For instance, when the charge capacity of any one of the first robot 100a and the second robot 100b is insufficient, it is necessary to stop performing the collaborative driving due to difficulty in driving ahead or behind. When the collaborative driving is stopped without a specific motion, there is a concern of causing a problem in the post-driving of the first robot 100a and the second robot 100b or causing inconvenience to the user.

Therefore, in the present specification, there is provided Embodiment 4 of the moving robot system 1 in which an appropriate response can be made according to a change in the charge capacity of the battery during such collaborative driving.

As illustrated in FIG. 11, in the embodiment of the system 1, a plurality of moving robots 100a and 100b, including the first robot 100a that operates based on power charged by the first charging stand 400a to drive in a zone to be cleaned, and the second robot 100b that operates based on power charged by the second charging stand 400b to drive along a path that has been driven by the first robot 100a, drive collaboratively.

In other words, in the system 1, each of the first robot 100a and the second robot 100b charges the power of the battery at each of the first charging stand 400a and the second charging stand 400b.

The first robot 100a may be a robot that sucks dust while driving ahead in a zone subject to the collaborative driving, and the second robot 100b may be a robot that wipes dust while driving behind in the zone that has been driven by the first robot 100a.

In other words, for the collaborative driving, the first robot 100a may suck dust while driving ahead, and the second robot 100b may perform cleaning to wipe dust on a path in which the first robot 100a has sucked dust while driving ahead.

In the system 1, the first robot 100a and the second robot 100b release a collaborative driving mode according to a charge capacity value of the battery by sensing a capacity charged in each battery while performing the collaborative driving mode, and each perform at least one of an independent driving mode and a charging mode of the battery in response to the charge capacity value.

Specifically, each of the first robot 100a and the second robot 100b releases the collaborative driving mode when the charge capacity value of the battery is below the reference capacity value, and moves to each charging stand 400a, 400b to charge the battery or performs the independent driving mode.

In other words, the first robot 100a may move to the first charging stand 400a to charge the battery when the charge capacity value of the first robot 100a is below than the reference capacity value, and the second robot 100b may move to the second charging stand 400b to charge the battery, or perform the independent driving mode when the charge capacity value of the second robot 100b is below the reference capacity value.

For instance, the first robot 100a and the second robot 100b may release the collaborative driving mode being performed, and at least one of the first robot 100a and the second robot 100b may move to the relevant charging stand 400a and/or 400b to charge the battery, or at least one of the first robot 100a and the second robot 100b may perform the independent driving mode.

Here, the independent driving mode may be performed immediately after releasing the collaborative driving mode, or may be performed after moving to the relevant charging stand 400a and/or 400b to charge the battery.

Each of the first robot 100a and the second robot 100b may sense a capacity charged in the battery while driving.

For instance, each of the first robot 100a and the second robot 100b may sense the capacity charged in the battery while performing the collaborative driving mode.

In addition, each of the first robot 100a and the second robot 100b may sense the capacity charged in the battery while performing another mode other than the collaborative driving mode.

Each of the first robot 100a and the second robot 100b may sense the capacity charged in the battery in real time while driving.

In other words, the first robot 100a may sense a charge capacity of the battery built in the first robot 100a in real time while driving, and the second robot 100b may sense a charge capacity of the battery built in the second robot 100b in real time while driving.

Each of the first robot 100a and the second robot 100b may sense the capacity charged in the battery while driving, and quantify a result of sensing as the charge capacity value. Accordingly, the sensing result of the capacity charged in the battery may be compared with the reference capacity value.

Each of the first robot 100a and the second robot 100b may release the collaborative driving mode when each of the charge capacity value is below the reference capacity value, and then move to the charging stands 100a, 100b to charge the battery.

Here, the release of the collaborative driving mode may denote stopping the collaborative driving mode being performed.

In other words, the first robot 100a may stop the execution of the collaborative driving mode, and then move to the first charging stand 400a to charge the battery when the charge capacity value of the first robot 100a is below the reference capacity value as a result of sensing the charge capacity of the battery while the first robot 100a performs the collaborative driving mode, and the second robot 100b may stop the execution of the collaborative driving mode, and then move to the second charging stand 400b to charge the battery when the charge capacity value of the second robot 100b is below the reference capacity value as a result of sensing the charge capacity of the battery while the second robot 100b performs the collaborative driving mode.

In this case, each of the first robot 100a and the second robot 100b may share information on the release of the collaborative driving mode with the other robot.

In other words, when the collaborative driving mode is released, each of the first robot 100a and the second robot 100b may transmit information on the release of the collaborative driving mode to the other robot to notify the other robot of the release of the collaborative driving mode.

For instance, the first robot 100a may transmit information on the release of the collaborative driving mode to the second robot 100b to allow the second robot 100b to recognize the release of the collaborative driving mode when the first robot 100a releases the collaborative driving mode since the charge capacity value is below the reference capacity value, and the second robot 100b may transmit information on the release of the collaborative driving mode to the first robot 100a to allow the first robot 100a to recognize the release of the collaborative driving mode when the second robot 100b releases the collaborative driving mode since the charge capacity value is below the reference capacity value.

Accordingly, when the charge capacity value is below the reference capacity value in at least one of the first robot 100a and the second robot 100b, both the first robot 100a and the second robot 100b may stop the execution of the collaborative driving mode.

Each of the first robot 100a and the second robot 100b may move to the charging stand 400a, 400b and then charge the battery until the charge capacity of the battery is charged above a predetermined reference capacity.

In other words, when each of the first robot 100a and the second robot 100b moves to the charging stands 400a, 400b since the charge capacity value is below the reference capacity, the battery may be charged until the charge capacity of the battery is charged above a predetermined reference capacity.

Here, the predetermined reference capacity may denote a level of the charge capacity of the battery. The predetermined reference capacity may be set as a ratio [%] to a total capacity of the battery, or may be set as a capacity unit [Ah] of the battery.

Each of the first robot 100a and the second robot 100b may preferably move to the charging stand 400a, 400b and then charge the battery until the charging of the battery is completed.

Each of the first robot 100a and the second robot 100b may recognize a current position to store a position information value prior to moving to the charging stand 400a, 400b since each charge capacity value is below the reference capacity value, and start driving using the position information value after the charge capacity of the battery is charged above a predetermined reference capacity at the charging stand 400a, 400b.

In other words, each of the first robot 100a and the second robot 100b may store the position information value corresponding to a position prior to moving to the charging stand 400a, 400b, and start driving using the position information value when driving is resumed after charging the battery at the charging stand 400a, 400b.

For instance, after completing the charging of the battery at the charging stand 400a, 400b, each of the first robot 100a and the second robot 100b may move to a position according to the position information value to start driving or output a notification for moving to a position according to the position information value upon starting driving.

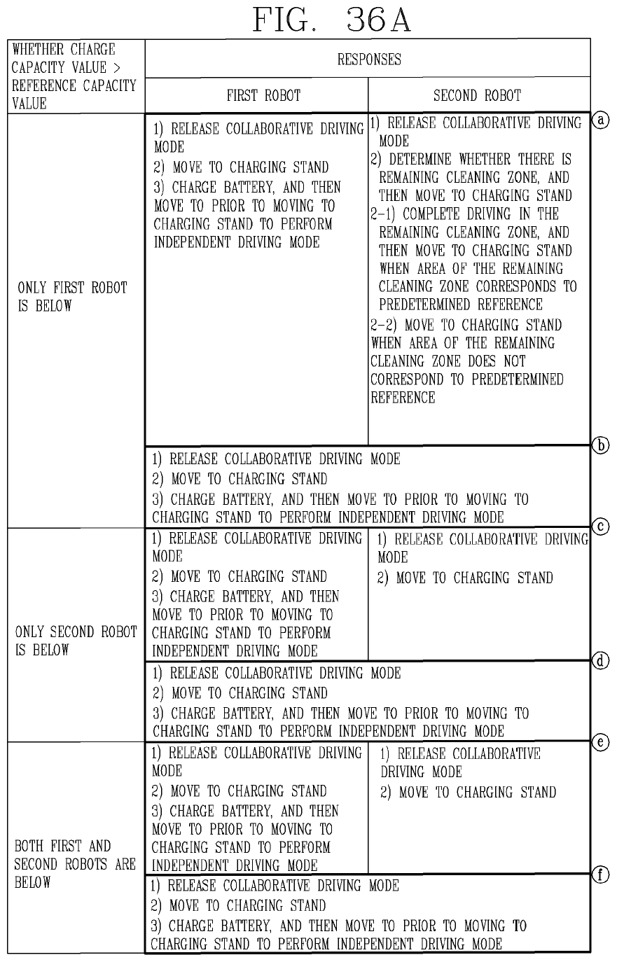

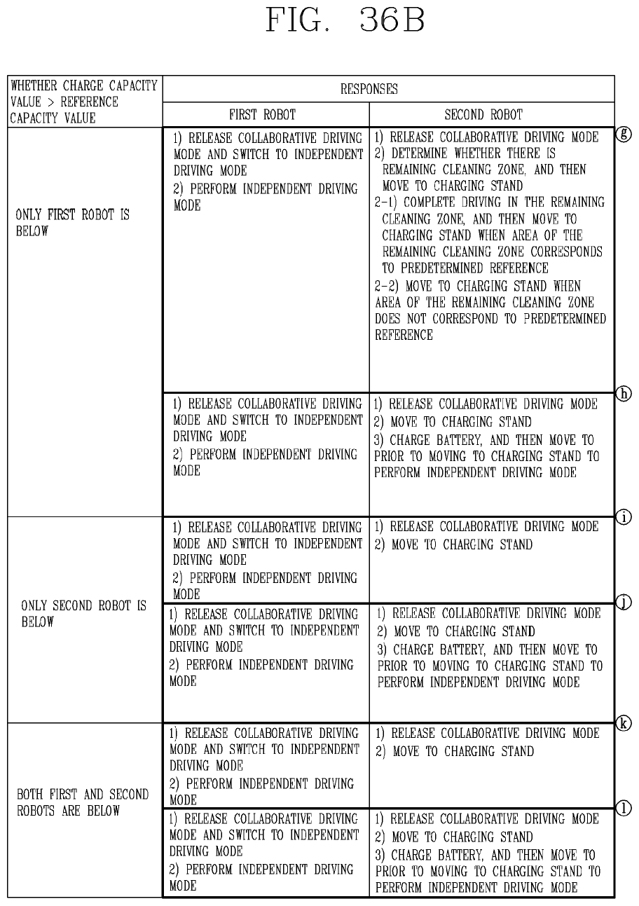

In the system 1, driving corresponding to the charge capacity of each of the first robot 100a and the second robot 100b may be carried out as in a chart illustrated in FIG. 36A.

{Response 1(a)}

When the charge capacity value of the first robot 100a is below the reference capacity value, and the charge capacity value of the second robot 100b is above the reference capacity value, the first robot 100a may release the collaborative driving mode, and then move to the first charging stand 400a to charge the battery, and move to a position prior to moving to the first charging stand 400a to perform an independent driving mode when the charge capacity of the battery is charged above a predetermined (capacity) reference level. In this case, the second robot 100b may release the collaborative driving mode, and then move to the second charging stand 400b to charge the battery according to whether there is the remaining cleaning zone. If an area of the remaining cleaning zone corresponds to a predetermined (area) reference value, the second robot 100b may complete the driving of the remaining cleaning zone, and then move to the second charging stand 400b. Furthermore, if the area of the remaining cleaning zone does not correspond to a predetermined reference area, the second robot 100b may move to the second charging stand 400b.

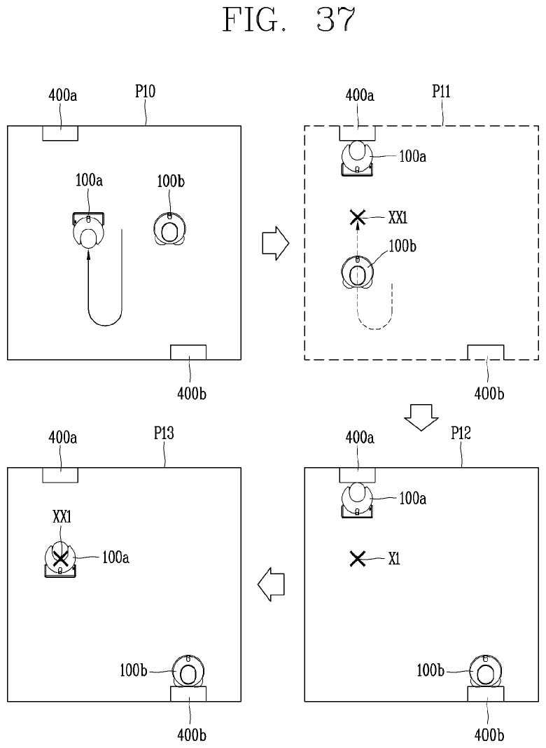

In other words, when only the charge capacity value of the first robot 100a is below the reference capacity value, as illustrated in FIG. 37, the first robot 100a may release a collaborative driving mode while performing the collaborative driving mode (P10), and then move to the first charging stand 400a (P11 or P12), but the second robot 100b may complete the driving of the remaining cleaning zone (P11) and then move to the second charging stand 400b (P12) when an area of the remaining cleaning zone corresponds to the predetermined reference value, and immediately move to the second charging stand 400b (P12) when the area of the remaining cleaning zone does not correspond to the predetermined reference area, and the first robot 100a may charge the charge capacity of the battery above a predetermined reference value at the first charging stand 400a, and then move to a position XX1 prior to moving to the first charging stand 400a to perform an independent driving move of the first robot 100a (P13).

{Response 2(b)}

In addition, each of the first robot 100a and the second robots 100b may release the collaborative driving mode, and then move to each charging stand 400a, 400b to charge the battery when the charge capacity value of the first robot 100a is below the reference capacity value, and the charge capacity value of the second robot 100b is above the reference capacity value, and move to a position prior to moving to each charging stand 400a, 400b to perform an independent driving mode when the charge capacity of the battery is charged above the reference capacity level.

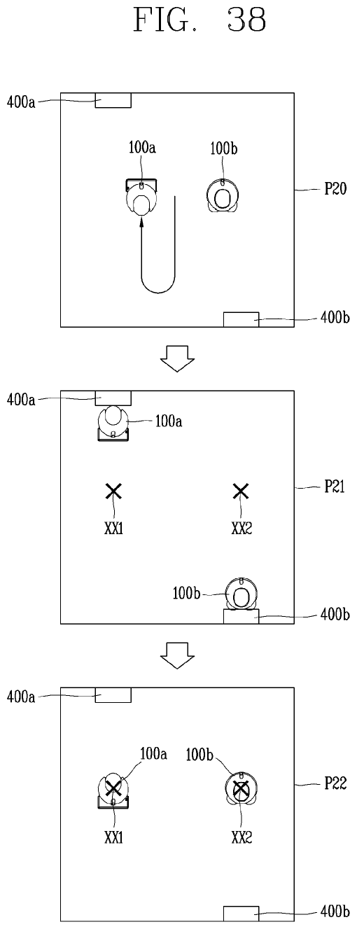

In other words, when only the charge capacity value of the first robot 100a is below the reference capacity value, as illustrated in FIG. 38, each of the first robot 100a and the second robot 100a may release the collaborative driving mode while performing the collaborative driving mode (P20), and then the first robot 100a may move to the first charging stand 400a and the second robot 100b may move to the second charging stand 400b (P21), and then each of the first robot 100a and the second robot 100b may charge the charge capacity of the battery above a predetermined reference capacity at each of the first charging stand 400a and the second charging stand 400b, and then the first robot 100a may move to a position XX1 prior to moving to the first charging stand 400a to perform an independent driving mode of the first robot 100a, and the second robot 100b may move to a position XX2 prior to moving to the second charging stand 400b to perform an independent driving mode of the second robot 100b (P22).

{Response 3(c)}

When the charge capacity value of the first robot 100a is above the reference capacity value and the charge capacity value of the second robot 100b is below the reference capacity value, each of the first robot 100a and the second robot 100b may release the collaborative driving mode, and then move to each charging stand 400a, 400b to charge the battery, and the first robot 100a may move to a position prior to moving to the first charging stand 400a to perform an independent driving mode when the charge capacity of the battery is charged above a predetermined reference capacity.

In other words, when the charge capacity values of both the first robot 100a and the second robot 100b are below the reference capacity value, as illustrated in FIG. 37, each of the first robot 100a and the second robot 100b may release the collaborative performance mode while performing the collaborative driving mode (P10), and then the first robot 100a may move to the first charging stand 400a and the second robot 100b may move to the second charging stand 400b (P12), but the first robot 100a may charge the charge capacity of the battery above a predetermined reference capacity at the first charging stand 400a, and then move to a position XX1 prior to moving to the first charging stand 400a to perform an independent driving mode of the first robot 100a (P13).

{Response 4(d)}

In addition, each of the first robot 100a and the second robots 100b may release the collaborative driving mode, and then move to each charging stand 400a, 400b to charge the battery when the charge capacity value of the first robot 100a is above the reference capacity value, and the charge capacity value of the second robot 100b is below the reference capacity value, and move to a position prior to moving to each charging stand 400a, 400b to perform an independent driving mode when the charge capacity of the battery is charged above the reference capacity level.

In other words, when only the charge capacity value of the first robot 100a is below the reference capacity value, as illustrated in FIG. 38, each of the first robot 100a and the second robot 100a may release the collaborative driving mode while performing the collaborative driving mode (P20), and then the first robot 100a may move to the first charging stand 400a and the second robot 100b may move to the second charging stand 400b (P21), and then each of the first robot 100a and the second robot 100b may charge the charge capacity of the battery above a predetermined reference capacity at each of the first charging stand 400a and the second charging stand 400b, and then the first robot 100a may move to a position XX1 prior to moving to the first charging stand 400a to perform an independent driving mode of the first robot 100a, and the second robot 100b may move to a position XX2 prior to moving to the second charging stand 400b to perform an independent driving mode of the second robot 100b (P22).

{Response 5(e)}

When both the charge capacity value of the first robot 100a and the charge capacity value of the second robot 100b are below the reference capacity value, each of the first robot 100a and the second robot 100b may release the collaborative driving mode, and then move to each charging stand 400a, 400b to charge the battery, and the first robot 100a may move to a position prior to moving to the first charging stand 400a to perform an independent driving mode when the charge capacity of the battery is charged above a predetermined reference capacity.

In other words, when the charge capacity values of both the first robot 100a and the second robot 100b are below the reference capacity value, as illustrated in FIG. 37, each of the first robot 100a and the second robot 100b may release the collaborative performance mode while performing the collaborative driving mode (P10), and then the first robot 100a may move to the first charging stand 400a and the second robot 100b may move to the second charging stand 400b (P12), but the first robot 100a may charge the charge capacity of the battery above a predetermined reference capacity at the first charging stand 400a, and then move to a position XX1 prior to moving to the first charging stand 400a to perform an independent driving mode of the first robot 100a (P13).

{Response 6(f)}

In addition, each of the first robot 100a and the second robots 100b may release the collaborative driving mode, and then move to each charging stand 400a, 400b to charge the battery when both the charge capacity value of the first robot 100a and the charge capacity value of the second robot 100b are below the reference capacity value, and move to a position prior to moving to each charging stand 400a, 400b to perform an independent driving mode when the charge capacity of the battery is charged above the reference capacity level.

In other words, when only the charge capacity value of the first robot 100a is below the reference capacity value, as illustrated in FIG. 38, each of the first robot 100a and the second robot 100a may release the collaborative driving mode while performing the collaborative driving mode (P20), and then the first robot 100a may move to the first charging stand 400a and the second robot 100b may move to the second charging stand 400b (P21), and then each of the first robot 100a and the second robot 100b may charge the charge capacity of the battery above a predetermined reference capacity at each of the first charging stand 400a and the second charging stand 400b, and then the first robot 100a may move to a position XX1 prior to moving to the first charging stand 400a to perform an independent driving mode of the first robot 100a, and the second robot 100b may move to a position XX2 prior to moving to the second charging stand 400b to perform an independent driving mode of the second robot 100b (P22).

Furthermore, in the system 1, driving corresponding to the charge capacity of each of the first robot 100a and the second robot 100b may also be carried out as in a chart illustrated in FIG. 36B.

{Response 7(g)}

When the charge capacity value of the first robot 100a is below the reference capacity value, and the charge capacity value of the second robot 100b is above the reference capacity value, the first robot 100a may release the collaboration driving mode and switch to an independent driving mode, and then drive while performing the independent driving mode, and the second robot 100b may release the collaborative driving mode, and then move to the charging stand 400b to charge the battery according to whether there is the remaining cleaning zone. When an area of the remaining cleaning zone corresponds to a predetermined (area) reference value, the second robot 100b may complete the driving of the remaining cleaning zone, and then move to the second charging stand 400b. Furthermore, if the area of the remaining cleaning zone does not correspond to a predetermined reference area, the second robot 100b may move to the second charging stand 400b.

In other words, when only the charge capacity value of the first robot 100a is below the reference capacity value, while performing the collaborative driving mode, the first robot 100a may release the collaborative driving mode and then switch to an independent driving mode to perform the independent driving mode, but the second robot 100b may complete the driving of the remaining cleaning zone and then move to the second charging stand 400b when an area of the remaining cleaning zone corresponds to the predetermined reference area, but immediately move to the second charging stand 400b when the area of the remaining cleaning zone does not correspond to the predetermined reference area, and the first robot 100a may charge the charge capacity of the battery above a predetermined capacity at the first charging stand 400a, and then move to a position XX1 prior to moving to the first charging stand 400a to perform an independent driving mode of the first robot 100a.

{Response 8(h)}

In addition, when the charge capacity value of the first robot 100a is below the reference capacity value, and the charge capacity value of the second robot 100b is above the reference capacity value, the first robot 100a may release the collaboration driving mode and switch to an independent driving mode, and then drive while performing the independent driving mode, and the second robot 100b may release the collaborative driving mode, and then move to the charging stand 400b to charge the battery, and move to a position prior to moving to the second charging stand 400b to perform an independent driving mode when the charge capacity of the battery is charged above a predetermined (capacity) reference level.

In other words, when only the charge capacity value of the first robot 100a is below the reference capacity value, while performing the collaborative driving mode, each of the first robot 100a and the second robot 100b may release the collaborative performance mode, and then the first robot 100a may switch to the independent driving mode to perform the independent driving mode, but the second robot 100b may move the move to the second charging stand 400b, and charge the charge capacity of the battery above a predetermined reference capacity at the second charging stand 400b, and then move to a position XX2 prior to moving to the second charging stand 400b to perform an independent driving mode of the first robot 100b.

{Response 9(i)}

When the charge capacity value of the first robot 100a is above the reference capacity value, and the charge capacity value of the second robot 100b is below the reference capacity value, the first robot 100a may release the collaboration driving mode and switch to an independent driving mode, and then drive while performing the independent driving mode, and the second robot 100b may release the collaborative driving mode, and then move to the charging stand 400b to charge the battery.

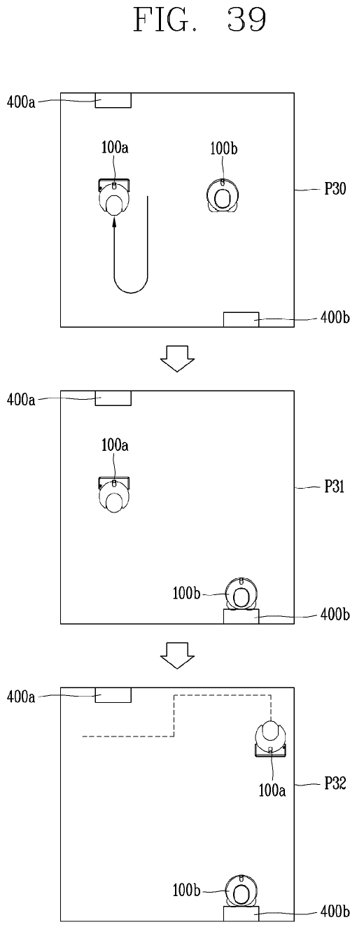

In other words, when only the charge capacity value of the second robot 100b is below the reference capacity value, as illustrated in FIG. 39, while performing the collaborative driving mode (P30), the second robot 100b may release the collaborative driving mode, and then move to the second charging stand 400b (P31), but the first robot 100a may release the collaborative driving mode and then switch to an independent driving mode to perform the independent driving mode (P32).

{Response 10(j)}

In addition, when the charge capacity value of the first robot 100a is above the reference capacity value, and the charge capacity value of the second robot 100b is below the reference capacity value, the first robot 100a may release the collaboration driving mode and switch to an independent driving mode, and then drive while performing the independent driving mode, and the second robot 100b may release the collaborative driving mode, and then move to the charging stand 400b to charge the battery, and move to a position prior to moving to the second charging stand 400b to perform an independent driving mode when the charge capacity of the battery is charged above a predetermined (capacity) reference level.

In other words, when only the charge capacity value of the second robot 100b is below the reference capacity value, while performing the collaborative driving mode, each of the first robot 100a and the second robot 100b may release the collaborative driving mode, and then the first robot 100a may switch to the independent driving mode to perform the independent driving mode, but the second robot 100b may move to the second charging stand 400b to charge the charge capacity of the battery above a predetermined reference capacity at the second charging stand 400b, and then move to a position XX2 prior to moving to the second charging stand 400b to perform the independent driving mode of the second robot 100b.

{Response 11(k)}

When both the charge capacity value of the first robot 100a and the charge capacity value of the second robot 100b are below the reference capacity value, the first robot 100a may release the collaboration driving mode and switch to an independent driving mode, and then drive while performing the independent driving mode, and the second robot 100b may release the collaborative driving mode, and then move to the charging stand 400b to charge the battery.

In other words, when only the charge capacity value of the second robot 100b is below the reference capacity value, as illustrated in FIG. 39, while performing the collaborative driving mode (P30), the second robot 100b may release the collaborative driving mode, and then move to the second charging stand 400b (P31), but the first robot 100a may release the collaborative driving mode and then switch to an independent driving mode to perform the independent driving mode (P32).

{Response 12(I)}

In addition, when both the charge capacity value of the first robot 100a and the charge capacity value of the second robot 100b are below the reference capacity value, the first robot 100a may release the collaboration driving mode and switch to an independent driving mode, and then drive while performing the independent driving mode, and the second robot 100b may release the collaborative driving mode, and then move to the charging stand 400b to charge the battery, and move to a position prior to moving to the second charging stand 400b to perform an independent driving mode when the charge capacity of the battery is charged above a predetermined (capacity) reference level.

In other words, when only the charge capacity value of the second robot 100b is below the reference capacity value, while performing the collaborative driving mode, each of the first robot 100a and the second robot 100b may release the collaborative driving mode, and then the first robot 100a may switch to the independent driving mode to perform the independent driving mode, but the second robot 100b may move to the second charging stand 400b to charge the charge capacity of the battery above a predetermined reference capacity at the second charging stand 400b, and then move to a position XX2 prior to moving to the second charging stand 400b to perform the independent driving mode of the second robot 100b.

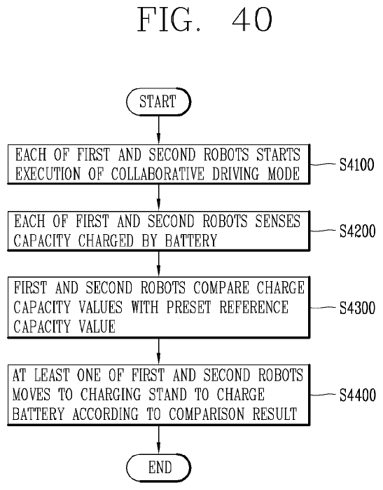

On the other hand, in the system 1 in which a response is made according to the state of the charge capacity of the battery as described above, the collaborative driving may be performed by a method of performing collaborative driving as illustrated in FIG. 40.

The method of performing collaborative driving (hereinafter, referred to as an implementation method), which is a method of performing collaborative driving in the system 1 including the first robot 100a that operates based on power charged by the first charging stand 400a to drive in a zone to be cleaned, and the second robot 100b that operates based on power charged by the second charging stand 400b to drive along a path that has been driven by the first robot 100a, may include starting, by each of the first robot 100a and the second robot 100b, the execution of a collaborative driving mode (S4100), sensing, by each of the first robot 100a and the second robot 100b, a capacity charged by the battery (S4200), and comparing, by each of the first robot 100a and the second robot 100b, a charge capacity value with a preset reference capacity value (S4300), and performing an independent driving mode or moving to the charging stand 400a, 400b to charge the battery, by at least one of the first robot 100a and the second robot 100b, according to the comparison result (S4400).

Here, the first robot 100a may suck dust while driving ahead in an area subject to the collaborative driving, and the second robot 100b may wipe dust while driving behind in a zone in which the first robot 100a has driven.

The starting step (S4100) may be a step in which the first robot 100a and the second robot 100b start driving according to the collaborative driving mode.

The sensing step (S4200) may be a step in which each of the first robot 100a and the second robot 100b senses a capacity charged in the battery in real time while driving according to the collaborative driving mode.

In the sensing step (S4200), the first robot 100a may sense a charge capacity of a battery built in the first robot 100a to quantify the sensing result as the charge capacity value, and the second robot 100b may sense a charge capacity of a battery built in the second robot 100b to quantify the sensing result as the charge capacity value.

The comparing step (S4300) may be a step in which each of the first robot 100a and the second robot 100b compares a charge capacity value obtained by quantifying the result of the sensing in the sensing step (S4200) with the reference capacity value.

In the comparing step (S4300), the first robot 100a may compare the charge capacity value of the first robot 100a with the reference capacity value, and the second robot 100b may compare the charge capacity value of the second robot 100b with the reference capacity value.

In the comparing step (S4300), each of the first robot 100a and the second robot 100b may transmit and share a result of comparing the charge capacity value with the reference capacity value.

The charging step (S4400) may be a step in which a robot with the charge capacity value below the reference capacity value between the first robot 100a and the second robot 100b moves to the charging stand 400a, 400b to charge the battery.

In the charging step (S4400), when the charge capacity value of the first robot 100a is below the reference capacity value, and the charge capacity value of the second robot 100b is above the reference capacity value, as shown in (a) of FIG. 36A, the first robot 100a may release the collaborative driving mode, and then move to the first charging stand 400a to charge the battery, and move to a position prior to moving to the first charging stand 400a to perform an independent driving mode when the charge capacity of the battery is charged above a predetermined reference capacity, and the second robot 100b may release the collaborative driving mode, and then move to the second charging stand 400b to charge the battery according to whether there is the remaining cleaning zone.

Accordingly, when only the charge capacity value of the first robot 100a is below the reference capacity value, in the charging step (S4400), as illustrated in FIG. 37, the first robot 100a may release a collaborative driving mode while performing the collaborative driving mode (P10), and then move to the first charging stand 400a (P11 or P12), but the second robot 100b may complete the driving of the remaining cleaning zone (P11) and then move to the second charging stand 400b (P12) when an area of the remaining cleaning zone corresponds to the predetermined reference area, and immediately move to the second charging stand 400b (P12) when the area of the remaining cleaning zone does not correspond to the predetermined reference area, and the first robot 100a may charge the charge capacity of the battery above a predetermined reference value at the first charging stand 400a, and then move to a position XX1 prior to moving to the first charging stand 400a to perform an independent driving move of the first robot 100a (P13).

In the charging step (S4400), when the charge capacity value of the first robot 100a is below the reference capacity value, and the charge capacity value of the second robot 100b above the reference capacity value, as shown in (b) of FIG. 36A, each of the first robot 100a and the second robot 100b may release the collaborative driving mode, and then move to each charging stand 400a, 400b to charge the battery, and move to a position prior to moving to the each charging stand 400a, 400b to perform an independent driving mode when the charge capacity of the battery is charged above a predetermined reference capacity.

Accordingly, when only the charge capacity value of the first robot 100a is below the reference capacity value, in the charging step (S4400), as illustrated in FIG. 38, while performing the collaborative driving mode (P20), each of the first robot 100a and the second robot 100b may release the collaborative driving mode, and then the first robot 100a may move to the first charging stand 400a and the second robot 100b may move to the second charging stand 400b (P21), and then each of the first robot 100a and the second robot 100b may charge the charge capacity of the battery above a predetermined reference capacity at each of the first charging stand 400a and the second charging stand 400b, and the first robot 100a may move to a position XX1 prior to moving to the first charging stand 400a to perform an independent driving mode of the first robot 100a, and the second robot 100b may move to a position XX2 prior to moving to the second charging stand 400b to perform an independent driving mode of the second robot 100b (P22).

In the charging step (S4400), when the charge capacity value of the first robot 100a is above the reference capacity value, and the charge capacity value of the second robot 100b is below the reference capacity value, as shown in (c) of FIG. 36A, the first robot 100a may release the collaboration driving mode and switch to an independent driving mode, and then drive while performing the independent driving mode, and the second robot 100b may release the collaborative driving mode, and then move to the charging stand 400b to charge the battery.

Accordingly, when only the charge capacity value of the second robot 100b is below the reference capacity value, in the charging step (S4400), as illustrated in FIG. 39, while performing the collaborative driving mode (P30), the second robot 100b may release the collaborative driving mode, and then move to the second charging stand 400b (P31), but the first robot 100a may release the collaborative driving mode and then switch to an independent driving mode to perform the independent driving mode (P32).

In the charging step (S4400), when both the charge capacity value of the first robot 100a and the charge capacity value of the second robot 100b are below the reference capacity value, as shown in (e) of FIG. 36A, each of the first robot 100a and the second robot 100b may release the collaborative driving mode, and then move to each charging stand 400a, 400b to charge the battery, and the first robot 100a may move to a position prior to moving to the first charging stand 400a to perform an independent driving mode when the charge capacity of the battery is charged above a predetermined reference level.

Accordingly, when the charge capacity values of both the first robot 100a and the second robot 100b are below the reference capacity value, in the charging step (S4400), as illustrated in FIG. 37, each of the first robot 100a and the second robot 100b may release the collaborative performance mode while performing the collaborative driving mode (P10), and then the first robot 100a may move to the first charging stand 400a and the second robot 100b may move to the second charging stand 400b (P12), but the first robot 100a may charge the charge capacity of the battery above a predetermined reference capacity at the first charging stand 400a, and then move to a position XX1 prior to moving to the first charging stand 400a to perform an independent driving mode of the first robot 100a (P13).

In the charging step (S4400), when both the charge capacity value of the first robot 100a and the charge capacity value of the second robot 100b are below the reference capacity value, as shown in (f) of FIG. 36A, each of the first robot 100a and the second robot 100b may release the collaborative driving mode, and then move to each charging stand 400a, 400b to charge the battery, and move to a position prior to moving to the each charging stand 400a, 400b to perform an independent driving mode when the charge capacity of the battery is charged above a predetermined reference capacity.

Accordingly, when both the charge capacity values of both the first robot 100a and the second robot 100b are below the reference capacity value, in the charging step (S4400), as illustrated in FIG. 38, while performing the collaborative driving (P20), each of the first robot 100a and the second robot 100b may release the collaborative performance mode, and then the first robot 100a may move to the first charging stand 400a, and the second robot 100b may move to the second charging stand 400b (P21), and then each of the first robot 100a and the second robot 100b may charge the charge capacity of the battery above a predetermined reference capacity at each of the first charging stand 400a and the second charging stands 400b, and then the first robot 100a may move to a position XX1 prior to moving to the first charging stand 400a to perform an independent driving mode of the first robot 100a, and the second robot 100b may move to a position XX2 prior to moving to the second charging stand 400b to perform an independent driving mode of the second robot 100b (P22).

The execution method including the starting step (S4100), the sensing step (S4200), the comparing step (S4300), and the charging step (S4400) may be implemented as computer-readable codes on a program-recorded medium. The computer readable medium includes all types of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). In addition, the computer may include the control unit 1800.

Although specific embodiments according to the present disclosure have been described so far, various modifications may be made thereto without departing from the scope of the present disclosure. Therefore, the scope of the present disclosure should not be limited to the above-described embodiments, and should be defined by the claims to be described later as well as equivalents thereto.

Although the present disclosure has been described by specific embodiments and drawings, the present disclosure is not limited to those embodiments, and it will be apparent to those skilled in the art that various changes and modifications can be made from the description disclosed herein. Accordingly, the concept of the present disclosure should be construed in accordance with the appended claims, and all the same and equivalent changes will fall into the scope of the present disclosure.

[Reference Signs List]

| 1: Moving robot system | 10: Building |
|---|---|
| 50: Network | 100: Moving robot |
| 100a: First moving robot | 100b: Second moving robot |
| 110: Main body | 111: Wheel unit |
| 120: Cleaning unit | 130: Sensing unit |
| 131: Camera | 300, 300a, 300b: Terminal |
| 400: Charging stands | 400a: First Charging stand |
| 400b: Second Charging stand | 500: Cloud Server |
| 600: Controller | 1100: Communication unit |
| 1200: Input unit | 1300: Driving unit |
| 1400: Sensor | 1500: Output unit |
| 1600: Power supply unit | 1700: Memory |
| 1800: | 1900: |

1. A moving robot system that drives in a zone to be cleaned, the moving robot system comprising: a first robot that sucks contaminants in the zone to be cleaned, a second robot that wipes the floor in the zone to be cleaned, a first charging stand that charges the first robot, a second charging stand that charges the second robot, and a network that connects the first robot and the second robot with each other,
wherein the first robot and the second robot enter a collaborative driving mode using the network to perform collaborative driving by recognizing position information to each other, and
the first robot or the second robot determines whether to release the collaborative driving mode when an error occurs in at least one of the first robot and the second robot, or when a kidnap occurs in at least one of the first robot and the second robot, or when the network is disconnected while performing the collaborative driving.

2. The moving robot system of claim 1, wherein for the collaborative driving,
the first robot drives ahead of the driving of the second robot to suck contaminants in the zone to be cleaned, and
the second robot drives along a path that has been driven by the first robot to wipe the floor in the zone to be cleaned.

3. The moving robot system of claim 2, wherein the first robot turns off the power when a first error occurs in the first robot and a preset standby time period has passed, and
the second robot releases the collaborative driving mode and drives to a point at which the first robot has driven, and then returns to the second charging stand, and
wherein the point at which the first robot has driven is a position of the first robot at the time when the first error occurs.

4. The moving robot system of claim 2, wherein when a first error occurs in the first robot, but the first error is resolved and a resume command is received at the first robot, and the first robot and the second robot recognize position information to each other for a preset standby time period,
the first robot and the second robot perform the collaborative driving again, and
the second robot drives again in the zone to be cleaned that has been driven by the second robot from the time when the first error occurs to the time when the collaborative driving is performed again.

5. The moving robot system of claim 2, wherein when a first error occurs in the first robot, but the first error is resolved and a resume command is received at the first robot, and the first robot and the second robot do not recognize position information to each other for a preset standby time period,
the first robot releases the collaborative driving mode, and then performs independent driving, and
the second robot releases the collaborative driving mode and drives to a point at which the first robot has driven, and then returns to the second charging stand, and
wherein the point at which the first robot has driven is a position of the first robot at the time when the first error occurs.

6. The moving robot system of claim 2, wherein when a first error occurs in the first robot, a second error occurs in the second robot, and a preset standby time period has passed,
the first robot turns off the power of the first robot, and
the second robot turns off the power of the second robot.

7. The moving robot system of claim 2, wherein when a second error occurs in the second robot, and a preset standby time period has passed,
the second robot turns off the power, and
the first robot releases the collaborative driving mode, and then performs independent driving.

8. The moving robot system of claim 2, wherein when a second error occurs in the second robot, but the second error is resolved and a resume command is received at the second robot, and the first robot and the second robot recognize position information to each other for a preset standby time period,
the first robot and the second robot perform the collaborative driving again, and
the first robot drives again in the zone to be cleaned that has been driven by the first robot from the time when the second error occurs to the time when the collaborative driving is performed again.

9. The moving robot system of claim 2, wherein when a second error occurs in the second robot, but the second error is resolved and a resume command is received at the second robot, and the first robot and the second robot do not recognize position information to each other for a preset standby time period,
the second robot releases the collaborative driving mode and drives to a point at which the first robot has driven, and then returns to the second charging stand, and
wherein the point at which the first robot has driven is a position of the first robot at the time when the second error occurs, and
the first robot releases the collaborative driving mode, and then performs independent driving.

10. The moving robot system of claim 2, wherein when a first kidnap occurs in the first robot, and a preset standby time period has passed,
the first robot turns off the power, and
the second robot releases the collaborative driving mode and drives to a point at which the first robot has driven, and then returns to the second charging stand, and
wherein the point at which the first robot has driven is a position of the first robot at the time when the first kidnap occurs.

11. The moving robot system of claim 2, wherein when a first kidnap occurs in the first robot, but a resume command is received at the first robot, and the first robot and the second robot recognize position information to each other for a preset standby time period,
the first robot and the second robot perform the collaborative driving again, and
the second robot drives again in the zone to be cleaned that has been driven by the second robot from the time when the first kidnap occurs to the time when the collaborative driving is performed again.

12. The moving robot system of claim 2, wherein when a first kidnap occurs in the first robot, but a resume command is received at the first robot, and the first robot and the second robot do not recognize position information to each other for a preset standby time period,
the first robot releases the collaborative driving mode, and then performs independent driving, and
the second robot releases the collaborative driving mode and drives to a point at which the first robot has driven, and then returns to the second charging stand, and
wherein the point at which the first robot has driven is a position of the first robot at the time when the first kidnap occurs.

13. The moving robot system of claim 2, wherein when a first kidnap occurs in the first robot, and a second kidnap occurs in the second robot, but a resume command is received at the first robot and the second robot, and the first robot and the second robot recognize position information to each other for a preset standby time period,
the first robot and the second robot perform the collaborative driving again.

14. The moving robot system of claim 2, wherein when a second kidnap occurs in the second robot, and a preset standby time period has passed,
the second robot turns off the power, and
the first robot releases the collaborative driving mode, and then performs independent driving.

15. The moving robot system of claim 2, wherein when a second kidnap occurs in the second robot, but a resume command is received at the second robot, and the first robot and the second robot recognize position information to each other for a preset standby time period,
the first robot and the second robot perform the collaborative driving again, and
the first robot drives again in the zone to be cleaned that has been driven by the first robot from the time when the second kidnap occurs to the time when the collaborative driving is performed again.

16. The moving robot system of claim 2, wherein when a second kidnap occurs in the second robot, but a resume command is received at the second robot, and the first robot and the second robot do not recognize position information to each other for a preset standby time period,
the second robot releases the collaborative driving mode and drives to a point at which the first robot has driven, and then returns to the second charging stand, and
wherein the point at which the first robot has driven is a position of the first robot at the time when the second kidnap occurs, and
the first robot releases the collaborative driving mode, and then performs independent driving.

17. The moving robot system of claim 2, wherein the network comprises a first network for the first robot and the second robot to share map information of the zone to be cleaned, and a second network for the first robot and the second robot to recognize a separation distance between the first robot and the second robot, and
the moving robot system continuously perform the collaborative driving when the first network or the second network is disconnected between the first robot and the second robot while performing the collaborative driving.

18. The moving robot system of claim 2, wherein the network comprises a first network for the first robot and the second robot to share map information of the zone to be cleaned, and a second network for the first robot and the second robot to recognize a separation distance between the first robot and the second robot, and
when both the first network and the second network are disconnected between the first robot and the second robot while performing the collaborative driving,
the first robot releases the collaborative driving mode. and then perform independent driving, and
the second robot releases the collaborative driving mode, and then returns to the second charging stand.

19. A method of performing collaborative driving of a moving robot system that drives in a zone to be cleaned,
wherein the moving robot system comprises a first robot that sucks contaminants in the zone to be cleaned, a second robot that wipes the floor in the zone to be cleaned, a first charging stand that charges the first robot, a second charging stand that charges the second robot, and a network that connects the first robot and the second robot with each other, and
wherein the method of performing the collaborative driving comprises:
entering, by the first robot and the second robot, a collaborative driving mode using the network;
recognizing, by the first robot and the second robot, position information to each other to perform collaborative driving; and
determining, by the first robot or the second robot, whether to release the collaborative driving mode when an error occurs in at least one of the first robot and the second robot, or when a kidnap occurs in at least one of the first robot and the second robot, or when the network is disconnected while performing the collaborative driving.

20. A moving robot that drives in a zone to be cleaned, the moving robot comprising:
a main body defining an appearance of the moving robot;
a cleaning unit mounted on one side of the main body to suck contaminants in the zone to be cleaned; and
a communication unit provided inside the main body to exchange data with another moving robot using a network,
wherein the network comprises a first network for the moving robot and the other robot to share map information of the zone to be cleaned, and a second network for the moving robot and the other robot to recognize a separation distance between the moving robot and the other robot, and
wherein the moving robot,
enters a collaborative driving mode using the network, and recognizes position information to each other to perform collaborative driving with the other moving robot, and
turns off the power, receives a resume command and then performs the collaborative driving again, or releases the collaborative driving mode and then perform independent driving when an error or kidnap occurs while performing the collaborative driving, and
releases the collaborative driving mode, and then performs independent driving when both the first network and the second network are disconnected from the other robot while performing the collaborative driving.

21. A moving robot that drives in a zone to be cleaned, the moving robot comprising:
a main body defining an appearance of the moving robot;
a mop unit mounted on one side of the main body to wipe the floor in the zone to be cleaned; and
a communication unit provided inside the main body to exchange data with another moving robot using a network,
wherein the network comprises a first network for the moving robot and the other robot to share map information of the zone to be cleaned, and a second network for the moving robot and the other robot to recognize a separation distance between the moving robot and the other robot, and
wherein the moving robot,
enters a collaborative driving mode using the network, and recognizes position information to each other to perform collaborative driving with the other moving robot, and
turns off the power, receives a resume command and then performs the collaborative driving again, or releases the collaborative driving mode and then returns to a charging stand when an error or kidnap occurs while performing the collaborative driving, and
releases the collaborative driving mode, and then returns to the charging stand when both the first network and the second network are disconnected from the other root while performing the collaborative driving.
